(19) United States
(12) Patent Application Publication
(10) Pub. No.: US 2025/0347956 A1
(43) Pub. Date: Nov. 13, 2025

(54) Directional display apparatus

(71) Applicant: RealD Spark, LLC, Boulder, CO (US)

(72) Inventors: Graham J. Woodgate, Henley-on-Thames (GB); Jonathan Harrold, Leamington Spa (GB); Michael G Robinson, Boulder, CO (US)

(21) Appl. No.: 18/979,088

(22) Filed: Dec. 12, 2024

Related U.S. Application Data
(60) Provisional application No. 63/612,598, filed on Dec. 20, 2023.
(60) Provisional application No. 63/678,425, filed on Aug. 1, 2024.

(51) Int. Cl. G02F 1/1335; G02F 1/13357; G02F 1/1343

(52) U.S. Cl. CPC G02F 1/133626; G02F 1/133512; G02F 1/133514; G02F 1/133526; G02F 1/133528; G02F 1/133606; G02F 1/13362; G02F 1/13439

(57) ABSTRACT

A SLM comprises emissive pixels, a parallax barrier, and a birefringent lens array. The apertures and lenses are each aligned with a respective pixel, polarisation switch, display polariser, and reflective polariser, with a switchable polar control retarder between the reflective polariser and an additional polariser. In privacy mode, pixel light transmitted by the display polariser is provided with optical power by the lens array; the parallax barrier has regions that reduce the pixel light from pixels that are not aligned with a respective lens; and the polar control retarder has a phase difference only in non-viewing directions and provides high security factor. In share mode, pixel light transmitted by the display polariser is provided with no optical power by the lens array; and the polar control retarder has no phase difference over a wide field of view and provides high image visibility. A near-eye display has increased dynamic range.

### TECHNICAL FIELD

This disclosure generally relates to illumination from light modulation devices, and more specifically relates to optical stacks for providing control of illumination for use in display including privacy display and night-time display.

### BACKGROUND

Privacy displays provide image visibility to a primary user that is typically in an on-axis position and reduced visibility of image content to a snooper, that is typically in an off-axis position. A privacy function may be provided by micro-louvre optical films that transmit some light from a display in an on-axis direction with low luminance in off-axis positions. However such films have high losses for head-on illumination and the micro-louvres may cause Moiré artefacts due to beating with the pixels of the spatial light modulator. The pitch of the micro-louvre may need selection for panel resolution, increasing inventory and cost.

Switchable privacy displays may be provided by control of the off-axis optical output.

Control may be provided by means of luminance reduction, for example by means of switchable backlights for a liquid crystal display (LCD) spatial light modulator. Display backlights in general employ waveguides and edge emitting sources. Certain imaging directional backlights have the additional capability of directing the illumination through a display panel into viewing windows. An imaging system may be formed between multiple sources and the respective window images. One example of an imaging directional backlight is an optical valve that may employ a folded optical system and hence may also be an example of a folded imaging directional backlight. Light may propagate substantially without loss in one direction through the optical valve while counter-propagating light may be extracted by reflection off tilted facets as described in U.S. Pat. No. 9,519,153, which is herein incorporated by reference in its entirety.

### BRIEF SUMMARY

According to a first aspect of the present disclosure there is provided a display device comprising: a pixel layer comprising a plurality of pixels arranged in a pixel array; a parallax barrier layer comprising a plurality of apertures arranged in an aperture array, wherein each of the plurality of pixels is aligned with a respective aperture of the plurality of apertures; a lens layer comprising a plurality of lenses arranged in a lens array, wherein each of the plurality of pixels is aligned with a respective lens of the plurality of lenses, and wherein the plurality of lenses comprises one or more birefringent lenses; and a display polariser which is a linear polariser, wherein the parallax barrier layer is arranged between the lens layer and the pixel layer, wherein the lens layer is arranged between the pixel layer and the display polariser, wherein the pixel layer is arranged to output light towards the parallax barrier layer, the parallax barrier layer is arranged to receive light output from the pixel layer and to output light towards the lens layer, the lens layer is arranged to receive light output from the parallax barrier layer and to output light towards the display polariser, and the display polariser is arranged to receive light output from the lens layer and to output linearly polarised light, and wherein the parallax barrier layer is arranged to prevent at least some of the light from each of the plurality of pixels from reaching lenses which are not aligned with that pixel, and wherein the each of the plurality of lenses is arranged to reflect at least some of the light received from pixels which are not aligned with that lens. At least 50%, preferably at least 65% and more preferably at least 75% of the light output by each of the plurality of lenses of the lens layer may be from the pixel with which that lens is aligned.

A display device may be provided with a display angular luminance profile that is narrower than provided by the pixels of the pixel layer. Increased brightness may be provided in a desirable viewing direction. The visibility of secondary viewing lobes may be reduced. A display device suitable for use in a privacy display and suitable for use in a near-eye display apparatus may be provided.

The lens layer may be arranged to reflect at least some of the light that it receives by total internal reflection at a lens surface. The width of the apertures of the parallax barrier may be increased and display brightness improved in a desirable viewing direction while luminance may be reduced in desirable non-viewing directions.

The display device may further comprise at least one planar surface, wherein the at least one planar surface is arranged to receive light output from the lens layer and to reflect at least some of the light that it receives by total internal reflection. The visibility of off-axis luminance from the pixels may advantageously be reduced, achieving improved security factor in non-viewing directions.

The parallax barrier layer may comprise light blocking regions arranged between the plurality of apertures. Image visibility in non-viewing directions and the visibility of front reflections may be reduced. The light blocking regions may be provided in a thin layer to achieve reduced device thickness.

The aperture array and the lens array may be one dimensional arrays which extend in a common one dimensional direction. Complexity and cost of fabrication may be reduced. The display device may be further provided with polar control retarders that provide a luminance reduction that is smaller along the common direction and larger along the direction orthogonal to the common one dimensional direction and in the plane of the display device. Image visibility along the orthogonal direction may be reduced.

The aperture array and the lens array may be two dimensional arrays which extend in common two dimensional directions. Further increase in display brightness may be achieved. A display suitable for landscape and portrait privacy display operation may be achieved. A display device suitable for use in a near-eye display with high dynamic range may be provided.

The pitch of the apertures in the parallax barrier layer and the pitch of the lenses in the lens layer may be arranged relative to the pitch of the pixels in the pixel layer so as to direct light from each pixel of the plurality of pixels into a common viewing window. Improved uniformity of images may be achieved.

The display device may further comprise a reflection control polarisation conversion retarder, the reflection control polarisation conversion retarder being arranged in at least one mode to convert a polarisation state of light passing therethrough between a linear polarisation state and a circular polarisation state. The reflection control polarisation conversion retarder may be a quarter-wave retarder. The reflection control polarisation conversion retarder may be arranged between the lens layer and the pixel layer. The visibility of reflections from layers in the display device including from the pixel plane may be reduced.

The display device may further comprise a polarisation switch layer arranged between the lens layer and the display polariser, the polarisation switch layer being arranged to convert a polarisation state of light passing therethrough between a first polarisation state and a second polarisation state orthogonal to the first polarisation state. The polarisation switch layer may comprise a switchable liquid crystal layer. The display device may further comprise transmissive electrodes and liquid crystal surface alignment layers formed on each side of the switchable liquid crystal layer. The display device may further comprise a control system arranged to control a voltage applied across the transmissive electrodes. A switchable display device may be provided to achieve low luminance in non-viewing directions in a first mode that may be a privacy mode or high brightness mode and to achieve increased luminance and improved image visibility in the in a second mode that may be a share mode such that the non-viewing directions are switched to viewing directions.

At least one of the transmissive electrodes may be provided with multiple addressable regions. Some regions of the display device may provide low off-axis luminance while other regions may provide increased off-axis luminance. A display with privacy and share mode regions may be provided.

The display device may further comprise a first transparent layer arranged between the pixel layer and the parallax barrier layer. The first transparent layer may comprise a thin film encapsulation layer arranged to provide a barrier to water and oxygen. The parallax barrier layer may be conveniently formed on the first transparent layer. The thickness of the first transparent layer may be arranged to achieve desirable angular luminance profile characteristics in a share mode. Display lifetime may be increased.

The display device may further comprise a second transparent layer arranged between the parallax barrier layer and the lens layer. The thickness of the first and second transparent layers may be arranged to achieve desirable angular luminance profile characteristics in a privacy mode for angles.

The second transparent layer may comprise an encapsulation layer arranged to provide a barrier to water and oxygen. Display lifetime may be increased.

The thickness of the first and second transparent layers may be the same. In at least one direction across the pixel layer, a width of each of the plurality of apertures may be equal to or less than a pitch of the pixel array in the at least one direction. The width of each of the plurality of apertures in the at least one direction may be at least half of the pitch of the pixel array in the at least one direction. The luminance in the non-viewing directions may be reduced while the brightness in a desirable viewing direction increased.

The pixel layer may comprise different colour pixels and the width of each of the different colour pixels in the at least one direction may be arranged to compensate for chromatic aberration of the plurality of lenses of the lens layer, such that variation in display luminance angular profile is the same for each colour of the different colour pixels. The parallax barrier layer may comprise different width apertures and the width of each of the different width apertures in the at least one direction may be arranged to compensate for angular colour variations of the output of the different colour pixels, such that variation in display luminance angular profile is the same for each colour of the different colour pixels. The pixel layer may comprise different colour pixels and the shape of each of the different colour pixels may be arranged to compensate for angular colour variations of the output of the different colour pixels, such that variation in display luminance angular profile is the same for each colour of the different colour pixels. The display white point may be the same for different viewing angles.

Each of the plurality of lenses may comprise an input aperture and the display device may further comprise one or more first colour filters aligned with one or more of the input apertures of the plurality of lenses. The display device may further comprise one or more second colour filters aligned with one or more of the plurality of apertures of the parallax barrier layer. The one or more second colour filters may comprise an array of red, green and blue colour filters. Luminance provided in non-viewing directions may be reduced. Colour fidelity in preferred viewing directions may be increased.

The plurality of pixels may comprise light emitting diodes. At least one of the light emitting diodes may comprise an organic light emitting material. At least one of the light emitting diodes may be an inorganic micro-LED. A thin display with high brightness may be provided. The display may be curved and/or flexible.

The display device may further comprise an additional linear polariser arranged on an output side of the lens layer, the additional polariser being a linear polariser; and at least one polar control retarder arranged between the lens layer and the additional polariser. The at least one polar control retarder may comprise at least one passive retarder. Security factor of a privacy display may be increased. High image visibility in viewing directions may be achieved.

The at least one polar control retarder may comprise a switchable liquid crystal retarder comprising a layer of liquid crystal material and transmissive electrodes arranged to apply a voltage for switching the layer of liquid crystal material. The at least one polar control retarder may be arranged in a first switchable state of the switchable liquid crystal retarder, simultaneously to introduce no net relative phase shift to orthogonal polarisation components of light received by the at least one polar control retarder along an axis along an inclination direction to the plane of the at least one polar control retarder and to introduce a net relative phase shift to orthogonal polarisation components of light received by the at least one polar control retarder along an axis inclined to the inclination direction to the plane of the at least one polar control retarder; and in a second switchable state of the switchable liquid crystal retarder, simultaneously to introduce no net relative phase shift to orthogonal polarisation components of light received by the at least one polar control retarder along an axis along the inclination direction to the plane of the at least one polar control retarder and to introduce no net relative phase shift to orthogonal polarisation components of light received by the at least one polar control retarder along an axis inclined to the inclination direction to the plane of the at least one polar control retarder. A switchable privacy display that may be switched between a privacy mode and a share mode may be achieved.

The inclination direction may be a direction normal to the plane of the at least one polar control retarder. A privacy display suitable for users with a head-on viewing direction may be provided.

The display device may further comprise a reflective polariser arranged between the display polariser and the at least one polar control retarder, the reflective polariser being a linear polariser arranged to pass the same linearly polarised polarisation component as the display polariser. Increased security factor may be achieved.

The display polariser may be a reflective polariser. Display thickness and cost may be reduced.

According to a second aspect of the present disclosure there is provided a near-eye display apparatus comprising the display device of the first aspect. Increased efficiency may be achieved and stray light reduced. Image contrast and image brightness may be improved. The polarisation switch layer may comprise a switchable liquid crystal layer, the near-eye display apparatus may be arranged to provide pixel data to both the pixel layer and the polarisation switch layer, thereby providing increased dynamic range. Image contrast may be improved.

According to a third aspect of the present disclosure there is provided a head-worn display apparatus comprising: the near-eye display apparatus according to the second aspect; and a head-mounting arrangement for mounting the head-worn display apparatus on a head of a wearer such that the near-eye display apparatus extends across at least one eye of the wearer. A virtual reality display apparatus may be provided with high brightness and high image realism.

According to a fourth aspect of the present disclosure there is provided a view angle control optical element for use with a pixel layer of a display device, the pixel layer comprising a plurality of pixels arranged in a pixel array, wherein the view angle control optical element comprises: a parallax barrier layer comprising a plurality of apertures arranged in an aperture array, wherein, in use, each of the plurality of apertures is aligned with a respective pixel of the plurality of pixels; a lens layer comprising a plurality of lenses arranged in a lens array, wherein, in use, each of the plurality of lenses is aligned with a respective pixel of the plurality of pixels, and wherein the plurality of lenses comprises one or more birefringent lenses; and a display polariser which is a linear polariser, wherein, in use, the parallax barrier layer is arranged between the lens layer and the pixel layer, wherein, in use, the lens layer is arranged between the pixel layer and the display polariser, wherein, in use, the pixel layer is arranged to output light towards the parallax barrier layer, the parallax barrier layer is arranged to receive light output from the pixel layer and to output light towards the lens layer, the lens layer is arranged to receive light output from the parallax barrier layer and to output light towards the display polariser, and the display polariser is arranged to receive light output from the lens layer and to output linearly polarised light, and wherein, in use, the parallax barrier layer is arranged to prevent at least some of the light from each of the plurality of pixels from reaching lenses which are not aligned with that pixel, and wherein each of the plurality of lenses is arranged to reflect at least some of the light received from pixels which are not aligned with that lens. The view angle control optical element may further comprise a liquid crystal switching layer.

According to a fifth aspect of the present disclosure there is provided a display device comprising: a pixel layer comprising a plurality of pixels arranged in a pixel array; a first colour filter layer comprising a plurality of first colour filters arranged in a first colour filter array, wherein each of the plurality of pixels is aligned with a respective first colour filter of the plurality of first colour filters; a lens layer comprising a plurality of lenses arranged in a lens array, wherein each of the plurality of pixels is aligned with a respective lens of the plurality of lenses, and wherein the plurality of lenses comprises one or more birefringent lenses; and a display polariser which is a linear polariser, wherein the first colour filter layer is arranged between the lens layer and the pixel layer, wherein the lens layer is arranged between the pixel layer and the display polariser, wherein the pixel layer is arranged to output light towards the first colour filter layer, the first colour filter layer is arranged to receive light output from the pixel layer and to output light towards the lens layer, the lens layer is arranged to receive light output from the first colour filter layer and to output light towards the display polariser, and the display polariser is arranged to receive light output from the lens layer and to output linearly polarised light, and wherein the first colour filter layer is arranged to prevent at least some of the light from each of the plurality of pixels from reaching lenses which are not aligned with that pixel, and wherein each of the plurality of lenses is arranged to reflect at least some of the light received from pixels which are not aligned with that lens. At least 50%, preferably at least 65% and more preferably at least 75% of the light output by each of the plurality of lenses of the lens layer may be from the pixel with which that lens is aligned. A display device may be provided with a display angular luminance profile that is narrower than provided by the pixels of the pixel layer. Increased brightness may be provided in a desirable viewing direction. The visibility of secondary viewing lobes may be reduced. A display device suitable for use in a privacy display and suitable for use in a near-eye display apparatus may be provided. Colour fidelity may be improved.

Each of the plurality of pixels may be aligned with a respective first colour filter which has the same colour, each of the plurality of pixels may be adjacent to another pixel of the plurality of pixels which has a different colour, and each of the plurality of first colour filters may be adjacent to another first colour filter of the plurality of first colour filters which has a different colour. Off-axis luminance may be reduced and on-axis colour fidelity and brightness improved.

The display device may further comprise a second colour filter layer comprising a plurality of second colour filters arranged in a second colour filter array, wherein each of the plurality of pixels may be aligned with a respective second colour filter of the plurality of second colour filters. The second colour filter layer may be arranged to receive light output from the pixel layer and to output light towards the first colour filter layer. The second colour filter layer may be arranged between the first colour filter layer and the pixel layer. Each second colour filter may be aligned with a respective first colour filter which has the same colour. The first colour filter layer may be located adjacent to the lens layer, and each first colour filter of the first colour filter layer may be aligned with a respective lens of the lens layer. Off-axis luminance may be further reduced and on-axis colour fidelity and brightness further improved.

According to a sixth aspect of the present disclosure there is provided a view angle control optical element for use with a pixel layer of a display device, the pixel layer comprising a plurality of pixels arranged in a pixel array, wherein the view angle control optical element comprises: a first colour filter layer comprising a plurality of first colour filters arranged in a first colour filter array, wherein, in use, each of the plurality of first colour filters is aligned with a respective pixel of the plurality of pixels; a lens layer comprising a plurality of lenses arranged in a lens array, wherein, in use, each of the plurality of lenses is aligned with a respective pixel of the plurality of pixels, and wherein the plurality of lenses comprises one or more birefringent lenses; and a display polariser which is a linear polariser, wherein, in use, the first colour filter layer is arranged between the lens layer and the pixel layer, wherein, in use, the lens layer is arranged between the pixel layer and the display polariser, wherein, in use, the pixel layer is arranged to output light towards the first colour filter layer, the first colour filter layer is arranged to receive light output from the pixel layer and to output light towards the lens layer, the lens layer is arranged to receive light output from the first colour filter layer and to output light towards the display polariser, and the display polariser is arranged to receive light output from the lens layer and to output linearly polarised light, and wherein, in use, the first colour filter layer is arranged to prevent at least some of the light from each of the plurality of pixels from reaching lenses which are not aligned with that pixel, and wherein each of the plurality of lenses is arranged to reflect at least some of the light received from pixels which are not aligned with that lens.

Any of the aspects of the present disclosure may be applied in any combination.

Embodiments of the present disclosure may be used in a variety of optical systems. The embodiments may include or work with a variety of projectors, projection systems, optical components, displays, microdisplays, computer systems, processors, self-contained projector systems, visual and/or audio-visual systems and electrical and/or optical devices. Aspects of the present disclosure may be used with practically any apparatus related to optical and electrical devices, optical systems, presentation systems or any apparatus that may contain any type of optical system. Accordingly, embodiments of the present disclosure may be employed in optical systems, devices used in visual and/or optical presentations, visual peripherals and so on and in a number of computing environments.

Before proceeding to the disclosed embodiments in detail, it should be understood that the disclosure is not limited in its application or creation to the details of the particular arrangements shown, because the disclosure is capable of other embodiments. Moreover, aspects of the disclosure may be set forth in different combinations and arrangements to define embodiments unique in their own right. Also, the terminology used herein is for the purpose of description and not of limitation.

These and other advantages and features of the present disclosure will become apparent to those of ordinary skill in the art upon reading this disclosure in its entirety.

### BRIEF DESCRIPTION OF THE DRAWINGS

Embodiments are illustrated by way of example in the accompanying FIGURES, in which like reference numbers indicate similar parts, and in which:

FIG. 1 is a schematic diagram illustrating in side perspective view a switchable privacy display device for use in ambient illumination comprising an OLED emissive spatial light modulator (SLM), parallax barrier, birefringent lens array, polarisation switch, display polariser, reflective polariser, a switchable polar control retarder and an additional polariser arranged on the output side of the SLM;

FIG. 2A is a schematic diagram illustrating in top view operation of the SLM, parallax barrier, birefringent lens array, polarisation switch and display polariser in privacy mode;

FIG. 2B is a schematic diagram illustrating in front perspective view alignment of optical layers in the optical stack of FIG. 2A in privacy mode;

FIG. 3A is a schematic diagram illustrating in top view operation of the SLM, parallax barrier, birefringent lens array, polarisation switch and display polariser in share mode;

FIG. 3B is a schematic diagram illustrating in front perspective view alignment of optical layers in the optical stack of FIG. 3A in share mode;

FIG. 4A is a schematic diagram illustrating in top view reduction of stray light by reflection from birefringent lenses in privacy mode;

FIG. 4B is a schematic diagram illustrating in top view reduction of stray light by reflection from birefringent lenses in share mode;

FIG. 4C is a schematic graph illustrating schematic output luminance profiles of the arrangements of FIGS. 2A-B and FIGS. 3A-B and TABLE 1;

FIG. 4D is a schematic graph illustrating schematic relative output luminance profiles of FIG. 4C and further comprising profiles of alternative notional arrangements;

FIG. 4E is a schematic graph illustrating encircled luminance profiles for the arrangements of FIGS. 4C-D;

FIG. 5A is a schematic diagram illustrating in top view reduction of reflected ambient light for the embodiment of FIG. 2A in privacy mode;

FIG. 5B is a schematic diagram illustrating in top view reduction of reflected ambient light for the embodiment of FIG. 3A in share mode;

FIG. 6A is a schematic diagram illustrating in side perspective view a polar control retarder;

FIG. 6B is a schematic diagram illustrating in top view a polar control retarder arranged between a display polariser and an additional polariser;

FIG. 6C is a schematic diagram illustrating in top view propagation of display illumination light through the optical stack of FIG. 1 in a share mode;

FIG. 6D is a schematic diagram illustrating in top view propagation of display illumination light through the optical stack of FIG. 1 in a privacy mode;

FIG. 6E is a schematic diagram illustrating in top view propagation of ambient illumination light through the optical stack of FIG. 1 in a share mode;

FIG. 6F is a schematic diagram illustrating in top view propagation of ambient illumination light through the optical stack of FIG. 1 in a privacy mode;

FIG. 7A is a schematic graph illustrating the polar variation of luminance output for the embodiment of FIG. 2A in privacy mode for the case of Lambertian emission of light from the pixels of the SLM;

FIG. 7B is a schematic graph illustrating the polar variation of luminance output for the embodiment of FIG. 3A in share mode for the case of Lambertian emission of light from the pixels of the SLM;

FIG. 7C is a schematic graph illustrating the polar variation of transmission for the embodiment of FIG. 6A and TABLE 2 in privacy mode;

FIG. 7D is a schematic graph illustrating the polar variation of reflectivity for the embodiment of FIG. 6A and TABLE 2 in privacy mode;

FIG. 8 is a schematic graph illustrating the polar variation of security factor for the embodiment of FIG. 1 and TABLES 1-2 in privacy mode;

FIG. 9 is a schematic diagram illustrating in top view a SLM comprising a thin film encapsulation layer and a second transparent layer further comprising at least one encapsulation layer;

FIG. 10A is a schematic diagram illustrating in top view a view angle control optical element comprising a parallax barrier layer, a spacer layer and a birefringent lens layer;

FIG. 10B is a schematic diagram illustrating in top view a view angle control optical element comprising a parallax barrier layer, a spacer layer, a birefringent lens layer and further comprising a polarisation switch and display polariser;

FIG. 11A is a schematic diagram illustrating in side perspective view a switchable privacy display for use in ambient illumination comprising a two dimensional parallax barrier layer and a two dimensional lens array;

FIG. 11B is a schematic diagram illustrating in front perspective view an alternative arrangement of optical layers comprising a one dimensional parallax barrier and a one dimensional lens array;

FIG. 11C is a schematic diagram illustrating in front perspective view an alternative arrangement of optical layers comprising a two dimensional parallax barrier and a one dimensional lens array;

FIG. 11D is a schematic diagram illustrating in front perspective view an alternative arrangement of optical layers comprising a two dimensional parallax barrier and a two dimensional lens array;

FIG. 11E is a schematic diagram illustrating in front perspective view an alternative arrangement of optical layers comprising a one dimensional parallax barrier and a two dimensional lens array;

FIG. 12 is a schematic diagram illustrating in top view a switchable privacy display wherein the pixels of the SLM comprise inorganic micro-LEDs;

FIG. 13A is a schematic diagram illustrating in side perspective view an alternative switchable privacy display for use in ambient illumination wherein the polarisation switch is omitted;

FIG. 13B is a schematic diagram illustrating in top view a view angle control optical element comprising a parallax barrier layer, a spacer layer, a birefringent lens layer and a display polariser for use in the display device of FIG. 13A;

FIG. 13C is a schematic diagram illustrating in side perspective view a non-switched display device comprising a one dimensional parallax barrier array and a one dimensional birefringent lens array;

FIG. 13D is a schematic diagram illustrating in side perspective view a non-switched display device comprising a two dimensional parallax barrier array and a two dimensional birefringent lens array;

FIG. 14A is a schematic diagram illustrating in top view operation of an alternative SLM wherein the birefringent lenses are arranged to have negative optical power in a share mode;

FIG. 14B is a schematic diagram illustrating in top view operation of an alternative SLM wherein the liquid crystal material of the birefringent lenses is concave;

FIG. 14C is a schematic diagram illustrating in top view operation of an alternative switchable privacy display comprising first and second birefringent layers;

FIG. 15A is a schematic diagram illustrating top views of a method to form a birefringent lens array;

FIG. 15B is a schematic diagram illustrating top views of a method to form a view angle control optical element;

FIG. 16A is a schematic diagram illustrating in top view an alternative view angle control optical element wherein the second transparent layer comprises the reflection control polarisation conversion retarder;

FIG. 16B is a schematic diagram illustrating in top view an alternative view angle control optical element wherein the birefringent lens array comprises at least one Fresnel lens;

FIG. 17A is a schematic diagram illustrating in top view an alternative display device wherein a first colour filter array is provided in a colour filter layer at the input apertures of the lens array;

FIG. 17B is a schematic diagram illustrating in top view an alternative display device wherein a second colour filter array is provided in a layer at the apertures of the parallax barrier layer;

FIG. 17C is a schematic diagram illustrating in top view an alternative display device wherein a first colour filter array is provided in a layer between the parallax barrier and the layer of pixels and a second colour filter array is provided in a layer between the parallax barrier and the lens array;

FIG. 18A is a schematic diagram illustrating in top view an alternative display device wherein a colour filter layer is arranged at the input apertures birefringent lens layer;

FIG. 18B is a schematic diagram illustrating in top view an alternative display device wherein the parallax barrier is provided by a first colour filter array and a second colour filter array is provided in a layer between the parallax barrier and the lens array;

FIG. 18C is a schematic diagram illustrating in top view a view angle control element comprising a first colour filter layer;

FIG. 19A is a schematic diagram illustrating in front perspective view an alternative arrangement of optical layers comprising a one dimensional colour filter layer and a one dimensional lens array;

FIG. 19B is a schematic diagram illustrating in front perspective view an alternative arrangement of optical layers comprising an alternative one dimensional colour filter layer and a one dimensional lens array;

FIG. 19C is a schematic diagram illustrating in front perspective view an alternative arrangement of optical layers comprising a one dimensional colour filter layer and a two dimensional lens array;

FIG. 19D is a schematic diagram illustrating in front perspective view an alternative arrangement of optical layers comprising a two dimensional colour filter layer and a two dimensional lens array;

FIG. 20A is a schematic diagram illustrating in top view an alternative display device wherein the width of the apertures of the parallax barrier and the width of the pixels is adjusted to compensate for colour variations in display luminance angular profile;

FIG. 20B is a schematic graph illustrating the profile of output luminance with viewing angle for typical organic LED red pixels, green pixels and blue pixels, and a modified profile for the modified display apparatus of FIG. 20A for organic LED red pixels, green pixels and blue pixels;

FIG. 21A is a schematic diagram illustrating in front view an alternative display device wherein the size of the apertures of the parallax barrier and the width of the pixels is adjusted to compensate for colour variations in display luminance angular profile;

FIG. 21B is a schematic diagram illustrating in front view an alternative display device wherein the width of the apertures of the parallax barrier and the shape of the pixels is adjusted to compensate for colour variations in display luminance angular profile;

FIG. 22 is a schematic diagram illustrating in side perspective view optical window formation for an alternative display device wherein the pixels, the apertures of the parallax barrier and the birefringent lenses have pitches that are adjusted to provide a common optical window from locations across the display device;

FIG. 23A is a schematic diagram illustrating in top view an alternative display device wherein the location of the apertures of the parallax barrier and the location of the birefringent lenses is adjusted to provide off-axis direction for maximum luminance;

FIG. 23B is a schematic diagram illustrating in side perspective view optical window formation for an alternative display device wherein the pitch of the pixels, the pitch of the apertures of the parallax barrier and the pitch of the birefringent lenses are the same;

FIG. 24A is a schematic graph illustrating the polar variation of luminance output for the embodiment of FIG. 23B in privacy mode for the case of pixels arranged on the right side of the display device;

FIG. 24B is a schematic graph illustrating the polar variation of luminance output for the embodiment of FIG. 23B in privacy mode for the case of pixels arranged on the left side of the display device;

FIG. 25A is a schematic diagram illustrating in top view optical window formation for the alternative display device of FIG. 23B wherein the display device is planar;

FIG. 25B is a schematic diagram illustrating in top view optical window formation for the alternative display device of FIG. 23B wherein the display device is curved;

FIG. 26 is a schematic diagram illustrating in top view an automotive vehicle comprising a display device of the present embodiments;

FIG. 27A is a schematic graph illustrating the polar variation of transmission for a polar control retarder comprising the embodiment of TABLE 4;

FIG. 27B is a schematic graph illustrating the polar variation of security factor for a display device of FIG. 1 wherein the display device comprises the luminance output of FIG. 24B and the polar control retarder comprises the transmission profile of FIG. 27A;

FIG. 28A is a schematic diagram illustrating in side perspective view a switchable privacy display device comprising an OLED emissive SLM; and a parallax barrier, birefringent lens array, out-of-plane polariser; polarisation switch, and display polariser arranged on the output side of the SLM;

FIG. 28B is a schematic diagram illustrating in top view the switchable privacy display device of FIG. 28A arranged in a privacy mode;

FIG. 28C is a schematic diagram illustrating in front perspective view, alignment of optical layers in the optical stack of FIGS. 28A-B;

FIG. 28D is a schematic diagram illustrating in side perspective view a view angle control optical element comprising a parallax barrier, birefringent lens array, half-wave retarder, out-of-plane polariser; polarisation switch, and display polariser for use with a pixel layer of a display device;

FIG. 28E is a schematic diagram illustrating in side perspective view a view angle control optical element comprising a parallax barrier, birefringent lens array, half-wave retarder, and out-of-plane polariser for use with a pixel layer of a display device;

FIG. 28F is a schematic diagram illustrating in side perspective view a view angle control optical element comprising a birefringent lens array, half-wave retarder, and out-of-plane polariser for use with a pixel layer of a display device;

FIG. 29A is a schematic diagram illustrating in top view the switchable privacy display device of FIG. 28A arranged in a share mode;

FIG. 29B is a schematic diagram illustrating in front perspective view, alignment of optical layers in the optical stack of FIG. 29A;

FIG. 30A is a schematic diagram illustrating in perspective side view operation of a birefringent lens array, half wave retarder, out-of-plane polariser, switchable layer of liquid crystal material and an in-plane polariser for light rays, inclined in lateral and elevation directions for a privacy mode;

FIG. 30B is a schematic diagram illustrating in perspective side view operation of a birefringent lens array, half wave retarder, out-of-plane polariser, switchable layer of liquid crystal material and an in-plane polariser for light rays, inclined in lateral and elevation directions for a share mode;

FIG. 30C is a schematic diagram illustrating in side view an out-of-plane polariser, a twisted nematic liquid crystal polarisation switch and an in-plane polariser in a first mode for an on-axis ray;

FIG. 30D is a schematic diagram illustrating the arrangement of FIG. 4A in edge view;

FIG. 30E is a schematic diagram illustrating in side view an out-of-plane polariser, a twisted nematic liquid crystal polarisation switch and an in-plane polariser in a second mode for an on-axis ray;

FIG. 30F is a schematic diagram illustrating the arrangement of FIG. 4C in edge view;

FIG. 31A is a schematic graph illustrating an alternative polar variation of luminance output for a birefringent lens array and parallax barrier in privacy mode;

FIG. 31B is a schematic graph illustrating an alternative polar variation of security factor for the luminance profile of FIG. 31A;

FIG. 31C is a schematic graph illustrating a polar variation of transmission for an out-of-plane polariser and in-plane polariser in privacy mode;

FIG. 31D is a schematic graph illustrating an alternative polar variation of security factor for the luminance profile of FIG. 31A and the transmission profile of FIG. 31C;

FIG. 31E is a schematic graph illustrating an alternative polar variation of luminance output for a birefringent lens array and parallax barrier layer in share mode;

FIG. 31F is a schematic graph illustrating a polar variation of transmission for an out-of-plane polariser and in-plane polariser in share mode;

FIG. 31G is a schematic graph illustrating a polar variation of luminance for a privacy display device of the type of FIG. 28A in share mode;

FIG. 32A is a schematic diagram illustrating in perspective side view a polarisation switch arranged between an in-plane polariser, a biaxial retarder and an out-of-plane polariser;

FIG. 32B is a schematic diagram illustrating in perspective front view an alternative biaxial retarder arrangement comprising an A-plate and a negative C-plate;

FIG. 32C is a schematic diagram illustrating in perspective front view an alternative biaxial retarder arrangement comprising an A-plate and a positive C-plate;

FIG. 32D is a schematic diagram illustrating in perspective top view an out-of-plane polariser;

FIG. 32E is a schematic diagram illustrating in perspective left side view an out-of-plane polariser;

FIG. 32F is a schematic diagram illustrating in perspective upper left quadrant view an out-of-plane polariser;

FIG. 32G is a schematic graph illustrating a polar variation of output polarisation state from an out-of-plane polariser without a biaxial retarder arrangement;

FIG. 32H is a schematic graph illustrating a polar variation of output polarisation state from an out-of-plane polariser arranged with a biaxial retarder arrangement;

FIG. 32I is a schematic diagram illustrating in perspective top view propagation of a polarisation state through an out-of-plane polariser and a biaxial retarder arrangement;

FIG. 32J is a schematic diagram illustrating in perspective left side view propagation of a polarisation state through an out-of-plane polariser and a biaxial retarder arrangement;

FIG. 32K is a schematic diagram illustrating in perspective upper left quadrant view propagation of a polarisation state through an out-of-plane polariser and a biaxial retarder arrangement;

FIG. 33A is a schematic graph illustrating a polar variation of transmission for the arrangement of FIG. 32A in privacy mode;

FIG. 33B is a schematic graph illustrating a polar variation of transmission for the arrangement of FIG. 32A in share mode;

FIG. 33C is a schematic diagram illustrating in perspective front view a polarisation switch comprising a vertically aligned polarisation switch layer with privacy and share mode regions;

FIG. 33D is a schematic graph illustrating a polar variation of transmission for the polarisation switch of FIG. 33C and TABLE 7 in the share region, the out-of-plane polariser and the biaxial retarder of TABLE 5A;

FIG. 34A, FIG. 34B, FIG. 34C, and FIG. 34D are schematic diagrams illustrating in top view various alternative structures of display device optical stacks comprising out-of-plane polarisers;

FIG. 35A is a schematic diagram illustrating in side perspective view a near-eye display device comprising the display device of the type of FIG. 23A, a pixellated polarisation switch and an eyepiece lens;

FIG. 35B is a schematic diagram illustrating in side view the operation of the near-eye display device of FIG. 35A;

FIG. 35C is a schematic diagram illustrating in side view the operation of the near-eye display device of FIG. 35A arranged to provide increased dynamic range;

FIG. 35D is a schematic diagram illustrating in side view the operation of a near-eye display device arranged to provide increased image contrast; and

FIG. 36 is a schematic diagram illustrating in rear view a head-mounted display device.

### DETAILED DESCRIPTION

Terms related to optical retarders for the purposes of the present disclosure will now be described.

In a layer comprising a uniaxial birefringent material there is a direction governing the optical anisotropy whereas all directions perpendicular to it (or at a given angle to it) have equivalent birefringence.

The optical axis of an optical retarder refers to the direction of propagation of a light ray in the uniaxial birefringent material in which no birefringence is experienced. This is different from the optical axis of an optical system which may for example be parallel to a line of symmetry or normal to a display surface along which a principal ray propagates.

For light propagating in a direction orthogonal to the optical axis, the optical axis is the slow axis when linearly polarized light with an electric vector direction parallel to the slow axis travels at the slowest speed. The slow axis direction is the direction with the highest refractive index at the design wavelength. Similarly the fast axis direction is the direction with the lowest refractive index at the design wavelength.

For positive dielectric anisotropy uniaxial birefringent materials the slow axis direction is the extraordinary axis of the birefringent material. For negative dielectric anisotropy uniaxial birefringent materials the fast axis direction is the extraordinary axis of the birefringent material.

The terms half a wavelength and quarter a wavelength refer to the operation of a retarder for a design wavelength Ao that may typically be between 500 nm and 570 nm. In the present illustrative embodiments exemplary retardance values are provided for a wavelength of 550 nm unless otherwise specified.

The retarder provides a phase shift between two perpendicular polarization components of the light wave incident thereon and is characterized by the amount of relative phase, Γ, that it imparts on the two polarization components: which is related to the birefringence Δn and the thickness d of the retarder by

$$Γ = 2. π . Δ n . d / {λ}_{0} \qquad eqn . 1$$

In eqn. 1, Δn is defined as the difference between the extraordinary and the ordinary index of refraction, i.e.

$$Δ n = {n}_{e} - {n}_{o} \qquad eqn . 2$$

For a half-wave retarder, the relationship between d, Δn, and λ₀ is chosen so that the phase shift between polarization components is Γ=π. For a quarter-wave retarder, the relationship between d, Δn, and λ₀ is chosen so that the phase shift between polarization components is Γ=π/2. The term half-wave retarder herein typically refers to light propagating normal to the retarder and normal to the spatial light modulator.

An absorption type polariser transmits light waves of a specific polarisation state and absorbs light (in a spectral waveband) of different polarisation states which may be orthogonal polarisation states to the specific polarisation state. For a given wavefront, an absorptive linear polariser absorbs light waves of a specific linear polarisation state and transmits light waves of the orthogonal polarisation state of the wavefront. The absorptive linear polariser comprises an absorption axis with unit vector direction kₑ which may alternatively be termed the optical axis or the director of the absorption material. Orthogonal directions kₒ to the absorption axis direction may be termed transmission axes.

A dichroic material has different absorption coefficients αₑ. αₒ for light polarized in different directions, where the complex extraordinary refractive index is:

$$\vec{{n}_{e}} = {n}_{e} + i . {α}_{e} \qquad eqn . 3 A$$

and the complex ordinary refractive index is:

$$\vec{{n}_{o}} = {n}_{o} + i . {α}_{o} \qquad eqn . 3 B$$

Absorptive linear polarisers may comprise a dichroic material such a dye or iodine. During manufacture a polyvinyl alcohol (PVA) layer is stretched so that the PVA chains align in one particular direction. The PVA layer is doped with iodine molecules, from which valence electrons are able to move linearly along the polymer chains, but not transversely. An incident polarisation state parallel to the chains is, at least in part, absorbed and the perpendicular polarisation state is substantially transmitted. Such a polariser may conveniently provide an in-plane polariser, that is a polariser wherein the absorption axis of the dichroic material is in a direction in which the plane of the polariser extends, as opposed to an out-of-plane polariser which has an absorption axis which has at least a component that is orthogonal to the plane of the out-of-plane polariser.

Another type of absorptive linear polariser is a liquid crystal dye type dichroic linear polariser. A thermotropic liquid crystal material is doped with a dye, and the liquid crystal material is aligned during manufacture, or by an electric field. The liquid crystal layers may be untwisted, or may incorporate a twist from one side of the device to the other. Alternatively alignment may be provided by lyotropic liquid crystal molecules that self-align onto a surface by provision of amphiphilic compounds (with hydrophilic and hydrophobic molecular groups) during manufacture. The alignment may be aided by mechanical movement of the liquid by for example a Meyer rod in a coating machine. The liquid crystal material may be a curable liquid crystal material. The dye may comprise an organic material that is aligned by the liquid crystal material or is provided in the liquid crystal molecules or may comprise silver nano-particles. Such polarisers may provide in-plane polarisers or may provide out-of-plane polarisers, wherein the optical axis direction kₑ or the absorption axis is out of the plane of the polariser. The directions kₒ of the transmission axes may be in the plane of the out-of-plane polariser. The direction kₑ may alternatively be referred to as the extraordinary axis direction and the directions kₒ may be referred to as the ordinary axis directions of the dichroic molecules.

If the absorbing dye molecules are rod-shaped then the polariser absorbs along a single axes and transmits on orthogonal axes. If the absorbing dye molecules are disc-shaped rather than rod-shaped, then the polariser can absorb two orthogonal axes and transmit the third.

Some aspects of the propagation of light rays through a transparent retarder between a pair of polarisers will now be described.

The state of polarisation (SOP) of a light ray is described by the relative amplitude and phase shift between any two orthogonal polarization components. Transparent retarders do not alter the relative amplitudes of these orthogonal polarisation components but act only on their relative phase. Providing a net phase shift between the orthogonal polarisation components alters the SOP whereas maintaining net relative phase preserves the SOP. In the current disclosure, the SOP may be termed the polarisation state.

A linear SOP has a polarisation component with a non-zero amplitude and an orthogonal polarisation component which has zero amplitude.

A linear polariser transmits a unique linear SOP that has a linear polarisation component parallel to the electric vector transmission direction of the linear polariser and attenuates light with a different SOP. The term “electric vector transmission direction” refers to a non-directional axis of the polariser parallel to which the electric vector of incident light is transmitted, even though the transmitted “electric vector” always has an instantaneous direction. The term “direction” is commonly used to describe this axis.

Absorbing polarisers are polarisers that absorb one polarisation component of incident light and transmit a second orthogonal polarisation component. Examples of absorbing linear polarisers are dichroic polarisers.

Reflective polarisers are polarisers that reflect one polarisation component of incident light and transmit a second orthogonal polarisation component. Examples of reflective polarisers that are linear polarisers are multilayer polymeric film stacks such as DBEF™ or APF™ from 3M Corporation, or wire grid polarisers such as ProFlux™ from Moxtek. Reflective linear polarisers may further comprise cholesteric reflective materials and a quarter waveplate arranged in series.

A retarder arranged between a linear polariser and a parallel linear analysing polariser that introduces no relative net phase shift provides full transmission of the light other than residual absorption within the linear polariser.

A retarder that provides a relative net phase shift between orthogonal polarisation components changes the SOP and provides attenuation at the analysing polariser.

In the present disclosure an ‘A-plate’ refers to an optical retarder utilizing a layer of birefringent material with its optical axis parallel to the plane of the layer.

A ‘positive A-plate’ refers to positively birefringent A-plates, i.e. A-plates with a positive Δn.

In the present disclosure a ‘C-plate’ refers to an optical retarder utilizing a layer of birefringent material with its optical axis perpendicular to the plane of the layer. A ‘positive C-plate’ refers to positively birefringent C-plates, i.e. C-plates with a positive Δn. A ‘negative C-plate’ refers to negatively birefringent C-plates, i.e. C-plates with a negative Δn.

‘O-plate’ refers to an optical retarder utilizing a layer of birefringent material with its optical axis having a component parallel to the plane of the layer and a component perpendicular to the plane of the layer. A ‘positive O-plate’ refers to positively birefringent O-plates, i.e. O-plates with a positive Δn.

A biaxial-plate or ‘B-plate’ is a non-chiral retarder that has three different principal refractive indices nx, ny, nz wherein:

$$nx \neq ny \neq nz \qquad eqn . 4 A$$

The out-of-plane retardation of a B-plate is described by the parameter Rth wherein

$$Rth = ( ( nx + ny ) / 2 - nz ) d \qquad eqn . 4 B$$

A B-plate is typically fabricated by stretching organic polymer films along two orthogonal in-plane directions that become two of the three principal axes; the third being orthogonal to both and out-of-plane. The direction that is stretched the most induces the largest principal refractive index along that same direction. A smaller refractive index results along the orthogonal in-plane stretch direction leaving the smallest third principal refractive index out-of-plane.

The angular dependence of birefringence is different between uniaxial A-plates, uniaxial C-plates and biaxial B-plates. In particular A-plates and C-plates have only one propagation direction with no birefringence whereas B-plates can achieve increased control of modification of output polarisation states with respect to transmission angle.

Achromatic retarders may be provided wherein the material of the retarder is provided with a retardance Δn·d that varies with wavelength λ as

$$Δ n . d / λ = σ \qquad eqn . 5$$

where σ is substantially a constant.

Examples of suitable materials include modified polycarbonates from Teijin Films. Achromatic retarders may be provided in the present embodiments to advantageously minimise colour changes between polar angular viewing directions which have low luminance reduction and polar angular viewing directions which have increased luminance reductions as will be described below.

Various other terms used in the present disclosure related to retarders and to liquid crystals will now be described.

A liquid crystal cell has a retardance given by Δn·d where Δn is the birefringence of the liquid crystal material in the liquid crystal cell and d is the thickness of the liquid crystal cell, independent of the alignment of the liquid crystal material in the liquid crystal cell.

Homogeneous alignment refers to the alignment of liquid crystals in liquid crystal displays where molecules align substantially parallel to a substrate. Homogeneous alignment is sometimes referred to as planar alignment. Homogeneous alignment may typically be provided with a small pre-tilt such as 2 degrees, so that the molecules at the surfaces of the alignment layers of the liquid crystal cell are slightly inclined as will be described below. Pretilt is arranged to minimise degeneracies in switching of cells or in alignment of curable liquid crystal layers before a curing step.

In the present disclosure, homeotropic alignment is the state in which rod-like liquid crystalline molecules align substantially perpendicularly to the substrate. In discotic liquid crystals homeotropic alignment is defined as the state in which an axis of the column structure, which is formed by disc-like liquid crystalline molecules, aligns perpendicularly to a surface. In homeotropic alignment, pretilt is the tilt angle of the molecules that are close to the alignment layer and is typically close to 90 degrees and for example may be 88 degrees.

In a twisted liquid crystal layer, a twisted configuration (also known as a helical structure or helix) of nematic liquid crystal molecules is provided. The twist may be achieved by means of a non-parallel alignment of alignment layers. Further, cholesteric dopants may be added to the liquid crystal material to break degeneracy of the twist direction (clockwise or anti-clockwise) and to further control the pitch of the twist in the relaxed (typically undriven) state. A supertwisted liquid crystal layer has a twist of greater than 180 degrees. A twisted nematic layer used in spatial light modulators typically has a twist of 90 degrees.

Liquid crystal molecules with positive dielectric anisotropy may be switched from a homogeneous alignment (such as an A-plate retarder orientation) to a homeotropic alignment (such as a C-plate or O-plate retarder orientation) by means of an applied electric field.

Liquid crystal molecules with negative dielectric anisotropy may be switched from a homeotropic alignment (such as a C-plate or O-plate retarder orientation) to a homogeneous alignment (such as an A-plate retarder orientation) by means of an applied electric field.

Rod-like molecules have a positive birefringence so that nₑ>nₒ as described in eqn. 2. Discotic molecules have negative birefringence so that nₑ<nₒ.

Positive retarders such as A-plates, positive O-plates and positive C-plates may typically be provided by stretched films or rod-like liquid crystal molecules. Negative retarders such as negative C-plates may be provided by stretched films or discotic-like liquid crystal molecules.

Parallel liquid crystal cell alignment refers to the alignment direction of homogeneous alignment layers being parallel or more typically antiparallel. In the case of pre-tilted homeotropic alignment, the alignment layers may have components that are substantially parallel or antiparallel. Hybrid aligned liquid crystal cells may have one homogeneous alignment layer and one homeotropic alignment layer. Twisted liquid crystal cells may be provided by alignment layers that do not have parallel alignment, for example oriented at 90 degrees to each other.

Transmissive spatial light modulators may further comprise retarders between the input display polariser and the output display polariser for example as disclosed in U.S. Pat. No. 8,237,876, which is herein incorporated by reference in its entirety. Such retarders (not shown) are in a different place to the passive retarders of the present embodiments. Such retarders compensate for contrast degradations for off-axis viewing locations, which is a different effect to the luminance reduction for off-axis viewing positions of the present embodiments.

A private mode of a display is one in which a viewer sees a low contrast sensitivity such that an image is not clearly visible. Contrast sensitivity is a measure of the ability to discern between luminances of different levels in a static image. Inverse contrast sensitivity may be used as a measure of visual security, in that a high visual security level (VSL) corresponds to low image visibility.

For a privacy display providing an image to a viewer, visual security may be given as:

$$V = ( Y + R ) / ( Y - K ) \qquad eqn . 6$$

where V is the visual security level (VSL), Y is the luminance of the white state of the display at a snooper viewing angle (which may be termed a non-viewing direction), K is the luminance of the black state of the display at the snooper viewing angle and R is the luminance of reflected light from the display.

Panel contrast ratio is given as:

$$C = Y / K \qquad eqn . 7$$

so the visual security level may be further given as:

$$V = ( P . {Y}_{max} + I . ρ / π ) / ( P . ( {Y}_{max} - {Y}_{max} / C ) ) \qquad eqn . 8$$

where: Yₘₐₓ is the maximum luminance of the display; P is the off-axis relative luminance typically defined as the ratio of luminance at the snooper angle to the maximum luminance Yₘₐₓ; C is the image contrast ratio; ρ is the surface reflectivity; π is a solid angle factor (with units steradians) and/is the illuminance. The units of Yₘₐₓ are the units of I divided by solid angle in units of steradian.

The luminance of a display varies with angle and so the maximum luminance of the display Yₘₐₓ occurs at a particular angle that depends on the configuration of the display.

In many displays, the maximum luminance Yₘₐₓ occurs head-on, i.e. normal to the display. Any display device disclosed herein may be arranged to have a maximum luminance Yₘₐₓ that occurs head-on, in which case references to the maximum luminance of the display device Yₘₐₓ may be replaced by references to the luminance normal to the display device.

Alternatively, any display described herein may be arranged to have a maximum luminance Yₘₐₓ that occurs at a polar angle to the normal to the display device that is greater than 0°. By way of example, the maximum luminance Yₘₐₓ may occur at a non-zero polar angle and at an azimuth angle that has for example zero lateral angle so that the maximum luminance is for an on-axis user that is looking down on to the display device. The polar angle may for example be 10 degrees and the azimuthal angle may be the northerly direction (90 degrees anti-clockwise from easterly direction). The viewer may therefore desirably see a high luminance at typical non-normal viewing angles.

The off-axis relative luminance, P is sometimes referred to as the privacy level. However, such privacy level P describes relative luminance of a display at a given polar angle compared to head-on luminance, and in fact is not a measure of privacy appearance.

The illuminance, I is the luminous flux per unit area that is incident on the display and reflected from the display towards the viewer location. For Lambertian illuminance, and for displays with a Lambertian front diffuser illuminance I is invariant with polar and azimuthal angles. For arrangements with a display with non-Lambertian front diffusion arranged in an environment with directional (non-Lambertian) ambient light, illuminance I varies with polar and azimuthal angle of observation.

Thus in a perfectly dark environment, a high contrast display has VSL of approximately 1.0. As ambient illuminance increases, the perceived image contrast degrades, VSL increases and a private image is perceived.

For typical liquid crystal displays the panel contrast C is above 100:1 for almost all viewing angles, allowing the visual security level to be approximated to:

$$V = 1 + I . ρ / ( π . P . {Y}_{max} ) \qquad eqn . 9$$

In the present embodiments, in addition to the exemplary definition of eqn. 6, other measurements of visual security level, V may be provided, for example to include the effect on image visibility to a snooper of snooper location, image contrast, image colour and white point and subtended image feature size. Thus the visual security level may be a measure of the degree of privacy of the display but may not be restricted to the parameter V.

The perceptual image security may be determined from the logarithmic response of the eye, such that a Security Factor, S is given by

$$S = {log}_{10} ( V ) \qquad eqn . 10$$

$$S = {log}_{10} ( 1 + α . ρ / ( π . P ) ) \qquad eqn . 11$$

where α is the ratio of illuminance/to maximum luminance Yₘₐₓ.

Desirable limits for S were determined in the following manner. In a first step a privacy display device was provided. Measurements of the variation of privacy level, P(θ) of the display device with polar viewing angle and variation of reflectivity ρ(θ) of the display device with polar viewing angle were made using photopic measurement equipment. A light source such as a substantially uniform luminance light box was arranged to provide illumination from an illuminated region that was arranged to illuminate the privacy display device along an incident direction for reflection to a viewer positions at a polar angle of greater than 0° to the normal to the display device. The variation I(θ) of illuminance of a substantially Lambertian emitting lightbox with polar viewing angle was determined by and measuring the variation of recorded reflective luminance with polar viewing angle taking into account the variation of reflectivity ρ(θ). The measurements of P(θ), ρ(θ) and I(θ) were used to determine the variation of Security Factor S(θ) with polar viewing angle along the zero elevation axis.

In a second step a series of high contrast images were provided on the privacy display including (i) small text images with maximum font height 3 mm, (ii) large text images with maximum font height 30 mm and (iii) moving images.

In a third step each viewer (with eyesight correction for viewing at 1000 mm where appropriate) viewed each of the images from a distance of 1000 mm, and adjusted their polar angle of viewing at zero elevation until image invisibility was achieved for one eye from a position near on the display at or close to the centre-line of the display. The polar location of the viewer's eye was recorded. From the relationship S(θ), the security factor at said polar location was determined. The measurement was repeated for the different images, for various display luminance Yₘₐₓ, different lightbox illuminance I(θ=0), for different background lighting conditions and for different viewers.

From the above measurements S<1.0 provides low or no visual security, and S≥1 makes the image not visible. In the range 1.0≤S<1.5, even though the image is not visible for practical purposes, some features of the image may still be perceived dependent on the contrast, spatial frequency and temporal frequency of image content, whereas in the range 1.5≤S<1.8, the image is not visible for most images and most viewers and in the range S≥1.8 the image is not visible, independent of image content for all viewers.

In practical display devices, this means that it is desirable to provide a value of S for an off-axis viewer who is a snooper that meets the relationship S≥Sₘᵢₙ, where: Sₘᵢₙ has a value of 1.0 or more to achieve the effect that in practical terms the displayed image is not visible to the off-axis viewer.

At an observation angle θ in question, the security factor Sₙ for a region of the display labelled by the index n is given from eqn. 10 and eqn. 11 by:

$${S}_{n} ( θ ) = {log}_{10} [ 1 + {ρ}_{n} ( θ ) . α ( θ ) / ( π . {P}_{n} ( θ ) ) ] \qquad eqn . 12$$

where: α is the ratio of illuminance I(θ) onto the display that is reflected from the display to the angle in question and with units lux (lumen·m⁻²), to maximum luminance Yₘₐₓ with units of nits (lumen·m⁻²·sr⁻¹) where the units of α are steradians, π is a solid angle in units of steradians, ρₙ(θ) is the reflectivity of the display device along the observation direction in the respective n^{th} region, and Pₙ(θ) is the ratio of the luminance of the display device along the observation direction in the respective n^{th} region.

In human factors measurement, it has been found that desirable privacy displays of the present embodiments described hereinbelow typically operate with security factor Sₙ≥1.0 at the observation angle when the value of the ratio α of illuminance/to maximum luminance Yₘₐₓ is 4.0. For example, the illuminance I(θ=−45°) that illuminates the display and is directed towards the snooper at the observation direction (θ=+45°) after reflection from the display may be 1000 lux and the maximum display illuminance Yₘₐₓ that is provided for the user may be 250 nits. This provides an image that is not visible for a wide range of practical displays.

More preferably, the display may have improved characteristics of reflectivity ρₙ (θ=45°) and privacy Pₙ(θ=−45°) by operating with security factor Sₙ≥1.0 at the observation angle when the ratio α is 2.0. Such an arrangement desirably improves the relative perceived brightness and contrast of the display to the primary user near to the direction of Yₘₐₓ while achieving desirable security factor, Sₙ≥1.0. Most preferably, the display may have improved characteristics of reflectivity ρₙ (θ=45°) and privacy Pₙ (θ=45°) by operating with security factor Sₙ≥1.0 at the observation angle when the ratio α is 1.0. Such an arrangement achieves desirably high perceived brightness and contrast of the display to the primary user near to the direction of Yₘₐₓ in comparison to the brightness of illuminated regions around the display, while achieving desirable security factor, Sₙ≥1.0 for an off-axis viewer 47 at the observation direction.

The above discussion focusses on reducing visibility of the displayed image to an off-axis viewer who is a snooper, but similar considerations apply to visibility of the displayed image to the intended user of the display device who is typically on-axis. In this case, decrease of the level of the visual security level (VSL) V corresponds to an increase in the visibility of the image to the viewer. During observation S<0.2 may provide acceptable visibility (perceived contrast ratio) of the displayed image and more desirably S<0.1. In practical display devices, this means that it is desirable to provide a value of S for an on-axis viewer who is the intended user of the display device that meets the relationship S≤Sₘₐₓ, where Sₘₐₓ has a value of 0.2.

In the present discussion the colour variation Δε of an output colour (u_{w}′+Δu′, v_{w}′+Δv′) from a desirable white point (u_{w}′, v_{w}′) may be determined by the CIELUV colour difference metric, assuming a typical display spectral illuminant and is given by:

$${{{Δε = ( Δ u ’}^{2} + Δ v ’}^{2} )}^{1 / 2} \qquad eqn . 13$$

A diffractive effect of a liquid crystal layer relates to the interference or bending of waves around the corners of an obstacle or through an aperture into the region of the geometrical shadow of the obstacle/aperture. The diffractive effect arises from the interaction of plane waves incident onto the phase structure of the layer, rather than the propagation of rays through the layer.

The structure and operation of various privacy display apparatuses will now be described. In this description, common elements have common reference numerals. It is noted that the disclosure relating to any element applies mutatis mutandi to each device in which the same or corresponding element is provided. Accordingly, for brevity such disclosure is not repeated. Similarly, the various features of any of the following examples may be combined together in any combination.

It would be desirable to provide a switchable privacy display with high security factor comprising a spatial light modulator (SLM) comprising pixels with a wide output luminous intensity distribution.

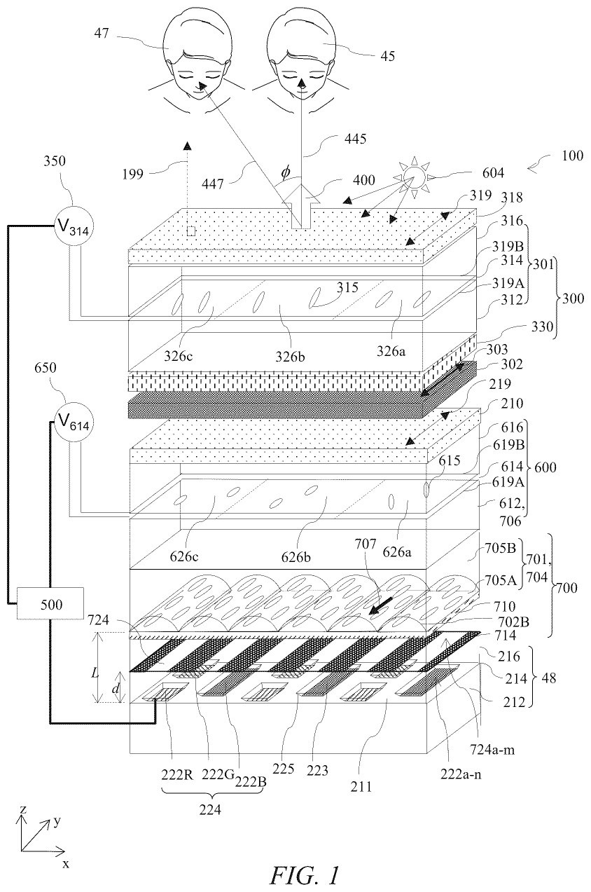

FIG. 1 is a schematic diagram illustrating in side perspective view a switchable privacy display device 100 for use in ambient illumination comprising an OLED emissive SLM 48, a parallax barrier layer 714, a birefringent lens array 701a-m, a polarisation switch layer 614, display polariser 210, reflective polariser 302, a switchable polar control retarder 300 and an additional polariser 318 arranged on the output side of the SLM 48.

FIG. 1 illustrates a display device 100 arranged to illuminate users 45, 47. In a privacy mode, the user 45 is provided with an image with high image visibility and is located around a nominal user direction 445 that may be parallel to the normal direction 199 to the display device 100, or may be inclined to the normal direction 199. The user 47 in a privacy mode may be termed a snooper 47 and is located in snooper direction 447 that is inclined to the nominal user direction 445, and the display device 100 is intended to provide light output rays in direction 447 with a high security factor, S to the snooper 47. In a share mode, both users 45, 47 are intended to see light output for an image on the display with high image visibility for directions 445, 447. In an illustrative embodiment, the off-axis angle ø may be 40° or greater in a laptop display device 100, or may be 25° or greater in an automotive passenger infotainment display device 100.

The display device 100 comprises a pixel layer 214 comprising a plurality of red, green and blue pixels 222R. 222G, 222B arranged in a pixel array 222a-n. SLM 48 may comprise a backplane substrate 212, and first transparent layer 216, with the pixel layer 214 arranged therebetween.

The plurality of pixels 222 comprise light emitting diodes and the pixels 222R, 222G, 222B comprise the light emitting regions of organic light emitting material 223 that are arranged in wells 225, separated by gaps 211. The plurality of pixels 222 may further comprise white pixels 222W, yellow pixels 222Y or other coloured emission pixels 2220 (not shown). Advantageously colour gamut may be increased. The pixels 222R, 222G, 222B and pixels 222W, 222Y, 2220 when present together provide an addressable colour pixel 224.

The light emitting diodes of the pixels 222 may emit light in a narrow spectral band, such as red, green or blue spectral bands. Alternatively the light emitting diodes of the pixels 222 may emit the same colour light and may be provided with respective red, green and blue colour conversion elements such as quantum dots or phosphors. Alternatively the light emitting diodes of the pixels 222 may each emit white light such as by blue light emitting diodes combined with a white colour conversion material such as a phosphor or quantum dot material; and a colour filter array may be arranged to filter the white light into respective red, green or blue spectral bands. Such colour filter array is arranged at the pixel layer 214 to receive light from the light emitting diodes of the pixels 222.

A parallax barrier layer 714 comprising a plurality of apertures 724 is arranged in an aperture array 724a-m. In the embodiment of FIG. 1, the plurality of apertures 724 comprise a one dimensional array aperture array 724a-m, wherein each of the apertures 724 are extended in the y-direction, that is orthogonal to the normal 199 (z-axis) to the parallax barrier layer 714 and orthogonal to a predetermined direction (x-axis). The parallax barrier layer 714 comprises light blocking regions 726 arranged between the plurality of apertures 724. The display device 100 further comprises a lens layer 704 comprising a plurality of lenses 701 arranged in a lens array 701a-m. The parallax barrier layer 714 may typically be provided by printing or deposition of a light absorbing material such as an ink in the light blocking regions 726. The thickness of the parallax barrier 714 may be small, for example a few micrometers or less.

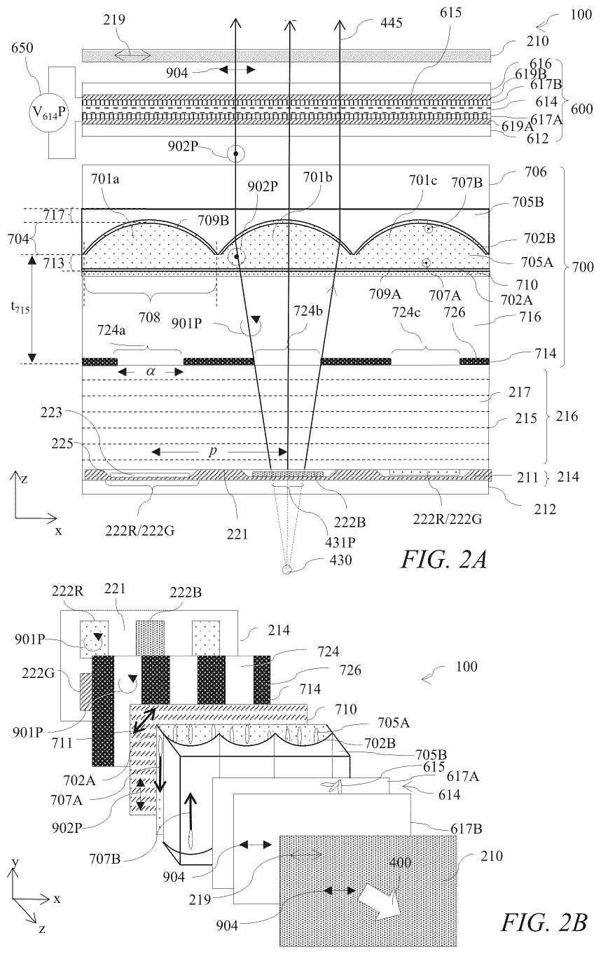

A polarisation switch 600 comprising a polarisation switch layer 614 is arranged between the lens layer 704 and the display polariser 210. The operation of the pixel layer 214, parallax barrier layer 714, lens layer 704 and polarisation switch 600 will be described further with respect to FIGS. 2A-B.

The display device 100 further comprises an additional linear polariser 318 arranged on an output side of the lens layer 704, the additional polariser 318 being a linear polariser; and at least one polar control retarder 300 arranged between the lens layer 704 and the additional polariser 318. The at least one polar control retarder 300 comprises at least one passive retarder 330. The at least one polar control retarder 300 comprises a switchable liquid crystal retarder 301 comprising a layer 314 of liquid crystal material 315 and transmissive electrodes 319A, 319B arranged to apply a voltage V₃₁₄ for switching the layer 301 of liquid crystal material 315. The operation and alternative embodiments of the polar control retarder 300 arranged between display polariser 210 and additional polariser 318 are described in U.S. Pat. No. 11,092,851, which is herein incorporated by reference in its entirety.

Display polariser 210 and additional polariser 318 are in-plane polarisers as will be described further hereinbelow.

The display device 100 further comprises a reflective polariser 302 arranged between the display polariser 210 and the at least one polar control retarder 300, the reflective polariser 302 being a linear polariser arranged to pass the same linearly polarised polarisation component as the display polariser 210. The operation and alternative embodiments of the polar control retarder 300 arranged between reflective polariser 302 and additional polariser 318 are described in U.S. Pat. No. 10,976,578, which is herein incorporated by reference in its entirety.

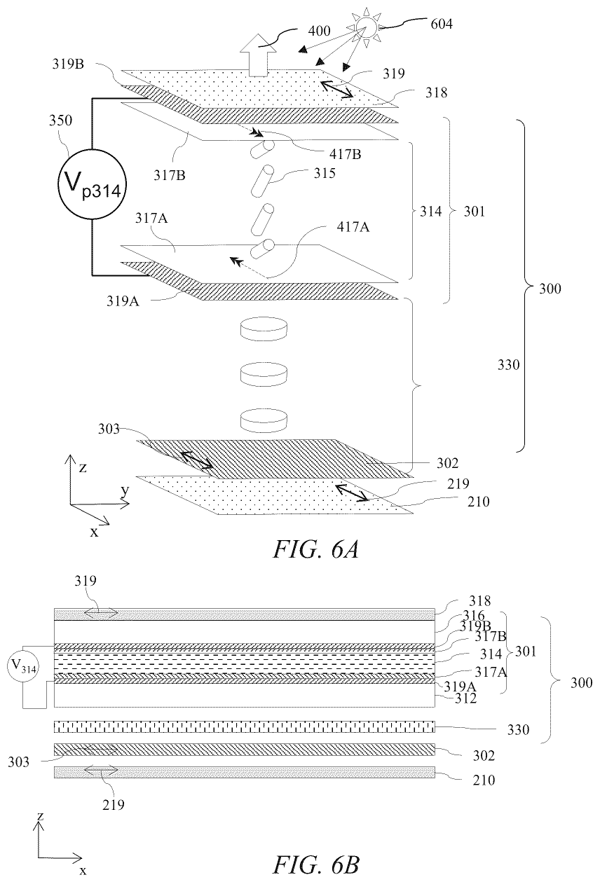

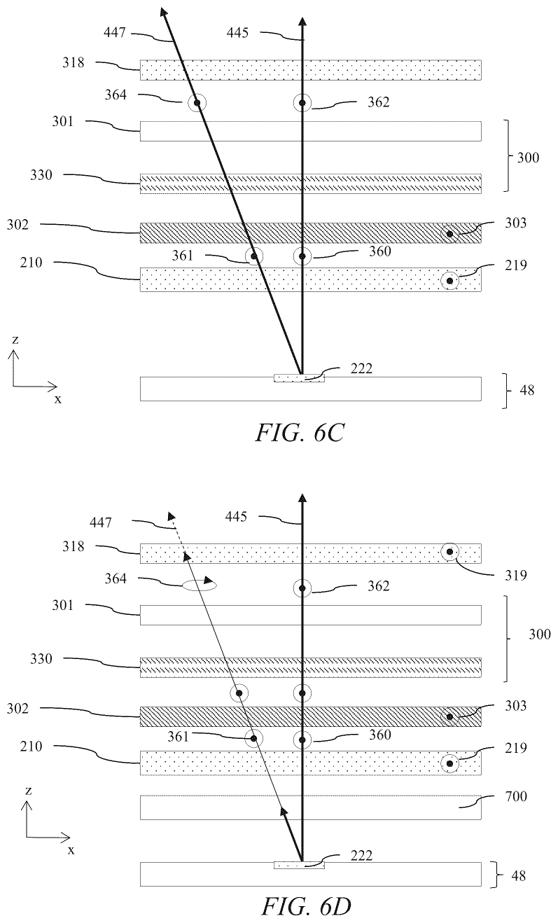

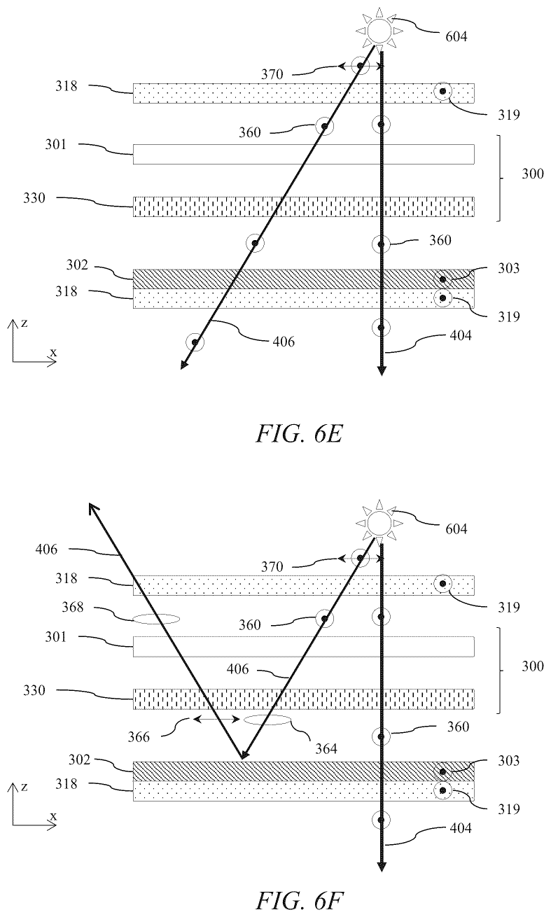

An illustrative embodiment of the polar control retarder 300 and operation thereof is described hereinbelow with respect to FIGS. 6A-B. FIG. 1 further illustrates that at least one of the electrodes 319A, 319B may be patterned into regions 326a, 326b, 326c. The output of the polar control retarder 300 may be different in different regions to achieve different regions of privacy and share mode operation across the display device 100.

FIG. 2A is a schematic diagram illustrating in top view operation of the SLM 48, parallax barrier layer 714, birefringent lens array 701a-m, polarisation switch layer 614 and display polariser 210 in privacy mode; and FIG. 2B is a schematic diagram illustrating in front perspective view alignment of optical layers in the optical stack of FIG. 2A in privacy mode. Features of the embodiments of FIGS. 2A-B not discussed in further detail may be assumed to correspond to the features with equivalent reference numerals as discussed above, including any potential variations in the features.

FIG. 2A illustrates that each of the plurality of pixels 222R, 222G, 222B is aligned with a respective aperture 724 of the plurality of apertures. Further, each of the plurality of pixels 222 is aligned with a respective lens 701 of the plurality of lenses 701.

The first transparent layer 216 is arranged between the pixel layer 214 and the parallax barrier layer 714 and the separation d of the parallax barrier layer 714 from the pixel layer 214 is provided by the first transparent layer 216. In the embodiment of FIG. 1, each aperture 724 is aligned with a column of pixels 222 where each column may comprise at least one of red pixels 222R, green pixels 222G and blue pixels 222B. In at least one direction (such as the lateral direction that may be the x-axis direction) across the pixel layer 214, a width α of each of the plurality of apertures 724 is equal to or less than a pitch p of the pixel array 222a-n in the at least one direction.

The first transparent layer 216 comprises a thin film encapsulation layer comprising transparent inorganic layers 215 and transparent organic layers 217 arranged to provide a barrier to water and oxygen. Advantageously degradation of the organic light emitting material 223 may be reduced or removed. Further the layer 216 provides a desirable spacer of thickness d for the parallax barrier layer 714 as will be described further hereinbelow.

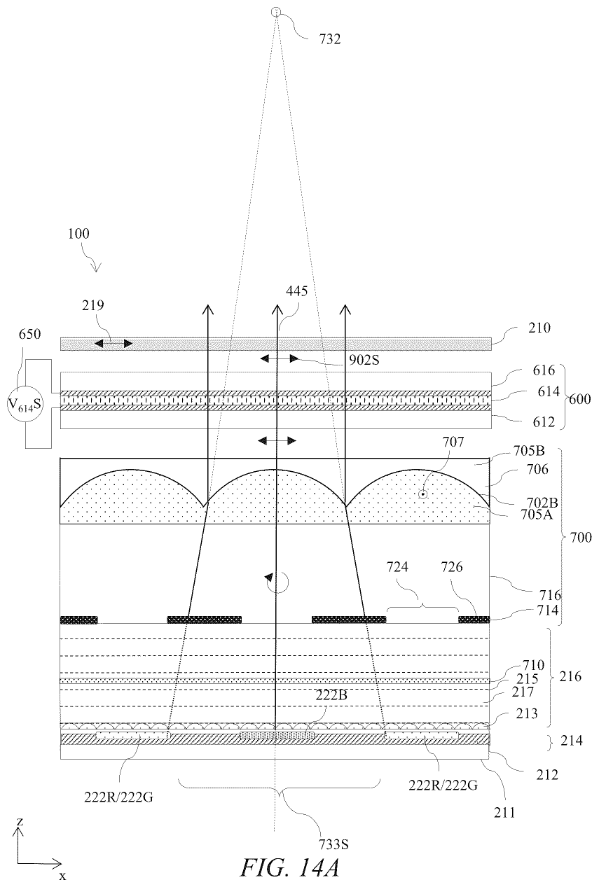

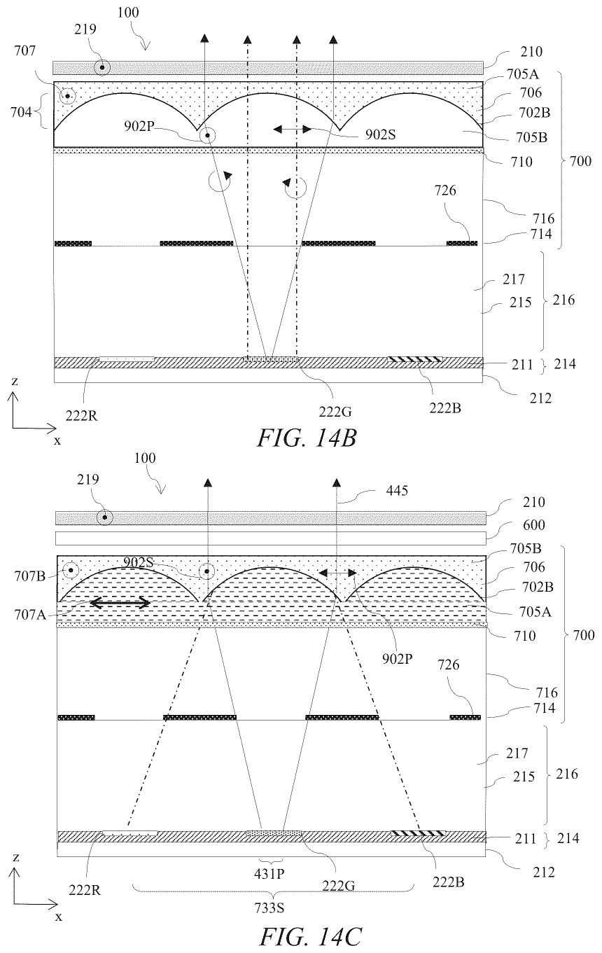

In the present description the birefringent lens layer 704 comprises the region through which the surface 702B extends. The lens layer 704 may further comprise the offsets 717, 713 of birefringent material 705A and material 705B respectively. Material 705B may be an isotropic material as illustrated in FIG. 2A or may be a birefringent material for example as illustrated in FIG. 14C hereinbelow.

The plurality of lenses 701a-m comprises one or more birefringent lenses 701. As illustrated in FIG. 2A, each of birefringent lenses 701a-c comprises birefringent material 705A and isotropic material 705B. The birefringent material 705A may have an alignment direction 707A at the planar input surface 702A and an alignment direction 707B at the profiled lens surface 702B. The alignment directions 707A, 707B may be provided by alignment layers 709A, 709B that are provided during manufacture of the birefringent lens 701 to provide alignment of the birefringent material 705A. An alignment layer 709B may be provided at the surface 702B between the isotropic material 705B and birefringent material 705A arranged during manufacture to provide alignment of the birefringent material 705A. Alternatively one or both alignment layers 709A. 709B may be removed in a manufacturing step of the birefringent lens and may not be present in the display device 100. The surface 702B has a sag 717 and is extended in the y-direction. The alignment directions 707A. 707B may be parallel to the direction in which the surface 702B is extended.

Transparent support substrate 706 may be provided for the isotropic material 705B. As illustrated in FIG. 1, the substrate 706 may be the substrate 612 of the polarisation switch 600 described hereinbelow.

The birefringent lenses 701 are non-switching, that is in operation the birefringent material 705A is not switched for example by the application of an electric field, and may be a cured liquid crystal material.

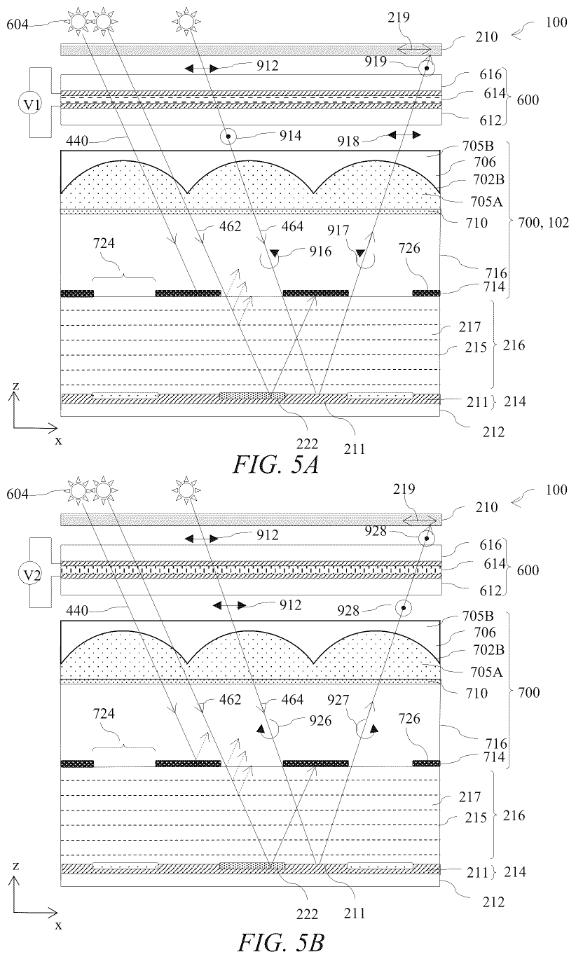

A reflection control polarisation conversion retarder 710 may be formed on the surface 702A of the birefringent lens 701a-n, by lamination of an A-plate retarder. The reflection control polarisation conversion retarder 710 is arranged to convert a polarisation state of light passing therethrough between the circular polarisation state 901P and the linear polarisation state 902P. Advantageously cost and complexity may be reduced. Alternatively the reflection control polarisation conversion retarder 710 may be provided as a liquid crystal layer such as a UV cured reactive mesogen liquid crystal material. Advantageously low thickness may be achieved. The operation of the reflection control polarisation conversion retarder 710 will be described further hereinbelow with respect to FIGS. 5A-B.

A second transparent layer 716 is arranged between the parallax barrier layer 714 and the lens layer 704. The separation tris of the birefringent lens 701 to the parallax barrier layer 714 may comprise the thickness t₇₁₆ of the second transparent spacer layer 716, the thickness of a reflection control polarisation conversion retarder 710 and the thickness of a cusp offset layer 713 comprising birefringent material 705A. The thickness of the cusp offset layer 713 and the retarder 710 may be small so that the separation t₇₁₅ of the birefringent lens 701 from the parallax barrier layer is substantially the same as the thickness t₇₁₆ of the second transparent spacer layer 716. The separation L of the birefringent lens 701 to the pixel plane 214 may comprise the thickness of the birefringent lens layer 704, the offset layer 713, the retarder 710, the second transparent layer 716, the parallax barrier layer 714 and the first transparent layer 216. Such manufacturing methods may achieve a separation L determined by the thickness of layers 216, 713, 714, 716, 710 that may together be sufficiently thin to advantageously achieve desirable viewing angle characteristics as described hereinbelow.

The birefringent lens 701, retarder 710 and second transparent layer 716 may be provided as a parallax component 700 that may further comprise support substrate 706 and/or parallax barrier layer 714.

The aperture array 724a-m and the lens array 701a-m are one dimensional arrays which extend in the common one dimensional direction that is in the y-direction, orthogonal to the predetermined direction.

The display device 100 further comprises a display polariser 210 which is a linear polariser with electric vector transmission direction 219. Typical polarisers may be linear absorbing polarisers such as stretched PVA iodine based polarisers that may be arranged between TAC layers.

The parallax barrier layer 714 is arranged between the lens layer 704 and the pixel layer 214; and the lens layer 704 is arranged between the pixel layer 214 and the display polariser 210. The pixel layer 214 is arranged to output light towards the parallax barrier layer 714, the parallax barrier layer 714 is arranged to receive light output from the pixel layer 214 and to output light towards the lens layer 704, the lens layer 704 is arranged to receive light output from the parallax barrier layer 714 and to output light towards the display polariser 210, and the display polariser 210 is arranged to receive light output from the lens layer 704 and to output linearly polarised light 400.

An illustrative embodiment for the arrangement of FIG. 2A is shown in TABLE 1.

TABLE 1

| Item | Property | Value | |
|---|---|---|---|
| Pixel 222R | Average lens pitch for 1000 lenses in x-direction | 80.000 | μm |
| | Width in x-direction | 40 | μm |
| First transparent layer 216 | Thickness | 25 | μm |
| Parallax barrier | Aperture 724 width | 40 | μm |
| layer 714 | Average aperture 724 pitch for 1000 apertures in x-direction | 79.996 | μm |
| Second transparent layer 716 | Thickness | 25 | μm |
| Reflection control | Retardance | 137.5 | nm |
| polarisation conversion | Thickness | 0.6 | μm |
| retarder 710 | Optical axis 711 direction | 45° | |
| Birefringent lens 701 | Average lens pitch for 1000 lenses in x-direction | 79.992 | μm |
| | Radius | 45 | μm |
| | Cusp offset thickness | 0 | μm |

| | | |
|---|---|---|
| Birefringent | Ordinary refractive index @ 550 nm | 1.50 |
| material 705A | Extraordinary refractive index @ 550 nm | 1.72 |
| | Alignment state 707A direction | 90° |
| | Alignment state 707B direction | 270° |
| Birefringent material 705B | Refractive index | 1.50 |
| Switch layer 614 | Liquid crystal material arrangement | See TABLE 2 |
| Polariser 210 | Electric vector transmission direction 219 | 90° |

The polarisation switch layer 614 comprises a switchable liquid crystal layer comprising liquid crystal material 615. The display device 100 further comprises transmissive electrodes 619A, 619B and liquid crystal surface alignment layers 617A, 617B formed on each side of the switchable liquid crystal layer. The display device 100 further comprises a control system 500 arranged to control a voltage Vs applied across the transmissive electrodes 619A, 619B. The liquid crystal polarisation switch layer 614 is arranged between (i) transparent substrate 612, electrode 619A and alignment layer 617A; and (ii) transparent substrate 616, electrode 619B and alignment layer 617B that are arranged on opposite sides of the liquid crystal polarisation switch layer 614. Driver 650 is arranged to drive the signal Vs applied across the liquid crystal polarisation switch layer 614, and is controlled by controller 500. The transparent substrate 612 may be the same as the support substrate 706, advantageously achieving reduced thickness.

An illustrative embodiment for the liquid crystal polarisation switch layer 614 driven by driver 650 is given in TABLE 2 for a third minimum cell design to advantageously achieve low chromatic variation of polarisation state switching.

TABLE 2

| | LC polarisation switch layer 614 | | | | | | |
|---|---|---|---|---|---|---|---|
| | Alignment layers | Alignment | Pretilt/ | Δn.d/ | | | |
| Mode | 617A, 617B | direction | deg | nm | Twist | Δε | Voltage/V |
| Share | Homogeneous | 90° | 2 | 168 | 90° | +13.2 | V₆₁₄S: 5.0 |
| Privacy | Homogeneous | 180° | 2 | 0 | | | V₆₁₄P: 0 |

Alternatively second or first minimum cell designs with lower Δn·d values can be chosen to achieve reduced switching time between privacy and share modes. Alternatively, the liquid crystal polarisation switch layer 614 can be made thicker still with the cell operating well into the Mauguin limit.

The propagation of light from the pixel layer 214 to the display polariser 210 in privacy mode will now be described with reference to FIGS. 2A-B.

Unpolarised light comprising orthogonal circular polarisation states 901P. 901S is provided by the pixels 222R, 222G, 222B. In FIG. 2B, only the polarisation state 901P that is transmitted by the display polariser 210 is illustrated while the orthogonal state 901S is absorbed by the display polariser 210 and so are not illustrated.

Considering FIGS. 2A-B, circular polarisation state 901P output from the pixels 222 is transmitted through an aperture 724 of the parallax barrier layer 714 and is incident onto the reflection control polarisation conversion retarder 710. Reflection control polarisation conversion retarder 710 is arranged to convert a circular polarisation state 901P to a linear polarisation state 902P and is for example a quarter wave retarder such as illustrated in TABLE 1. Such a retarder 710 may be provided with polarisation conversion characteristics that do not change substantially with angle of incidence. The off-axis luminance of the display device 100, described hereinbelow, is advantageously reduced.

The polarisation state 902P is incident onto the birefringent lens 701 with birefringent material 705A liquid crystal molecule alignment directions 707A, 707B arranged to provide the extraordinary refractive index to the light rays 445 with polarisation state 902P propagating within the birefringent lens 701. Such light rays 445 are incident onto the profiled lens surface 702B that has an index step to the refractive index of the isotropic material 705B, and provides optical power to the light rays incident across the aperture 708 of the lens 701. The focused rays 400 provide a focus region 430 for the parallel output rays 400 such that for a given viewing direction ø an illumination spot 431P is provided at the pixel layer 214 that represents the region of the pixel plane 214 from which the light is collected. The refractive index step between materials 705A, 705B for the polarisation state 902P remains the same for different output angles 447.

The polarisation state 902P is output from the birefringent lens 701 and incident onto the polarisation switch layer 614. A first voltage V₆₁₄S is applied across the switchable liquid crystal layer 614 that is arranged to convert in at least one mode, that is privacy mode in FIGS. 2A-B, a polarisation state of light passing therethrough between a first polarisation state 902P and a second polarisation state 904 orthogonal to the first polarisation state 902. The polarisation state 904 is aligned with the electric vector transmission direction 219 of the display polariser 210 and is output as output light 400.

Transparent layers 212, 216, 716, 706, parallax barrier layer 714 and lens layer 704 may be provided on flexible substrates or may form flexible substrates. Advantageously flexible, rollable and curved display devices 100 may be provided.

Operation in share mode will now be described.

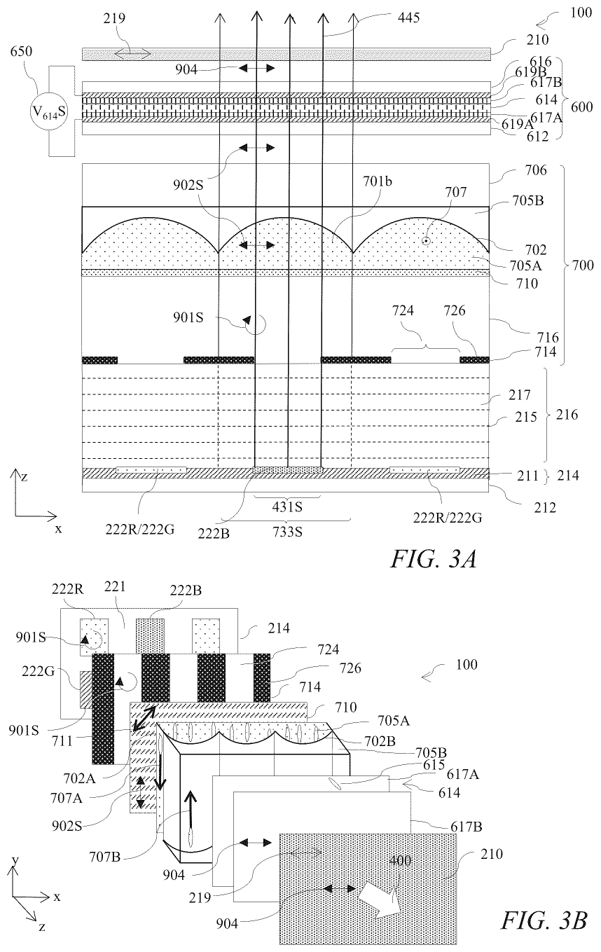

FIG. 3A is a schematic diagram illustrating in top view operation of the SLM 48, parallax barrier layer 714, birefringent lens array 701a-m, polarisation switch layer 614 and display polariser 210 in share mode; and FIG. 3B is a schematic diagram illustrating in front perspective view alignment of optical layers in the optical stack of FIG. 3A in share mode. Features of the embodiments of FIGS. 3A-B not discussed in further detail may be assumed to correspond to the features with equivalent reference numerals as discussed above, including any potential variations in the features.

By way of comparison with FIGS. 2A-B the alternative embodiments of FIGS. 3A-B illustrate share mode operation. Circular polarisation state 901S output from the pixels 222, is transmitted through an aperture 724 of the parallax barrier layer 714 and is incident onto the reflection control polarisation conversion retarder 710. Reflection control polarisation conversion retarder 710 converts the polarisation state 901S to a linear polarisation state 902S.

The polarisation state 902S is incident onto the birefringent lens 701 with birefringent material 705A liquid crystal molecule alignment directions 707A, 707B arranged to provide the ordinary refractive index to the light rays 445 with polarisation state 902S propagating within the birefringent lens 701. Such light rays 445 are incident onto the profiled lens surface 702B that is similar to or the same as the refractive index of the isotropic material 705B, and so no optical power is provided to the light rays incident across the aperture 708 of the lens 701. The undeflected rays 400 provide an illumination spot 431S at the pixel layer 214 determined by the aperture 724 of the parallax barrier layer 714. The similar refractive indices of materials 705A, 705B for the polarisation state 902S remains the same for different output angles 447. The illumination spot 733S that would be provided if the parallax barrier 714 were not present is also shown, which is the same as the lens 701 width.

The polarisation state 902S is output from the birefringent lens 701 and incident onto the polarisation switch layer 614. A second voltage Vs2 is applied across the switchable liquid crystal layer 614 such that the liquid crystal material 615 is arranged to not rotate the incident polarisation state so that the output polarisation state 904 is substantially the same as the polarisation state 902S.

The polarisation state 904 is aligned with the electric vector transmission direction 219 of the display polariser 210 and is output as output light 400. In alternative embodiments the electric vector transmission direction 219 may be arranged to transmit a polarisation state 902P such that the driven mode is privacy mode and the undriven mode is share mode. Advantageously power consumption in share mode may be reduced.

As illustrated in FIG. 1, at least one of the transmissive electrodes 619A, 619B is provided with multiple addressable regions 626a-c that may be aligned with the addressable regions 326a-c of the polar control retarder 300. The polar variation of luminance output (as described hereinbelow) may be different in the regions 626a-c to provide display properties that are different in the respective regions 626a-c. Advantageously some regions 626b-c may provide privacy output while other regions 626a may provide share mode output. In alternative embodiments the electrodes 619A, 619B may be uniform and a common optical output is provided across the display device 100. Advantageously cost and complexity may be reduced.

The propagation of light rays 447 in off-axis directions will now be described.

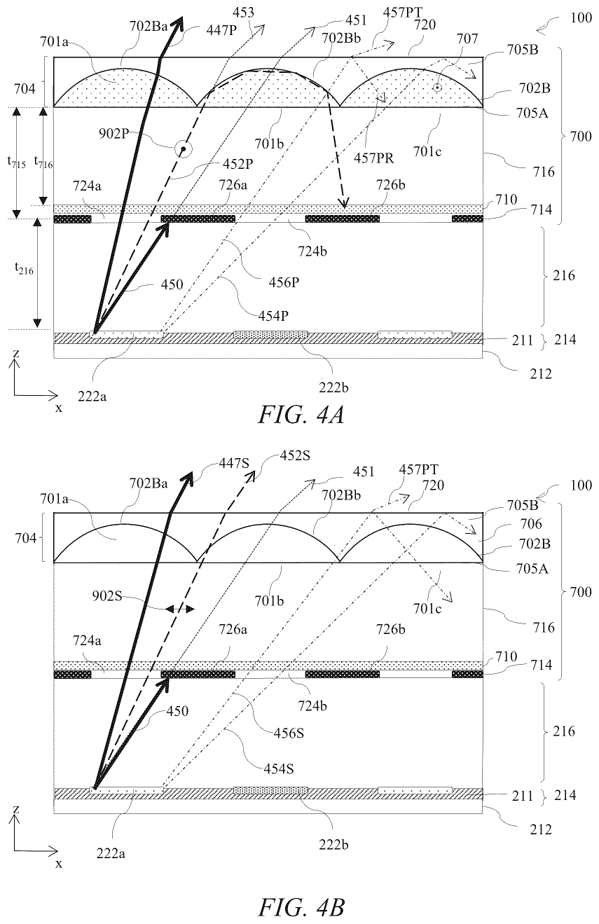

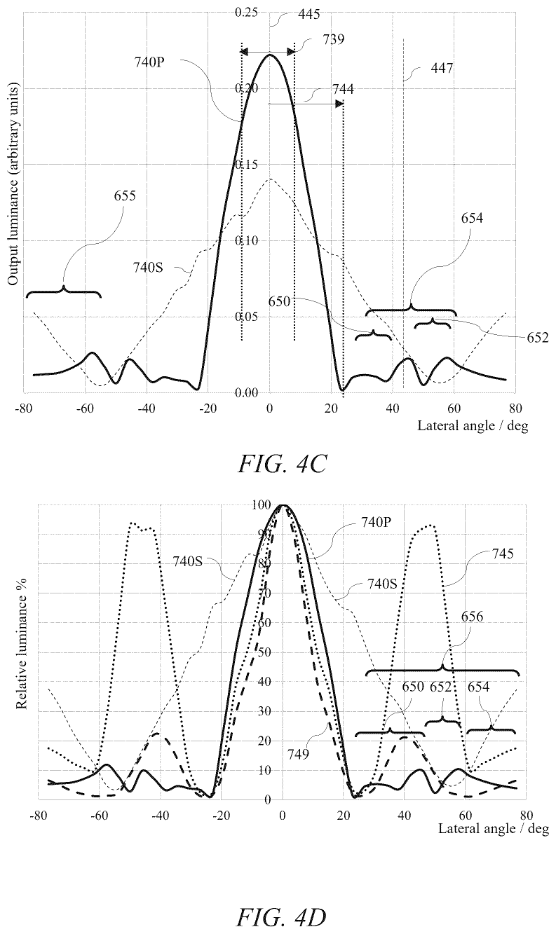

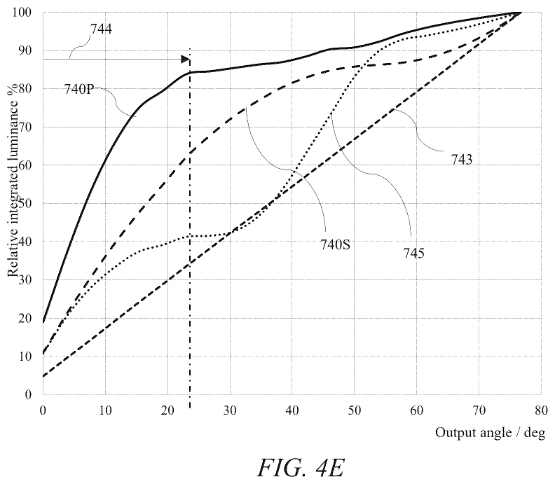

FIG. 4A is a schematic diagram illustrating in top view reduction of stray light by reflection from birefringent lenses 701 for the display device 100 in privacy mode; and FIG. 4B is a schematic diagram illustrating in top view reduction of stray light by reflection from birefringent lenses 701 for the display device 100 in share mode. Features of the embodiment of FIGS. 4A-B not discussed in further detail may be assumed to correspond to the features with equivalent reference numerals as discussed above, including any potential variations in the features.

FIG. 4A illustrates various light rays that may propagate within the display device 100 operating in privacy mode. For illustrative purposes, the display polariser 210 and polarisation switch 600 are omitted, however the behaviour with said components is similar or the same. Further, the location of the retarder 710 is adjusted to be next to the plane of the parallax barrier layer 714.

Light ray 447P is a light ray that is output from the left-hand edge of pixel 222a and transmitted through the aligned aperture 724a and incident onto the birefringent lens 701a. Desirable light rays 447P are described as in the zeroth lobe of output from the display device 100.

Light rays 450 that are directed towards the adjacent lens 701b from the pixel (as illustrated by notional ray 451) are blocked by the light blocking region 726 of the parallax barrier layer 714. Such undesirable notional light rays 45l are advantageously not output from the display device 100.

As illustrated in TABLE 1, the thicknesses t₂₁₆, t₇₁₆ of the first and second transparent layers 216, 716 respectively are the same, with negligible thicknesses of the offset of the parallax barrier layer 714, retarder 710, and offset 713. Such an arrangement achieves improved light blocking of the light from the pixel 222a to the lens 701b, advantageously achieving reduced stray light and improved security factor, S over an increased lateral field of view.

Intermediate light rays 452P are directed from the left edge of pixel 222a towards the lens 701b and are reflected by total internal reflection at the surface 702Bb. Undesirable notional light rays 453 are advantageously not output from the display device 100. The reflected light rays 452P provide for increased aperture 724 width without increased stray light so that the width α of each of the plurality of apertures 724 in the at least one direction may be at least half of the pitch p of the pixel array 222a-n in the at least one direction. Advantageously display luminance may be increased along the direction 445.

Further light rays 452P that do not reflect by total internal reflection at the surface 702Bb may have an angle of incidence at the surface 702Bb that is close to the Brewster angle. Such light rays have the s-polarisation state 902P at the surface 702Bb and so are preferentially reflected, reducing the luminance of a transmitted ray 453. Thus reflection that is not total internal reflection may be used to provide reflection at the surface 702Bb. The alignment direction 707b of the birefringent material 705A at the surface 702Bb of the lens 701b may be provided to increase the amount of reflected light for such rays 452P.

In other words, the parallax barrier layer 714 is arranged to prevent at least some of the light as illustrative light rays 450 from each of the plurality of pixels 222a from reaching lenses 701b which are not aligned with that pixel 222a, and wherein each of the plurality of lenses 701 is arranged to reflect at least some of the light as illustrative ray 452P received from pixels 222a which are not aligned with that lens 701b. Further, the lens layer 704 is arranged to reflect at least some of the light that it receives by total internal reflection at a lens 701b surface 702Bb. The reflected light ray 452P is redirected back towards the parallax barrier and absorbed in the light blocking region 726b.

Considering light ray 454P from the right side of the pixel is transmitted by the neighbouring aperture 724b, is transmitted through lens 701c and is incident with an angle of incidence at a planar surface 720 of the display device 100. The planar surface 720 provides a planar interface between a material such as polymer or glass and air, and may be a surface of the transparent support substrate 706, polarisation switch 600, display polariser 210 or additional polariser as illustrated in FIG. 1 for example.

The angle of incidence of the light ray 454P is greater than the critical angle and the ray 454P is desirably reflected by total internal reflection. The display device 100 thus further comprises at least one planar surface 720 wherein the at least one planar surface 720 is arranged to receive light output from the lens layer 704 and to reflect at least some of the light such as light ray 454P that it receives by total internal reflection. Advantageously luminance at higher output angles is reduced. Further the lens layer 704 is arranged to refract at least some of the light it receives such that the refracted light is reflected by total internal reflection at the at least one planar surface 720.

Considering light ray 456P from the right-hand side of the pixel 222a that is transmitted through the left hand side of the aperture 724b, light may be refracted by the lens 701b towards the normal to the surface 720, that is the angle of incidence onto the surface 720 may be reduced so that light is not reflected by total internal reflection at the surface 720. Transmitted light ray 457 PT provides undesirable stray light at wider lateral angles. Some light 456PR is reflected by Fresnel reflection at the surface 720. As the polarisation state 902P is s-polarised at the surface 720, the reflectivity of the light ray 457PR is increased in comparison to p-polarised light. The birefringent lens 701 may have alignment directions 707 of the birefringent material 705A that achieve reduced luminance in the rays 457 PT so that visibility at high lateral angles is advantageously reduced.

By way of comparison with FIG. 4A, the embodiment of FIG. 4B illustrates the operation of the display device 100 for stray light in share mode so that the polarisation state 902S is incident onto the birefringent lenses 701. Light rays 447S, 452S are output without substantial deflection by the lens layer 704, while ray 454S is reflected by total internal reflection the surface 720 in a similar manner to ray 454P. Ray 456S is incident onto the surface 720 with p-polarisation state 902S and is thus preferentially transmitted, advantageously increasing off-axis luminance.

In other embodiments wherein the display polariser 210 or additional polariser 318 is arranged at the outer interface to air, then it may be desirable to provide a p-polarisation state in lateral directions to reduce surface reflections in the lateral direction, that is the electric vector transmission direction of the display polariser 210 or additional polariser 318 is vertically oriented. Advantageously stray light in privacy mode may be reduced and security factor increased.

Simulated output luminance profiles will now be described.

FIG. 4C is a schematic graph illustrating schematic output luminance profiles 740S, 740P of the arrangements of FIGS. 2A-B and FIGS. 3A-B and TABLE 1; FIG. 4D is a schematic graph illustrating schematic relative luminance profiles of FIG. 4C and further comprising profiles of alternative notional arrangements; and FIG. 4E is a schematic graph illustrating relative integrated luminance profiles for the arrangements of FIGS. 4C-D. Features of the embodiment of FIGS. 4C-E not discussed in further detail may be assumed to correspond to the features with equivalent reference numerals as discussed above, including any potential variations in the features.

FIG. 4C illustrates the profile 740P of the variation of luminance with output angle in the lateral direction (parallel to the x-axis), that in the present embodiments is the predetermined direction, for privacy mode; and the profile 740S of the variation of luminance for share mode. Profiles 740P, 740S are for the arrangement wherein the centre of a pixel 222 column is aligned to the centre of an aperture 724, and is further aligned to the centre of a birefringent lens 701 so that the maximum luminance is provided in the normal direction 199.

Profile 740S illustrates the operation of the display device 100 of FIG. 3A wherein the voltage Vs2 is applied across the electrodes 319A, 319B of the polarisation switch 600. The profile provides desirable high image luminance at typical wide viewing angles, such as at a lateral viewing angle of 45°. The head-on luminance in share mode is the same as the base panel luminance as the aperture 724 is the same width as the pixel 222 width and no absorption losses are present.

In privacy mode the focussing of the lens 701 increases the head-on luminance. If the focus region 430 is arranged at the pixel plane then the head-on luminance may be doubled given the 50% aperture ratio of the pixels 222 across the lateral direction, however some of the light from the pixels 222 directed towards the lens 701 is clipped by the light blocking regions 726 of the barrier.

The illustrative embodiment of TABLE 1 and FIG. 2 provides a privacy mode output minimum luminance at lateral angle 744 that is close to 25° corresponding to the angle within which the light output by each of the plurality of lenses 701 of the lens layer 704 is from the pixel 222a with which that lens 701a is aligned. In operation, a display suitable for automotive applications wherein a driver may lean towards a passenger infotainment display device 100 such as illustrated in FIG. 26 hereinbelow may advantageously be provided. The central region of profile 740P may be modified by adjusting the surface 702B radius of curvature or the refractive indices of the birefringent material 705A for example. Image uniformity may advantageously be increased.

In operation, it is desirable to provide low output luminance and high security factor at viewing angles greater than a desirable image visibility angle in the profile region 656 at angles greater than the lateral angle 744. The profile region 656 comprises suppression regions 650, 652, 654 that are provided by different mechanisms of the present embodiments.

Considering FIG. 4D, for the purposes of illustration, a notional profile 745 is illustrated which is the simulated luminance profile if the parallax barrier layer 714 were omitted from the present embodiment. Such a profile provides undesirably high luminance levels at typical snooper 47 locations as will be described hereinbelow. A further notional profile 749 is illustrated which is the luminance profile that would be provided by a mathematical multiplication of the profile 745 with the profile provided by the parallax barrier layer 714 alone, which is the share mode profile 740S. Such a notional mathematical profile 749 would provide an undesirable luminance peak in the suppression region 650. The present embodiments advantageously achieve reduced luminance of such peak to achieve increased image security in said region 650. The present embodiments achieve this by the suppression of reflected rays 452P as illustrated in FIG. 4A. The profile 740P further has a wider luminance profile than would be expected from the notional mathematical profile 749 in the central region, advantageously increasing viewing freedom for the head-on observer 45.

The output luminance profile 740P has higher luminance in the suppression region 652 than the notional mathematical profile 749, however such region 652 is conveniently suppressed by the polar control retarder 300 and additional polariser 318 of FIG. 1 as will be described further hereinbelow. In suppression region 654 luminance is further reduced, advantageously increasing security factor at wide viewing angles.

The profile variations of FIG. 4D may alternatively be represented by the relative integrated luminance profiles of FIG. 4E. Profile 743 represents integrated luminance profile for a Lambertian emitter, that may be similar to the profile provided by the pixels 222 without the parallax barrier layer 714 or birefringent lens layer 704. As described in FIG. 4C, the angle 744 comprises the light output by each of the plurality of lenses 701 of the lens layer 704 is from the pixel 222a with which that lens 701a is aligned. In the present embodiments at least 50%, preferably at least 65% and more preferably at least 75% of the light output by each of the plurality of lenses 701 of the lens layer 704 is from the pixel 222 with which that lens 701 is aligned as illustrated by the profile 740P wherein 85% of the relative integrated luminance is provided up to the angle 744.

By comparison, the share mode profile 740S illustrates that more than 35% of the light is in directions relating to the light output by each of the plurality of lenses 701 of the lens layer 704 is from the pixel 222a with which an adjacent lens 701b is aligned. Advantageously increased image visibility is achieved at wider viewing angles for off-axis display device 100 users 47 in share mode.

The present embodiments thus achieve a combination of desirable profile 740P characteristics including but not limited to (i) a narrow cone angle such as 25° for image visibility; (ii) improved uniformity for head-on viewing; (iii) increased display luminance for head-on viewing; (iv) reduced luminance in the region 650 which is a region that is not typically suppressed by polar control retarder 300; (v) surface 702B curvature and liquid crystal birefringent material 705A that are conveniently provided by known manufacturing methods; and further with a profile 740S providing desirable image luminance to an off-axis display user 47 in share mode.

The operation of the display device 100 for illumination by ambient light will now be described.

FIG. 5A is a schematic diagram illustrating in top view reduction of reflected ambient light for the embodiment of FIG. 2A in privacy mode; and FIG. 5B is a schematic diagram illustrating in top view reduction of reflected ambient light for the embodiment of FIG. 3A in share mode. Features of the embodiment of FIGS. 5A-B not discussed in further detail may be assumed to correspond to the features with equivalent reference numerals as discussed above, including any potential variations in the features.

Considering light ray 440, ambient light 604 is directed onto the light blocking regions 726 and absorbed. Light ray 462 is absorbed at the light blocking layer 726 after reflection from a pixel or gap 211 that may for example comprise part of a reflective backplane of the pixel layer 214.

For the embodiment of FIG. 5A operating in privacy mode, light ray 464 with polarisation state 912 is converted to polarisation state 914 in privacy mode by the polarisation switch 600. The reflection control polarisation conversion retarder 710 is arranged between the lens layer 704 and the pixel layer 214 and is a quarter-wave retarder arranged to convert a polarisation state of light passing therethrough between a linear polarisation state 914 and a left circular polarisation state 916. Reflected light undergoes a phase change so that right circular polarisation state 917 is reflected from the pixel layer 214; is converted to linear polarisation state 918 by the retarder 710; and rotated to polarisation state 919 by the polarisation switch 600. Light ray 464 is thus absorbed by the polariser 210.

For the embodiment of FIG. 5B operating in share mode, light ray 464 with polarisation state 912 is converted to the right circular polarisation state 926. Reflected light undergoes a phase change so that left circular polarisation state 927 is reflected from the pixel layer 214; is converted to linear polarisation state 928 by the retarder 710; and rotated to polarisation state 919 by the polarisation switch 600. Light ray 464 is thus absorbed by the polariser 210.

The reflection control polarisation conversion retarder 710 achieves reduced visibility of reflection from layers including pixel layer 214 and other interfaces such as between inorganic layers 215B and organic layers 217B. Advantageously image contrast is improved in ambient light for both privacy mode and share mode.

The structure and operation of the polar control retarder 300 of FIG. 1 will now be described.

FIG. 6A is a schematic diagram illustrating in side perspective view a polar control retarder 300 for the illustrative embodiment of TABLE 3; and FIG. 6B is a schematic diagram illustrating in top view a polar control retarder 300 arranged between a display polariser 210 and an additional polariser 318. Features of the embodiments of FIGS. 6A-B not discussed in further detail may be assumed to correspond to the features with equivalent reference numerals as discussed above, including any potential variations in the features.

FIG. 6A and TABLE 3 are an illustrative embodiment of an arrangement of polar control retarder 300 comprising alignment layers 317A, 317B comprising homogeneous and homeotropic alignment directions 417A, 417B respectively arranged to align the liquid crystal material 315 of the liquid crystal polar control retarder 301 at the layers 317A, 317B.

TABLE 3

| | Passive compensation | | | | | | | | |
|---|---|---|---|---|---|---|---|---|---|
| | retarder(s) 330 | | Liquid Crystal polar control retarder 301 | | | | | | |
| | | Δn.d/ | Alignment | Alignment | Pretilt/ | Δn.d/ | | | |
| Mode | Type | nm | layers | direction | deg | nm | Twist | Δε | Voltage/V |
| Privacy | Negative C | −900 | Homogeneous | 90° | 2 | 1000 | 0° | +13.2 | V₃₁₄P: 1.4 |
| Share | | | Homeotropic | 270° | 88 | | | | V₃₁₄S: 5.0 |

When voltage V₃₁₄ is applied across the layer 314 then the molecules of material 315 are aligned to adjust the phase of light propagating therethrough in a manner that is dependent on the polar direction of incident light. Passive compensation retarder 330 is arranged to provide a phase shift that compensates for the phase shift of the layer of liquid crystal material 315 when driven by voltage V₃₁₄S in share mode so that wide viewing angle performance is achieved. The driving condition of the layer 314 of liquid crystal material 315 is arranged to cooperate with the polar variation of output of the parallax barrier layer 714, lens layer 704 and polarisation switch 600 when driven by voltage V₃₁₄P by voltage driver 350 in privacy mode.

The operation of the polar control retarder 300 for light from the SLM 48 pixel plane 214 is described in FIGS. 6C-D hereinbelow, and for reflections of ambient light in FIGS. 6E-F hereinbelow.

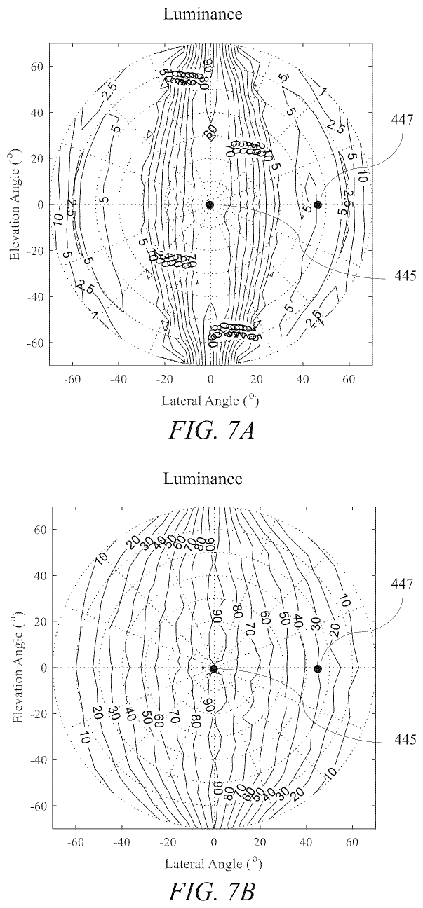

The at least one polar control retarder 300 is arranged in a first switchable state that is privacy mode driven by voltage V₃₁₄P of the switchable liquid crystal retarder 301, simultaneously to introduce no net relative phase shift to orthogonal polarisation components of light received by the at least one polar control retarder 300 along an axis along an inclination direction 445 to the plane of the at least one polar control retarder 300. In the embodiment of FIGS. 7C-D, the inclination direction is a direction 445 normal to the plane of the at least one polar control retarder 300.

The at least one polar control retarder 300 is further arranged to introduce a net relative phase shift to orthogonal polarisation components of light received by the at least one polar control retarder 300 along an axis with direction 447 inclined to the inclination direction 445 to the plane of the at least one polar control retarder 300.

In a second switchable state of the switchable liquid crystal retarder 301, for share mode driven by voltage V₃₁₄S the at least one polar control retarder 300 is arranged simultaneously to introduce no net relative phase shift to orthogonal polarisation components of light received by the at least one polar control retarder 300 along an axis along the inclination direction to the plane of the at least one polar control retarder 300 and to introduce no net relative phase shift to orthogonal polarisation components of light received by the at least one polar control retarder 300 along an axis with direction 447 inclined to the inclination direction to the plane of the at least one polar control retarder 300 of the direction 445.

Alternative embodiments of polar control retarders 300 are described in U.S. Pat. Nos. 11,092,851; 10,976,578; 11,073,735; and 10,802,356; all of which are herein incorporated by reference in their entireties. Such alternative embodiments may comprise alternative alignment layers wherein one or both alignment layers 317A. 317B are homeotropic alignment layers, different retardance of the layer 314 of liquid crystal material 315, different pretilts and different passive retarders 330.

In alternative embodiments not shown, the reflective polariser 302 may be omitted. Advantageously cost and complexity is reduced.

In alternative embodiments, the display polariser 210 may be a reflective polariser 302. Advantageously efficiency may be increased.

The principles of operation of the switchable polar control retarder of FIG. 6A will now be described further.

FIG. 6C is a schematic diagram illustrating in top view propagation of display illumination light through the optical stack of FIG. 1 in a share mode; and FIG. 6D is a schematic diagram illustrating in top view propagation of display illumination light through the optical stack of FIG. 1 in a privacy mode. Features of the embodiments of FIGS. 6C-D not discussed in further detail may be assumed to correspond to the features with equivalent reference numerals as discussed above, including any potential variations in the features.

Light ray 445 from the display polariser 210 of the SLM 48 may be along an axis with maximum transmission that may be perpendicular to the plane in which the display device 100 is extended, for example when the display is arranged for head-on viewing by the primary display user. Alternatively the axis may be inclined to the plane in which the display device 100 is extended, for example in the automotive application of FIG. 26.

As illustrated in FIG. 6C, when the layer 314 of liquid crystal material 315 of the liquid crystal polar control retarder is driven to operate in share mode, the retarders 300 provide no overall transformation of polarisation component 360 to output light rays 445 passing therethrough along the axis, and further provide no overall transformation of polarisation component 361 to light rays 447 passing therethrough for some polar angles which are at an acute angle to the perpendicular to the axis. Thus polarisation states 362, 364 are the same as the polarisation states 360, 361. Output ray 447 is output with substantially the same efficiency as for output ray 445 and share mode operation is achieved.

As illustrated in FIG. 6D, when the layer 314 of liquid crystal material 315 of the liquid crystal polar control retarder is driven to operate in privacy mode, the retarders 300 provide no overall transformation of polarisation component 360 to output light rays 445 passing therethrough along the axis, and provides an overall transformation of polarisation component 361 to light rays 447 passing therethrough for some polar angles which are at an acute angle to the perpendicular to the axis.

Along ray 445, polarisation state 362 is the same as polarisation state 360 and light is substantially transmitted by the additional polariser 318. Output ray 445 is output with high efficiency and share mode operation is achieved. By way of comparison, along ray 447, polarisation state 364 is different to polarisation state 361 and some light is absorbed in the additional polariser 318. Output ray 447 is output with lower efficiency than for output ray 445 and privacy mode operation is achieved, for example as illustrated in FIG. 7C hereinabove.

The luminous intensity of output ray 447 is further reduced by the absorption and reflections of the parallax component 700 and display polariser 210 as described hereinabove for example with reference to FIG. 2A and FIG. 4A. Advantageously off-axis security factor. S may be further increased.

The operation of the reflective polariser 302 for light from ambient light source 604 will now be described for the display operating in privacy mode.

FIG. 6E is a schematic diagram illustrating in top view propagation of ambient illumination light through the optical stack of FIG. 1 in a share mode; and FIG. 6F is a schematic diagram illustrating in top view propagation of ambient illumination light through the optical stack of FIG. 1 in a privacy mode. Features of the embodiment of FIGS. 6E-F not discussed in further detail may be assumed to correspond to the features with equivalent reference numerals as discussed above, including any potential variations in the features.

Ambient light source 604 illuminates the display device 100 with unpolarised light state 370. Additional polariser 318 transmits light ray 410 normal to the display device 100 with a first polarisation component 360 that is a linear polarisation component parallel to the electric vector transmission direction 319 of the additional polariser 318.

Considering on-axis ray 404, in both states of operation, the polarisation component 360 does not change polarisation state after transmission through the retarders 300 and so transmitted polarisation component 360 is parallel to the transmission axis of the reflective polariser 302 and the output polariser 210, so ambient light is directed through the SLM 48 and lost.

Considering off-axis ray 406 in share mode of FIG. 6E, again the polarisation component 360 does not substantially change polarisation state after transmission through the retarders 300 and so transmitted polarisation component 360 is parallel to the transmission axis of the reflective polariser 302 and the output polariser 210, so ambient light is directed through the SLM 48 and lost. The reflectivity of the display device 100 is thus not increased in either on-axis or off-axis directions when the display is operating in share mode.

By comparison, in privacy mode as illustrated in FIG. 6F, for off-axis ray 406, light is directed through the retarders 300 such that polarisation component 364 incident on the reflective polariser 302 has a polarisation component 366 that is orthogonal to the electric vector transmission direction 303 of the reflective polariser 302 and said polarisation component may thus be reflected. Such polarisation component 366 is re-converted into component 368 after passing through the polar control retarder 300 and is transmitted through the additional polariser 318.

Thus when the layer 314 of liquid crystal material is in privacy mode, the reflective polariser 302 provides no reflected light for ambient light rays 404 passing through the additional polariser 318 and then the retarders 300 along an axis that may for example be perpendicular to the plane of the retarders 300 as illustrated by ray 404 but not limited to perpendicular. The reflective polariser 302 does provide reflected light rays 406 for ambient light passing through the additional polariser 318 and then the retarders 300 at some polar angles which are at an acute angle to the axis, wherein the reflected light 406 passes back through the retarders 300 and is then transmitted by the additional polariser 318.

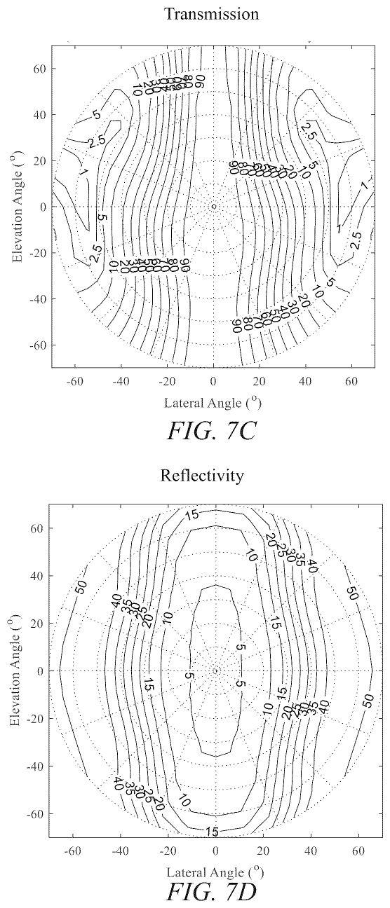

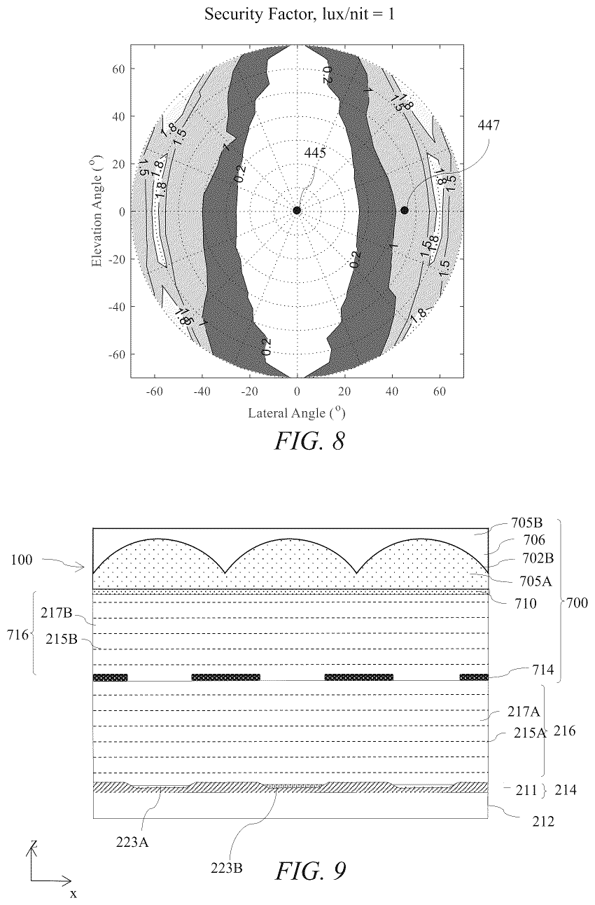

High reflectivity can be provided at typical snooper locations as illustrated in FIG. 7D hereinabove by means of privacy mode of the retarders 300. Thus, in privacy mode, the reflectivity for off-axis viewing positions is increased to achieve increased security factor as illustrated in FIG. 8 hereinabove.

The optical output in privacy mode of the illustrative embodiment comprising the illustrative embodiments of TABLES 1-3 will now be described.

FIG. 7A is a schematic graph illustrating the polar variation of luminance output for the embodiment of FIG. 2A in privacy mode for the case of Lambertian emission of light from the pixels 222 of the SLM 48 for the embodiment of TABLE 1; and FIG. 7B is a schematic graph illustrating the polar variation of luminance output for the embodiment of FIG. 3A in share mode for the case of Lambertian emission of light from the pixels 222 of the SLM 48 for the embodiment of TABLE 1; FIG. 7C is a schematic graph illustrating the polar variation of transmission for the embodiment of FIG. 6A and TABLE 3 in privacy mode; FIG. 7D is a schematic graph illustrating the polar variation of reflectivity for the embodiment of FIG. 6A and TABLE 3 in privacy mode; and FIG. 8 is a schematic graph illustrating the polar variation of security factor for the embodiment of FIG. 1 and TABLES 1-3 in privacy mode comprising the optical output of FIG. 7A together with the transmission profile of FIG. 7C and reflection profile of FIG. 7D. Features of the embodiment of FIGS. 7A-D and FIG. 8 not discussed in further detail may be assumed to correspond to the features with equivalent reference numerals as discussed above, including any potential variations in the features.

A head-on user 45 is located with a nominal user direction 445 while an off-axis snooper 47 is located a with a nominal snooper 47 direction 447. Considering the optical output of FIG. 7A, in comparison to a Lambertian output of pixels 222 that would have 100% luminance at snooper direction 447, the output of the parallax component 700 in privacy mode is substantially reduced. In operation, such a luminance would not achieve a desirable security factor of S≥1 for 1 lux/nit illuminance condition. The polar control retarder 300 achieves reduction of luminance as illustrated in FIG. 7C and increase of reflectivity as illustrated in FIG. 7D. Considering FIG. 8, high image visibility is achieved in the user 45 direction 445 and high security factor S>1 in the snooper 47 direction 447. Advantageously the display device 100 may provide desirable security factor.

FIG. 8 assumes Lambertian pixel 222 output although in practice, the output from OLED and micro-LED pixels 222 may be near-Lambertian with typically 50% or greater luminance at a lateral angle of 45°. Considering the luminance reduction profile of FIG. 7C, such a polar control retarder 300 and additional polariser 318 is insufficient to achieve S>1 alone with such near-Lambertian output. If further additional polarisers 318B and further control retarders 300B were provided in the optical stack but without the parallax component 700 of FIG. 1, security factor S may remain with S<1 at desirable non-viewing directions 447. The present embodiment advantageously achieve S>1 from pixels 222 with Lambertian or near-Lambertian distribution of output light.

In share mode, high transmission and low reflectivity is provided by the polar control retarder 300 and the reflective polariser 302 so that the distribution of luminance is that provided by FIG. 7B, so that in share mode desirably high luminance and image visibility is provided for a display user 47 in the direction 447.

In the current description, the lateral angle with zero elevation is the angle in a plane that is typically defined as the plane comprising the x-axis and z-axis of the respective figures and is most typically the angle across the horizontal with respect to the frame of reference of the observer 45. Similarly the elevation angle with zero lateral angle is the angle in a plane that is typically defined as the plane comprising the y-axis and z-axis of the respective figures and is most typically the angle across the vertical with respect to the frame of reference of the observer 45. Angles with both non-zero elevation and non-zero lateral angle may be referred to as being in the viewing quadrants in the frame of reference of the observer 45.

Alternative embodiments of the parallax component will now be described.

FIG. 9 is a schematic diagram illustrating in top view a SLM 48 comprising thin film encapsulation layer and a second transparent layer 716 further comprising at least one encapsulation layer. Features of the embodiment of FIG. 9 not discussed in further detail may be assumed to correspond to the features with equivalent reference numerals as discussed above, including any potential variations in the features.

By way of comparison with FIG. 2A, the second transparent layer 716 comprises a further encapsulation layer comprising inorganic layers 215B and organic layers 217B arranged to provide a barrier to water and oxygen. The lifetime of the light emitting materials 223A, 223B, 223C may be advantageously increased.

View angle control elements 102 for use with the display devices 100 of the present embodiments will now be described.

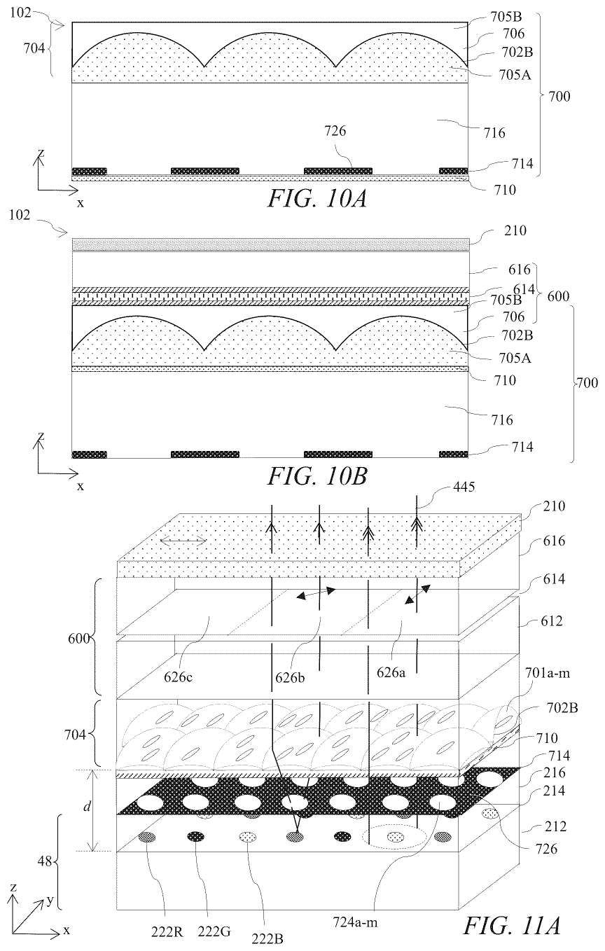

FIG. 10A is a schematic diagram illustrating in top view a view angle control optical element 102 comprising a parallax barrier layer 714, a spacer layer and a birefringent lens layer 704; and FIG. 10B is a schematic diagram illustrating in top view a view angle control optical element 102 comprising a parallax barrier layer 714, a spacer layer, a birefringent lens layer 704 and further comprising a polarisation switch layer 614 and display polariser 210. Features of the embodiment of FIGS. 10A-B not discussed in further detail may be assumed to correspond to the features with equivalent reference numerals as discussed above, including any potential variations in the features.

View angle control elements 102 of the present embodiments are arranged to be provided with the SLM 48 of the present embodiments and may comprise the parallax component 700 and may comprise the birefringent lens layer 704 and at least one of the parallax barrier layer 714, reflection control polarisation conversion retarder 710, second transparent spacer layer 716, polarisation switch layer 614 and display polariser 210.

In other words, view angle control optical element 102 is for use with a pixel layer 214 of a display device 100 wherein the pixel layer 214 comprises a plurality of pixels 222 arranged in a pixel array 222a-n. The view angle control optical apparatus 102 comprises: a parallax barrier layer 714 comprising a plurality of apertures 724 arranged in an aperture array 724a-m, wherein, in use, each of the plurality of apertures 724 is aligned with a respective pixel of the plurality of pixels 222. The view angle control optical apparatus 102 further comprises a lens layer 704 comprising a plurality of lenses 701 arranged in a lens array 701a-m, wherein, in use, each of the plurality of lenses 701 is aligned with a respective pixel of the plurality of pixels 222. The plurality of lenses 701 comprises one or more birefringent lenses 701.

The view angle control optical apparatus 102 or display device 100 may further comprise a display polariser 210 which is a linear polariser, wherein, in use, the parallax barrier layer 714 is arranged between the lens layer 704 and the pixel layer 214. In use, the lens layer 704 is arranged between the pixel layer 214 and the display polariser 210, wherein, in use, the pixel layer 214 is arranged to output light towards the parallax barrier layer 714, the parallax barrier layer 714 is arranged to receive light output from the pixel layer 214 and to output light towards the lens layer 704. The lens layer 704 is arranged to receive light output from the parallax barrier layer 714 and to output light towards the display polariser 210, and the display polariser 210 is arranged to receive light output from the lens layer 704 and to output linearly polarised light, and wherein, in use, the parallax barrier layer 714 is arranged to prevent at least some of the light from each of the plurality of pixels 222 from reaching lenses 701 which are not aligned with that pixel, and wherein the each of the plurality of lenses 701 is arranged to reflect at least some of the light received from pixels 222 which are not aligned with that lens.

In the alternative embodiment of FIG. 10A, the lens layer 704 and the parallax barrier layer 714 are formed on opposite sides of the second transparent layer 716 and the reflection control polarisation conversion retarder 710 provided on the parallax barrier layer 714. For example, in an illustrative manufacturing method the second transparent layer 716 may be provided with the parallax barrier layer for example by printing or deposition of a light absorbing material in the light blocking regions 726. The retarder 710 may be formed on the parallax barrier layer 714 by providing an alignment layer (not shown) on the parallax barrier layer 714 and providing a reactive mesogen liquid crystal material with appropriate thickness that is then cured. The birefringent lens layer 704 may be provided as described hereinabove and attached to the opposite side of the second transparent layer 716 by means of an adhesive layer (not shown).

By way of comparison with FIG. 10A and FIG. 2A, in the alternative embodiment of FIG. 10B, the view angle control optical element 102 further comprises a liquid crystal switching layer 614. The view angle control element 102 comprises the polarisation switch layer 614 with alignment layers 617A and electrode 619A that is formed on the layer of isotropic material 705B. In an illustrative method of manufacture, the view angle control element 102 of FIG. 10A and transparent substrate 616 are provided with electrodes 619A, 619B and alignment layers 617A. 617B respectively. The liquid crystal material 615 of the switch layer 614 is provided with suitable spacers between the alignment layers 617A. 617B. The display polariser 210 is provided on the output side of the transparent substrate 616. Advantageously the thickness of the view angle control element 102 is reduced in comparison to the embodiment of FIG. 2A.

It may be desirable to provide privacy operation in landscape and portrait modes of a rectangular display, for example a cell phone.

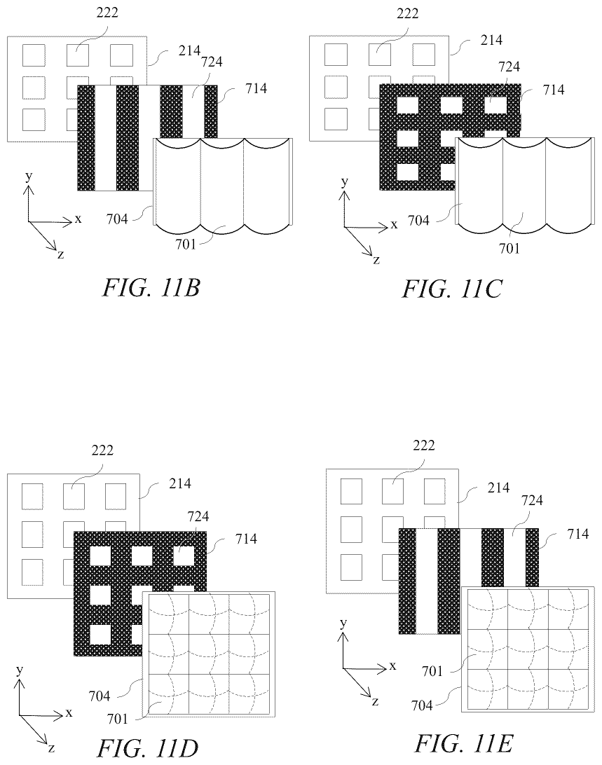

FIG. 11A is a schematic diagram illustrating in side perspective view a switchable privacy display device 100 for use in ambient illumination comprising a two dimensional parallax barrier layer 714 and a two dimensional lens array 701a-m. Features of the embodiment of FIG. 11A not discussed in further detail may be assumed to correspond to the features with equivalent reference numerals as discussed above, including any potential variations in the features.

By way of comparison with FIG. 2A, the alternative embodiment of display device 100 of FIG. 11A illustrates that the aperture array 724a-m, arranged between light blocking region 726, and the lens array 701a-m are two dimensional arrays which extend in common two dimensional directions, for example the x-direction and y-direction.

The lenses 701 may have profiled lens surface 702B that have a spherical or aspherical surface profile compared to the elongate lens surfaces 702B of FIG. 2A.

In privacy mode, the lenses 701 focus light from the pixels 222 so that increased brightness is achieved in the direction 445. Advantageously increased display efficiency may be achieved. The reduction of luminance may be provided in landscape and portrait orientations of the display to advantageously achieve an optical output for increased security factor in at least one of the two directions.

A polar control retarder 300 and additional polariser 318 may additionally be provided to achieve increased security factor in at least one of the two dimensional directions.

In the alternative embodiment of FIG. 11A, the pixels 222 and apertures 724 are circular to achieve a rotationally symmetric reduction of luminance. In other embodiments pixel 222 shapes, aperture array 724 shapes and lens 701 shapes may be provided such as square or rectangular shapes.

Alternative arrangements of pixels 222, apertures 724 and lenses 701 will now be described.

FIG. 11B is a schematic diagram illustrating in front perspective view an alternative arrangement of optical layers comprising a one dimensional parallax barrier layer 714 and a one dimensional lens array 701a-m; FIG. 11C is a schematic diagram illustrating in front perspective view an alternative arrangement of optical layers comprising a two dimensional parallax barrier layer 714 and a one dimensional lens array 701a-m; FIG. 11D is a schematic diagram illustrating in front perspective view an alternative arrangement of optical layers comprising a two dimensional parallax barrier layer 714 and a two dimensional lens array 701a-m; and FIG. 11E is a schematic diagram illustrating in front perspective view an alternative arrangement of optical layers comprising a one dimensional parallax barrier layer 714 and a two dimensional lens array 701a-m. Features of the embodiments of FIGS. 11B-E not discussed in further detail may be assumed to correspond to the features with equivalent reference numerals as discussed above, including any potential variations in the features.

The alternative embodiment of FIG. 11B illustrates an arrangement similar to that provided in FIG. 1. Advantageously luminance reduction may be achieved in the predetermined direction that may be the lateral direction. By way of comparison, the alternative embodiment of FIG. 11C achieves reduced luminance in the y-direction. Advantageously increased security factor may be provided in landscape and portrait orientations. Elongate birefringent lenses 701 may be provided with alignment directions 707B (as illustrated in FIG. 2A) that are parallel to the direction in which the lenses 701 are extended to achieve reduced liquid crystal disclinations in comparison to the two dimensional array of lenses 701 of FIG. 11D-E. Reduced scatter may be achieved and increased security factor for off-axis locations in privacy mode advantageously achieved.

The alternative embodiment of FIG. 11D illustrates an arrangement similar to that provided in FIG. 11A, however the pixels 222 and apertures 724 are square rather than circular. By way of comparison with FIG. 11C, the embodiment of FIG. 11D provides luminance reduction in both landscape and portrait orientations and brightness is increased in the direction 445 that may be the normal direction 199. By way of comparison with the embodiment of FIG. 11D, the alternative embodiment of FIG. 11E provides increased luminance in the elevation direction that is orthogonal to the lateral direction. Advantageously, image visibility in the elevation direction may be improved.

Alternative arrangements of pixels 222 comprising light emitting diodes will now be described.

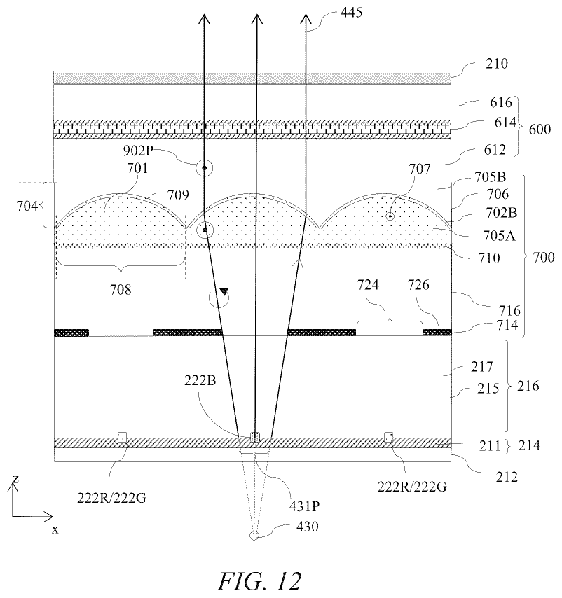

FIG. 12 is a schematic diagram illustrating in top view a switchable privacy display device 100 wherein the pixels 222 of the SLM 48 comprise inorganic micro-LEDs. Features of the embodiment of FIG. 12 not discussed in further detail may be assumed to correspond to the features with equivalent reference numerals as discussed above, including any potential variations in the features.

By way of comparison with FIG. 2A, in the alternative embodiment of FIG. 12, the pixels 222 are provided by light emitting diodes wherein at least one of the light emitting diodes is an inorganic micro-LED. Such inorganic micro-LEDs comprise materials such as gallium nitride (GaN) or aluminium indium gallium phosphide (AlInGaP) and may be provided with an area that is smaller than the pixels 222 of FIG. 2A comprising organic material 213. Inorganic micro-LED pixels 222 may advantageously achieve substantially higher brightness than that which may be achieved by organic LED pixels 222. Advantageously display luminance may be increased.

The micro-LEDs may be smaller than for the organic LEDs of TABLE 1, for example the micro-LED width may be 5 μm rather than 40 μm for the illustrative embodiment. In operation, the illumination spot 431P may be larger than the size of the pixel 222. The spot 431P may have a width of 40 μm for example. Considering FIG. 4C, the region 739 is the angular range of the profile 740P around the direction 445 (which in FIG. 4C is the optical axis 199 direction at 0 degrees lateral angle) for which luminance is above 90% of peak luminance. The embodiment of FIG. 12 achieves increased width of the region 739. Advantageously image uniformity may be increased.

It may be desirable to reduce the cost and thickness of the display device 100.

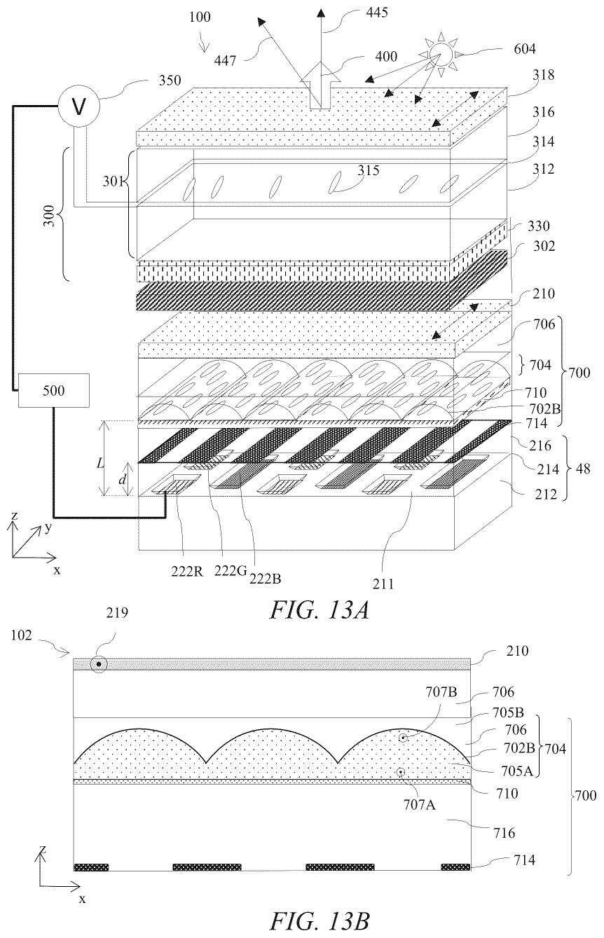

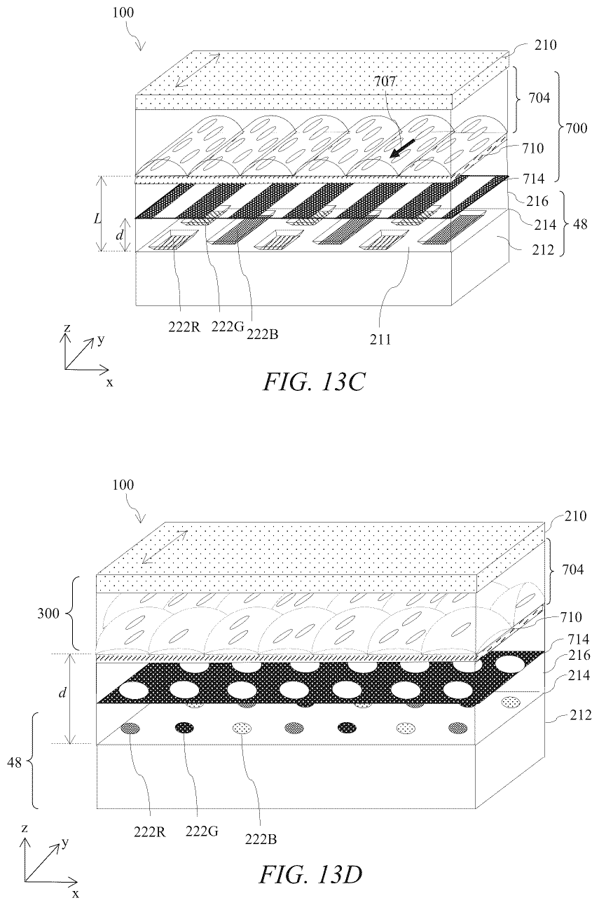

FIG. 13A is a schematic diagram illustrating in side perspective view an alternative switchable privacy display device 100 for use in ambient illumination wherein the polarisation switch layer 614 is omitted; and FIG. 13B is a schematic diagram illustrating in top view a view angle control optical element 102 comprising a parallax barrier layer 714, a spacer layer 716, a birefringent lens layer 704 and a display polariser 210 for use in the display device 100 of FIG. 13A. Features of the embodiments of FIGS. 13A-B not discussed in further detail may be assumed to correspond to the features with equivalent reference numerals as discussed above, including any potential variations in the features.

By way of comparison with the embodiment of FIG. 1, in the alternative embodiments of FIGS. 13A-B, the polarisation switch 600 substrates 612, 616 and liquid crystal polarisation switch layer 614 are omitted. The birefringent lens layer 704 is arranged on transparent support substrate 706. The electric vector transmission direction 219 is aligned with the alignment direction 707B of the liquid crystal material 705A at the surface 702B of the birefringent lens 701.

In operation, switching between privacy mode and share mode is provided by the polar control retarder 300 and additional polariser 318 as described elsewhere herein. The share mode luminance profile 740S is the same as the profile 740P in the illustrative embodiment of FIG. 4C, that is the lenses 701 remain in a mode where light that is transmitted by the display polariser 210 is that which undergoes a refractive index step at the interface 702B and so the lenses 701 have optical power.

The embodiments of FIGS. 13A-B advantageously achieve reduced cost, thickness and complexity. Further brightness in the direction 445 is increased in comparison to the SLM 48 without the parallax component 700.

It may be desirable to modify the display luminance angular profile for non-switching displays.

FIG. 13C is a schematic diagram illustrating in side perspective view a non-switched display device 100 comprising a one dimensional parallax barrier layer 714 array and a one dimensional birefringent lens array 701a-m; and FIG. 13D is a schematic diagram illustrating in side perspective view a non-switched display device 100 comprising a two dimensional parallax barrier layer 714 array and a two dimensional birefringent lens array 701a-m. Features of the embodiments of FIGS. 13C-D not discussed in further detail may be assumed to correspond to the features with equivalent reference numerals as discussed above, including any potential variations in the features.

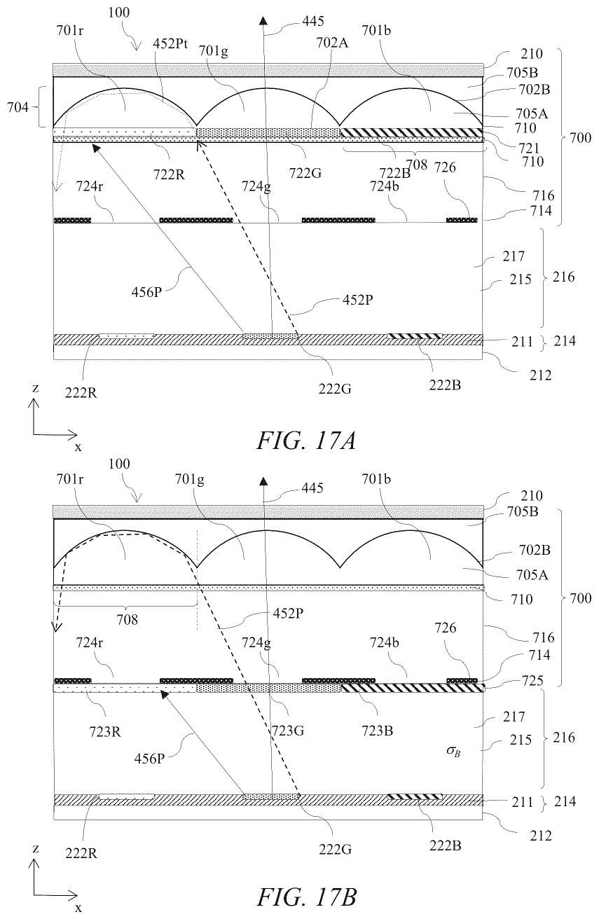

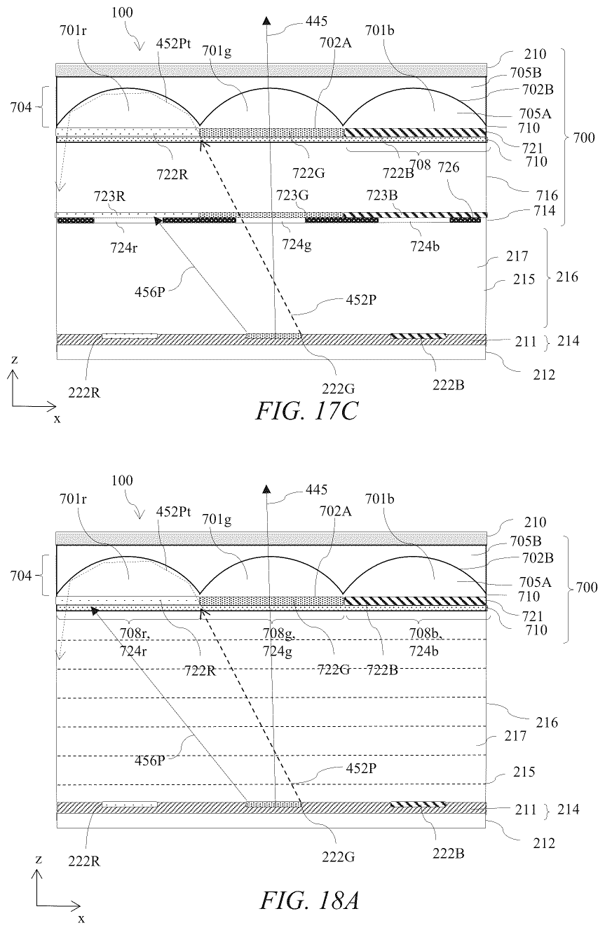

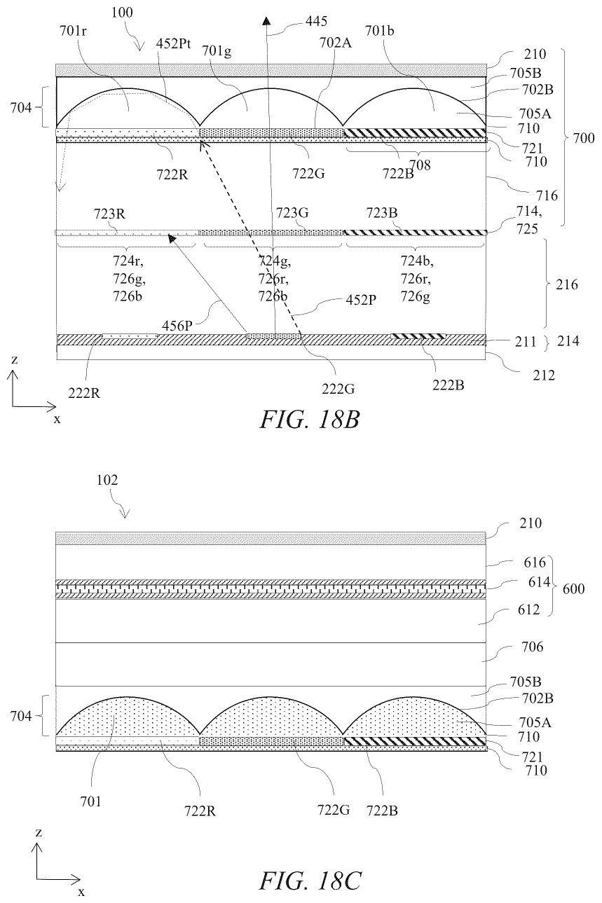

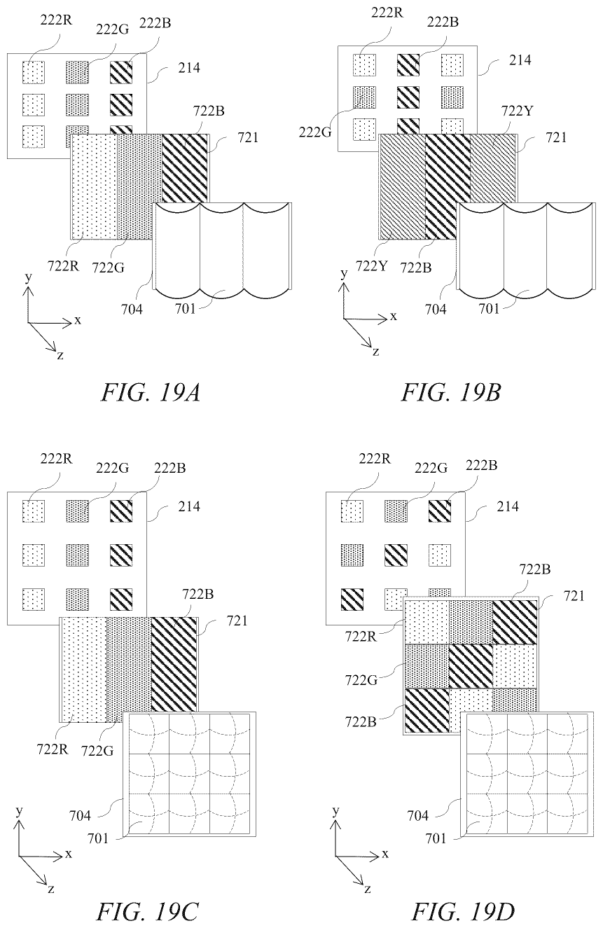

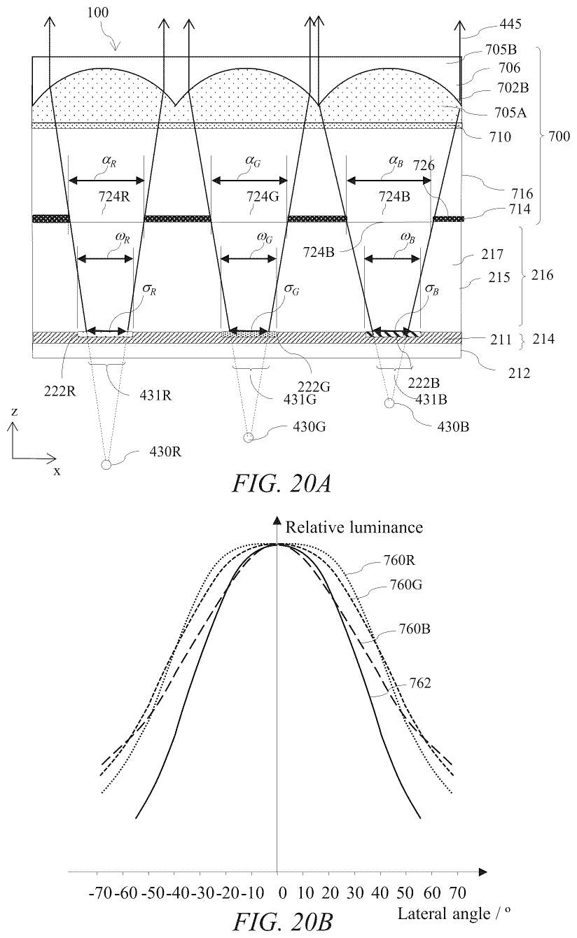

In alternative embodiments, the polar control retarder 300 and additional polariser 318 may be omitted. Advantageously cost and thickness may be reduced. The embodiments of FIGS. 13C-D may advantageously achieve increased display brightness as described elsewhere herein, for example in profile 740P of FIG. 4C. Alternative structures such as those including colour filters of FIGS. 17A-C. FIGS. 18A-C. FIGS. 19A-D may be provided without switch layer 614 or polar control retarder 300 to achieve desirable properties as described therein. Colour variations such as illustrated in FIG. 20B hereinbelow may be improved to achieve a common profile 762 for all colours.

It may be desirable to increase the off-axis luminance in share mode.

FIG. 14A is a schematic diagram illustrating in top view operation an alternative SLM 48 wherein the birefringent lenses 701 are arranged to have negative optical power in share mode. Features of the embodiment of FIG. 14A not discussed in further detail may be assumed to correspond to the features with equivalent reference numerals as discussed above, including any potential variations in the features.

In comparison to FIG. 3A and TABLE 1, in the alternative embodiment of FIG. 14A, the refractive index of the isotropic material 705B is greater than the ordinary refractive index of the liquid crystal birefringent material 705A of the birefringent lens 701. Virtual focal point 732 is provided by the negative power lens 701 in share mode and the illumination spot 733S for the lens 701, representing the region of the pixel layer 214 for which light in direction 445 would be collected, without the parallax barrier layer 714 is increased in size. Such larger spot 733S provides larger intersection with the pixel plane, such that as the off-axis viewing direction 447 changes luminance changes are reduced in comparison to the luminance in direction 445. By way of comparison with the profile 740S of FIG. 4D, higher relative luminance is achieved for off-axis directions 447. Advantageously improved image visibility may be achieved for off-axis display device 100 users 47.

The alternative embodiment of FIG. 14A further illustrates that a light diffusing structure 213 such as a microlens array (MLA) may be arranged near to or on the plane of the pixel layer 214. Such light diffusing structure 213 may be applied to other embodiments herein. The microlens array is different to the lens layer 704 of the present embodiments, for example the microlenses may have a pitch that is much smaller than the pixels 222, wherein in the illustrative embodiment of TABLE 1 the pitch of the microlenses may be 5 μm for example; and the microlenses do not require alignment with the pixels 222. In operation, the optical output of the pixels 222 may vary with angle, for example due to optical etalon structures provided in the optical stack of OLED pixels. The microlenses are arranged to diffuse angular cones of light from the pixels 222 to achieve increased angular uniformity of output for the light from the pixel 222 structures. The structure, location, function and operation of the microlenses of the light diffusing structure 213 is thus different to the lenses 701 of the present embodiments.

FIG. 14A further illustrates another alternative embodiment wherein the the reflection control polarisation conversion retarder 710 is provided between the pixel plane 214 and the parallax barrier layer 714. The retarder 710 may be formed within the substrate 216 or may be formed on the upper or lower side of the substrate 216. Advantageously the complexity of the view angle control element 102 may be reduced.

FIG. 14B is a schematic diagram illustrating in top view an alternative SLM 48 wherein the liquid crystal material of the birefringent lenses 701 is concave. Features of the embodiment of FIG. 14B not discussed in further detail may be assumed to correspond to the features with equivalent reference numerals as discussed above, including any potential variations in the features.

By way of comparison with FIG. 2A, in the alternative embodiment of FIG. 14B, the isotropic material 705B is arranged such that the surface 2 is convex in the isotropic material 705B and the surface 2 is concave in the birefringent material. The refractive index of the isotropic material 705B may be arranged to be the same or similar to the extraordinary refractive index of the birefringent material 705A.

The birefringent lens layer 704 may be more conveniently manufactured than the lens layer 704 of FIG. 2A.

FIG. 14C is a schematic diagram illustrating in top view operation an alternative switchable privacy display device 100 comprising first and second birefringent layers. Features of the embodiment of FIG. 14C not discussed in further detail may be assumed to correspond to the features with equivalent reference numerals as discussed above, including any potential variations in the features.

By way of comparison with FIG. 2A, in the alternative embodiment of FIG. 14C, the material 705B is provided by a birefringent material rather than an isotropic material.

In privacy mode, for polarisation state 902P, the light rays experience the extraordinary index in material 705A and the ordinary index in the material 705B, so that lens 701 provides positive optical power.

In share mode, the light rays with polarisation state 902S experience the ordinary index in material 705A and the extraordinary index in the material 705B, so that lens 701 provides negative optical power. The size of the illumination spot 733S may be increased while maintaining the size of the illumination spot 431P. Advantageously high brightness may be achieved in privacy mode and high angular uniformity may be achieved in share mode.

In alternative embodiments (not shown) the alignment directions 707A. 707B may be rotated by 90° in the plane in which the birefringent layer 704 extends. Improved yield during manufacture may be achieved.

An illustrative method to manufacture the plurality of birefringent lenses 701a-m will now be described.

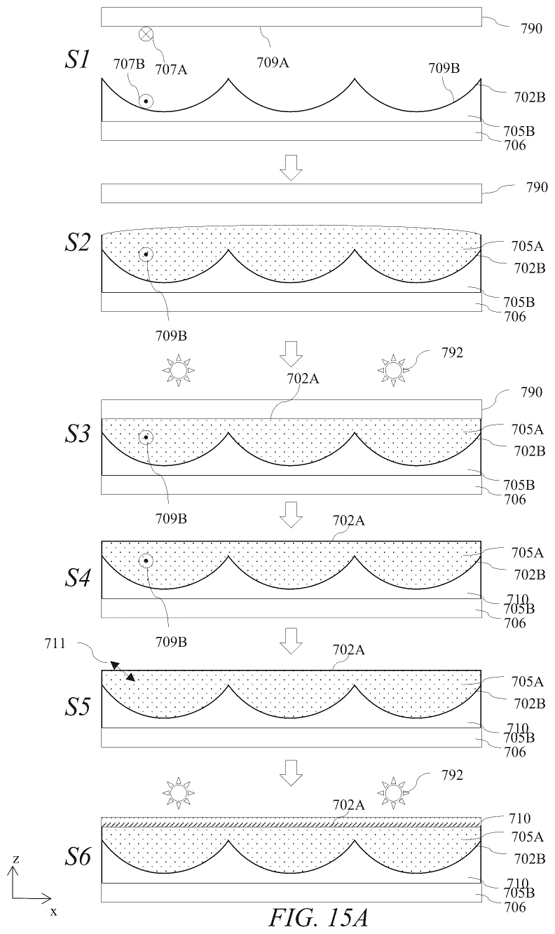

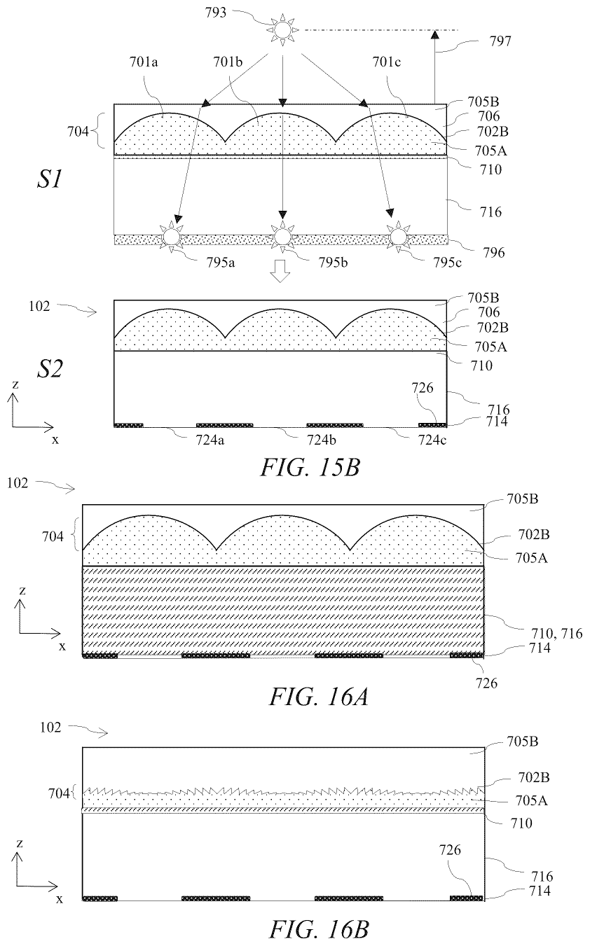

FIG. 15A is a schematic diagram illustrating top views of a method to form a birefringent lens array 701a-m. Features of the embodiment of FIG. 15A not discussed in further detail may be assumed to correspond to the features with equivalent reference numerals as discussed above, including any potential variations in the features.

In a first step S1 an isotropic material 705B is formed on substrate 706 with the surface 702B provided by replication such as moulding or UV casting. An alignment surface such as alignment layer 709B such as a polyimide is formed on the surface 702B and provided with an alignment direction 707B, for example by rubbing or photoalignment. A further alignment surface such as alignment layer 709B is provided on a further substrate 790.

In a second step S2, a birefringent material 705A such as a liquid crystal material 705A is provided on the alignment layer 707B and heated such that it is in the nematic phase so that the alignment 707A is provided. The birefringent material 705A may comprise a curable liquid crystal material such as a reactive mesogen.

In a third step S3 the further substrate 790 is provided and the liquid crystal material 705A is further aligned by the alignment direction 707A. Alternatively the substrate 790 may be omitted and the liquid crystal material surface 702A may align with homeotropic alignment for example. The liquid crystal material 705A is cured by UV illumination 792.

In a fourth step S4, optionally the substrate 790 is removed. Advantageously a low cusp offset layer 713 thickness and a small separation L may be achieved.

In a fifth step S5, the surface 702A may be provided with alignment direction 711, for example using an alignment layer provided on the surface 702A.

In a sixth step S6, a curable liquid crystal material is provided on the alignment layer on surface 702A with the thickness of a quarter waveplate and cured by UV illumination 792 to provide the reflection control polarisation conversion retarder 710. A birefringent lens layer 704 for use in the display device 100 of FIG. 1 is provided advantageously with low thickness and cost, and over a large area suitable for display applications.

A method to form a view angle control element 102 will now be described.

FIG. 15B is a schematic diagram illustrating top views of a method to form a view angle control optical element 102. Features of the embodiment of FIG. 15B not discussed in further detail may be assumed to correspond to the features with equivalent reference numerals as discussed above, including any potential variations in the features.

Continuing the method of FIG. 15A, a second transparent layer 716 may be provided on the reflection control polarisation conversion retarder 710, for example by attachment with an adhesive layer.

In a first alternative method (not shown), light blocking regions 726 may be provided on the input surface of the second transparent layer 716 for example by printing or other known deposition technique such as deposition of light absorbing material through a fine metal mask that is aligned with the lenses 701.

In a second alternative method such as illustrated by step S1 of FIG. 15B, a photosensitive layer 796 of photosensitive material may be provided on the input surface of the second transparent layer 716. A light source 793 is arranged to illuminate the photosensitive layer 796 through the lens layer 704 and second transparent layer 716 such that images 795a-c of the light source 793 are formed under each respective lens 701a-c. The distance 797 of the light source 793 from the lens layer 704 may be set to be the desirable window distance as will be described further hereinbelow. The size of the light source 793 may be arranged to provide desirable width of the apertures 724a-c. The self-alignment of the apertures 724a-c formed by illumination of regions 795a-c the photosensitive layer 796 may achieve improved image uniformity and reduced manufacturing cost.

Alternative arrangements of view angle control elements 102 and display devices 100 will now be described.

FIG. 16A is a schematic diagram illustrating in top view an alternative view angle control optical element 102 wherein the second transparent layer 716 comprises the reflection control polarisation conversion retarder 710. Features of the embodiment of FIG. 16A not discussed in further detail may be assumed to correspond to the features with equivalent reference numerals as discussed above, including any potential variations in the features.

By way of comparison with FIG. 10A, in the alternative embodiment of FIG. 16A the reflection control polarisation conversion retarder 710 may comprise a quarter wave retarder film with thickness that is suitable for the second transmissive layer 716. The quarter wave retarder film may be attached to the birefringent lens layer 704 by means of an adhesive layer (not shown). Advantageously complexity of fabrication of the view angle control element 102 may be reduced.

FIG. 16B is a schematic diagram illustrating in top view an alternative view angle control optical element 102 wherein the birefringent lens array 701a-m comprises at least one Fresnel lens. Features of the embodiment of FIG. 16B not discussed in further detail may be assumed to correspond to the features with equivalent reference numerals as discussed above, including any potential variations in the features.

By way of comparison with FIG. 10A, in the alternative embodiment of FIG. 16B, the surface 702B is provided by a Fresnel lens surface. Advantageously thickness of the lens layer 704 is reduced.

It may be desirable to further increase security factor for off-axis snoopers 47.

FIG. 17A is a schematic diagram illustrating in top view an alternative display device 100 wherein a first colour filter array is provided in a colour filter layer at the input apertures of the lens array 701a-m. Features of the embodiment of FIG. 17A not discussed in further detail may be assumed to correspond to the features with equivalent reference numerals as discussed above, including any potential variations in the features.

FIG. 17A illustrates a display device 100 comprising: a pixel layer 214 comprising a plurality of pixels 222 arranged in a pixel array; a parallax barrier layer 714 comprising a plurality of apertures 724 arranged in an aperture array, wherein each of the plurality of pixels 222 is aligned with a respective aperture 724 of the plurality of apertures; a lens layer 704 comprising a plurality of lenses 701 arranged in a lens array, wherein each of the plurality of pixels 222 is aligned with a respective lens 701 of the plurality of lenses, and wherein the plurality of lenses 701 comprises one or more birefringent lenses comprising birefringent material 705A; and a display polariser 210 which is a linear polariser, wherein the parallax barrier layer 714 is arranged between the lens layer 704 and the pixel layer 214, wherein the lens layer 704 is arranged between the pixel layer 222 and the display polariser 210, wherein the pixel layer 214 is arranged to output light towards the parallax barrier layer 714, the parallax barrier layer 714 is arranged to receive light output from the pixel layer 214 and to output light towards the lens layer 704, the lens layer 704 is arranged to receive light output from the parallax barrier layer 714 and to output light towards the display polariser 210, and the display polariser 210 is arranged to receive light output from the lens layer 704 and to output linearly polarised light, and wherein the parallax barrier layer 714 is arranged to prevent at least some of the light from each of the plurality of pixels 222 from reaching lenses 701 which are not aligned with that pixel 222.

By way of comparison with FIG. 2A, in the alternative embodiment of FIG. 17A each of the plurality of lenses 701r. 701g, 701b comprises an input aperture 708r. 708g. 708b and the display device 100 further comprises a respective first colour filter 722R, 722G, 722B aligned with the input apertures 708r. 708g, 708b of the plurality of lenses 701r. 701g. 701b. The one or more first colour filters 722 thus comprise an array of red, green and blue colour filters 722R, 722G, 722B and the plurality of first colour filters 722 are arranged in a first colour filter layer 721.

Considering FIG. 15A, the colour filters 722R, 722G, 722B may be provided on the surface 702A of the birefringent lens layer 704 in a manufacturing step between step S5 and S6 or after step S6 by means of deposition, for example through a fine metal mask or by printing.

Red light emitting pixel 222R is aligned with light transmitting aperture 724r, red transmitting first colour filter 722R and birefringent lens 701r; green light emitting pixel 222G is aligned with light transmitting aperture 724g, green transmitting first colour filter 722G and birefringent lens 701g; and blue light emitting pixel 222B is aligned with light transmitting aperture 724b, blue transmitting first colour filter 722B, and birefringent lens 701b.

In operation light ray 445 from pixel 222G is transmitted by aperture 724g, the first colour filter 722G and lens 701g. Light ray 452P is transmitted by the aperture 724g and is incident on the colour filter 722R at which at least some of the light ray 452P is absorbed at the colour filer layer 721. Any light ray 452Pt that is transmitted, for example by the absorption spectrum of the filter 722R not exactly matching the output spectrum from the pixel 222G, is reflected by the surface 702 of the lens 701r.

Arrangements herein comprising colour filters may further achieve improved colour fidelity of output. Advantageously colour gamut may be improved.

Considering FIG. 4C, luminance in the region 650 is further reduced. Advantageously improved security factor S in privacy mode is achieved in the region 650.

FIG. 17B is a schematic diagram illustrating in top view an alternative display device 100 wherein a second colour filter array is provided in a layer at the apertures of the parallax barrier layer 714. Features of the embodiment of FIG. 17B not discussed in further detail may be assumed to correspond to the features with equivalent reference numerals as discussed above, including any potential variations in the features.

By way of comparison with FIG. 2A, in the alternative embodiment of FIG. 17B the display device 100 further comprises one or more second colour filters 723 aligned with one or more of the plurality of apertures 724 of the parallax barrier layer 714. The one or more second colour filters 723 comprise an array of red, green and blue colour filters 723R, 723G, 723B. The plurality of second colour filters 723 are arranged in a second colour filter layer 725.

The second colour filters 723 may be arranged between the first transparent substrate 216 and the second transparent substrate 716. In the illustrative embodiment of FIG. 17A, the parallax barrier layer 714 is arranged to receive light from the second colour filters 723. In alternative embodiments, the second colour filters 723 may be arranged to receive light from the apertures 724 of the parallax barrier layer 714.

Red light emitting pixel 222R is aligned with red transmitting second colour filter 723R, light transmitting aperture 724r and birefringent lens 701r; green light emitting pixel 222G is aligned with green transmitting second colour filter 723G, light transmitting aperture 724g and birefringent lens 701g; and blue light emitting pixel 222B is aligned with blue transmitting second colour filter 723B, light transmitting aperture 724b and birefringent lens 701b.

In operation light ray 445 from pixel 222G is transmitted by the second colour filter 723G, aperture 724g and lens 701g. Light ray 452P is transmitted by the aperture 724g but is reflected by the surface 702 of the lens 701r. Light ray 456P that as illustrated in FIG. 2A may be output as light ray 457 PT is absorbed by the second colour filter 723R and thus the stray light from light ray 457 PT is reduced. Considering FIG. 4C, luminance in the region 652 is reduced. Advantageously improved security factor S in privacy mode is achieved.

In an alternative embodiment, the red and green pixels 222R, 222G may be arranged in a first array of columns and blue pixels 222B may be arranged in a second array of columns wherein the first and second arrays are interlaced, for example as illustrated in FIG. 1. In such an arrangement, the second colour filter layer 725 may comprise blue and yellow colour filters 723B, 723Y wherein the yellow colour filters are arranged to transmit red and green light rays and to block blue light rays. Alternative combinations, not shown, may include red and cyan colour filters 723R, 723C wherein the first array of columns comprises red pixels 222R and the second array of columns comprises blue and green pixels 222B, 222G; and green and magenta colour filters 723G, 723M wherein the first array of columns comprises green pixels 222G and the second array of columns comprises blue and red pixels 222B, 222R. Advantageously reduced cost and complexity of fabrication of the layer 721 may be achieved.

FIG. 17C is a schematic diagram illustrating in top view an alternative display device 100 wherein a first colour filter array is provided in a layer between the parallax barrier layer 714 and the layer of pixels 222 and a second colour filter array is provided in a layer between the parallax barrier layer 714 and the lens array 701a-m. Features of the embodiment of FIG. 17C not discussed in further detail may be assumed to correspond to the features with equivalent reference numerals as discussed above, including any potential variations in the features.

By way of comparison with FIG. 17A, in the alternative embodiment of FIG. 18B the display device 100 further comprises the second colour filters 723 aligned with one or more of the plurality of apertures 724 of the parallax barrier layer 714. Advantageously stray light directed towards the region 656 of FIG. 4D may be reduced and increased security factor S achieved.

FIG. 18A is a schematic diagram illustrating in top view an alternative display device 100 wherein a colour filter layer 721 is arranged at the input apertures birefringent lens layer 704. Features of the embodiment of FIG. 18A not discussed in further detail may be assumed to correspond to the features with equivalent reference numerals as discussed above, including any potential variations in the features.

FIG. 18A illustrates a display device 100 comprising: a pixel layer 214 comprising a plurality of pixels 222R, 222G, 222B arranged in a pixel array 222a-n; a first colour filter layer 721 comprising a plurality of first colour filters 722R, 722G, 722B arranged in a first colour filter array 722a-n, wherein each of the plurality of pixels 222R, 222G, 222B is aligned with a respective first colour filter 722R, 722G, 722B of the plurality of first colour filters 722R, 722G, 722B; a lens layer 704 comprising a plurality of lenses 701 arranged in a lens array 701a-m, wherein each of the plurality of pixels 222R, 222G, 222B is aligned with a respective lens of the plurality of lenses 701, and wherein the plurality of lenses 701 comprises one or more birefringent lenses 701; and a display polariser 210 which is a linear polariser, wherein the first colour filter layer 721 is arranged between the lens layer 704 and the pixel layer 214, wherein the lens layer 704 is arranged between the pixel layer 214 and the display polariser 210, wherein the pixel layer 214 is arranged to output light towards the first colour filter layer 721, the first colour filter layer 721 is arranged to receive light output from the pixel layer 214 and to output light towards the lens layer 704, the lens layer 704 is arranged to receive light output from the first colour filter layer 721 and to output light towards the display polariser 210, and the display polariser 210 is arranged to receive light output from the lens layer 704 and to output linearly polarised light, and wherein the first colour filter layer 721 is arranged to prevent at least some of the light from each of the plurality of pixels 222R, 222G, 222B from reaching lenses which are not aligned with that pixel, and wherein the each of the plurality of lenses 701 is arranged to reflect at least some of the light received from pixels 222 which are not aligned with that lens.

At least 50%, preferably at least 65% and more preferably at least 75% of the light 445 output by each of the plurality of lenses 701 of the lens layer 704 may be from the pixel with which that lens is aligned.

Each of the plurality of pixels 222R. 222G, 222B is aligned with a respective first colour filter 722R. 722G, 722B which has the same colour, each of the plurality of pixels 222R. 222G, 222B is adjacent to another pixel of the plurality of pixels 222R, 222G, 222B which has a different colour, and each of the plurality of first colour filters 722R, 722G, 722B is adjacent to another first colour filter 722R, 722G, 722B of the plurality of first colour filters 722R, 722G, 722B which has a different colour. Such an arrangement provides the light blocking effect that is described hereinabove, as provided by light blocking regions 726 of the parallax barrier layer 714.

The first colour filter layer 721 is located adjacent to the lens layer 704, and each first colour filter 722R. 722G, 722B of the first colour filter layer 721 is aligned with a respective lens of the lens layer 704.

The arrangement of FIG. 18A has operation that is similar to that described with respect to FIG. 1. FIGS. 2A-B. FIGS. 3A-B. FIGS. 4A-B and FIGS. 17A-C hereinabove, and can be used in combination with any of the other parts of the overall optical stacks shown in the said figures. At least some of the advantages thereof are the same as said FIGURES, in particular to provide output luminance profiles that are similar in nature to the illustrative profiles 740P. 740S of FIG. 4C. Most particularly but not exclusively the display devices 100 therefrom are arranged to achieve high image security to snoopers 47 in direction 447 in privacy mode, while providing high image brightness and image visibility to users 45 in direction 445; and in share mode to achieve high image visibility to users 45, 47 in directions 445, 447 respectively.

The arrangement of FIG. 18A may further comprise the polarisation switch 600 of FIG. 1 and the component parts therein, the alternatives of which and operation of which is described elsewhere hereinabove. The advantages of the polarisation switch 600 are described elsewhere herein wherein the operation of the lenses 701 may be switched to provide first and second output luminance profiles in a similar manner to those shown in FIG. 4C. A switchable privacy display device 100 for switching between a privacy mode and share mode may be achieved for pixels 222 that output light into a wide angular distribution.

The arrangement of FIG. 18A may further comprise control system 500 and at least one of voltage drivers 350, 650 to achieve switching of the display device 100 between privacy and share modes of operation.

The operation of the arrangement of FIG. 18A for ambient light is similar to that illustrated for example in FIGS. 5A-B, and at least some of the advantages including improved image contrast provided by the reflection control polarisation conversion retarder 710 are as described therein. Further the colour filters may achieve further reduction of reflected light from ambient light sources.

The arrangement of FIG. 18A may further comprise the reflective polariser 302, switchable polar control retarder 300 and additional polariser 318 of FIG. 1, the operation, alternatives and at least some of the advantages of which are described elsewhere herein with respect to FIGS. 6A-B, FIGS. 7C-D, FIGS. 6C-D and FIGS. 6E-F. The security factor in privacy mode may advantageously be increased and high image visibility may be achieved in share mode.

The arrangement of FIG. 18A may further be modified similarly to the alternative embodiments of the alternative substrates 216, 716 of FIG. 9; the alternative view angle control element 102 structures of FIGS. 10A-B; the two dimensional arrays of FIG. 11A, the alternative arrangements of birefringent lenses 701 of FIGS. 11B-E; the inorganic micro-LEDs of FIG. 12, the non-switching birefringent lenses of FIGS. 13A-B; the alternative arrangements of birefringent and isotropic materials 705A, 705B, microlens arrays, and reflection control polarisation conversion retarder 710 of FIGS. 14A-C; the birefringent lens manufacturing method of FIG. 15A; and the alternative view angle control elements 102 of FIGS. 16A-B. At least some of the advantages and further alternatives of said alternative embodiments are as described in the respective descriptions hereinabove.

Further in the embodiments hereinabove, the lens layer 704 may comprise first and second isotropic materials 705A, 705B wherein the polarisation switch 600 is omitted. Advantageously cost and complexity of fabrication of the lens layer 704 may be reduced.

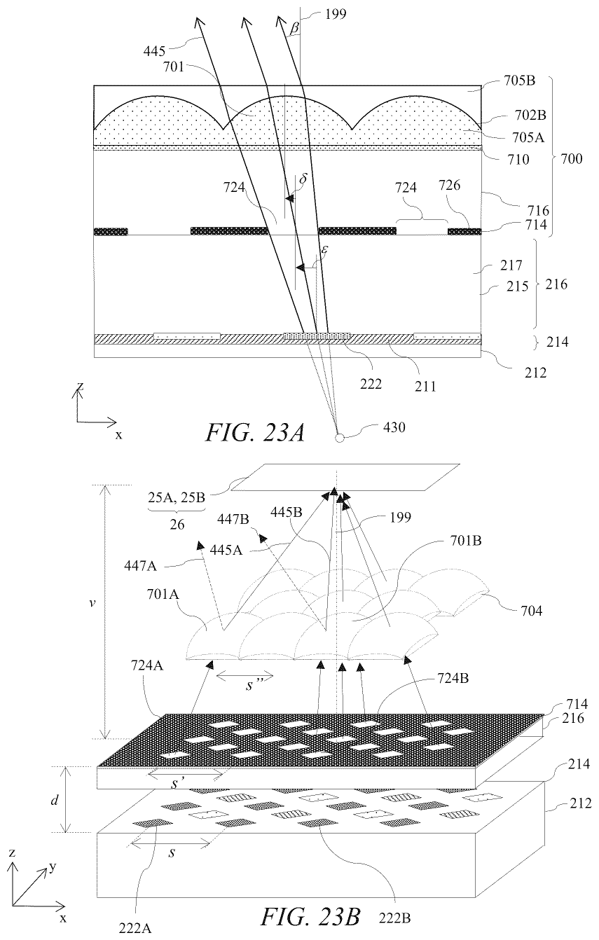

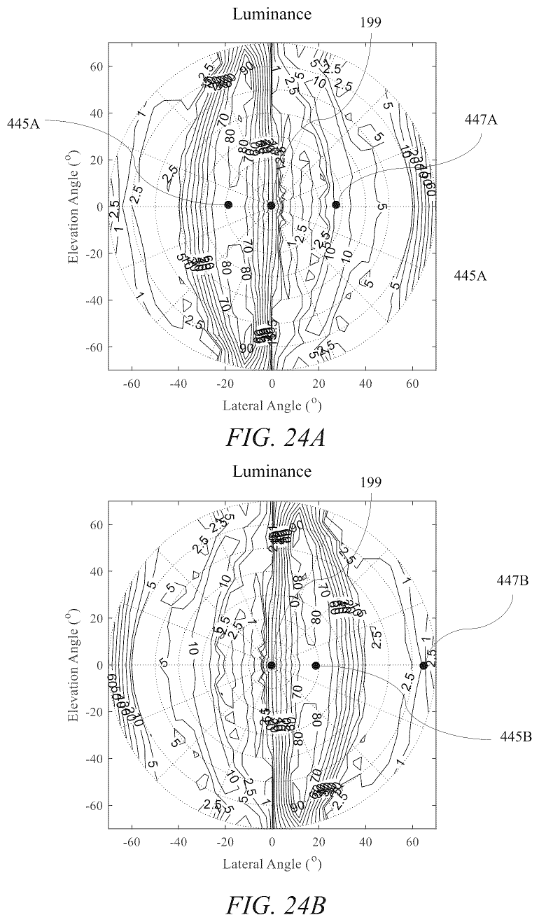

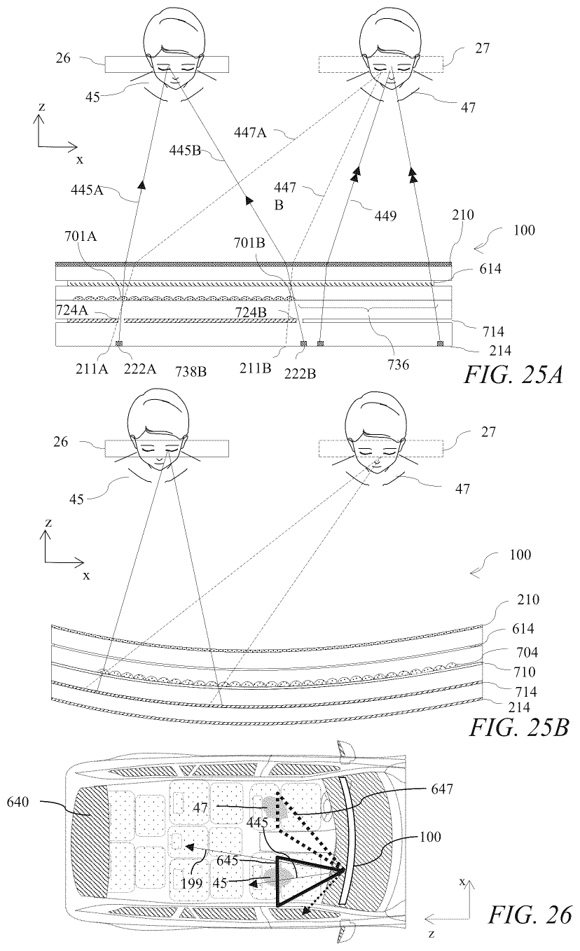

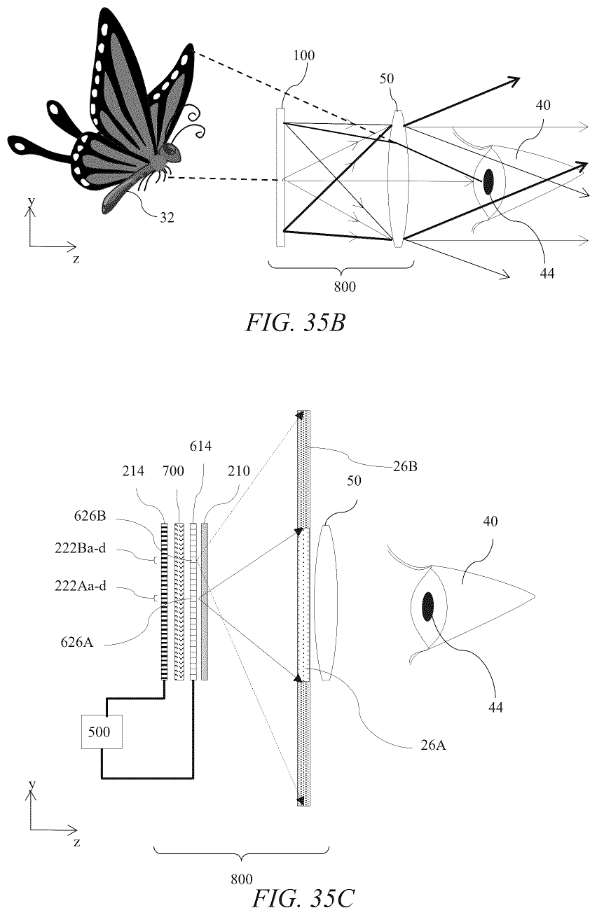

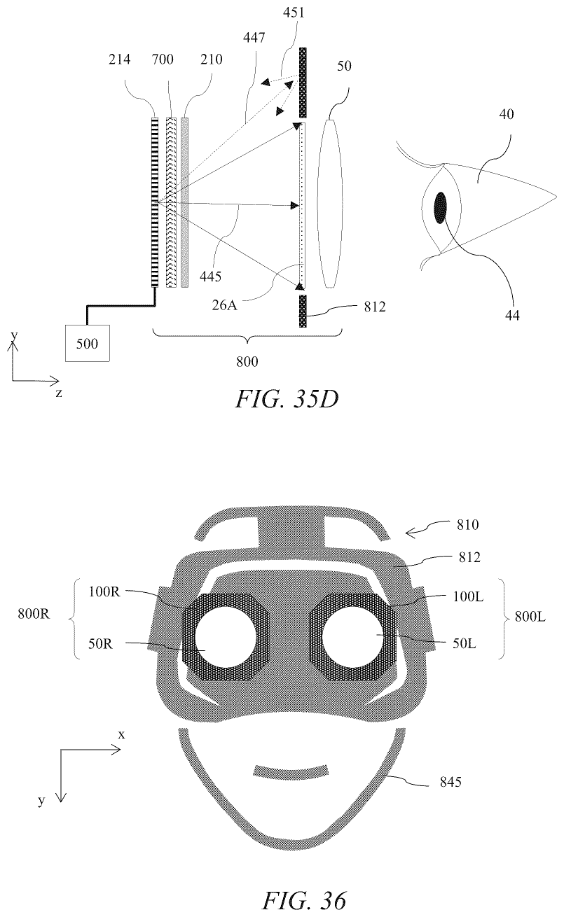

The pitch and relative location of the first optical filters 722 may be modified as illustrated for the modified pitch of the lenses 701 in FIG. 23B; and pitch and relative location of the second optical filters 723 may be modified as illustrated for the modified pitch of the apertures 724 in FIG. 23B. Advantageously increased image uniformity may be achieved and off-axis operation provided, as described in FIGS. 24A-B. FIGS. 25A-B, FIG. 26 hereinbelow. The display devices 100 may further be provided in near-eye displays 800 as illustrated in FIGS. 35A-C, and FIG. 36 hereinbelow.

FIG. 18B is a schematic diagram illustrating in top view an alternative display device 100 wherein the parallax barrier layer 714 is provided by a first colour filter array and a second colour filter array is provided in a layer between the parallax barrier layer 714 and the lens array 701a-m. Features of the embodiment of FIG. 18B not discussed in further detail may be assumed to correspond to the features with equivalent reference numerals as discussed above, including any potential variations in the features.

By way of comparison with FIG. 18A, in the alternative embodiment of FIG. 18B a second colour filter layer 725 is provided. Further, by way of comparison with FIG. 17C, in the alternative embodiment of FIG. 18B the display device 100 the parallax barrier layer 714 comprises the second colour filter layer 725.

The display device 100 further comprises a second colour filter layer 725 comprising a plurality of second colour filters 723R, 723G, 723B arranged in a second colour filter array 722a-n, wherein each of the plurality of pixels 222R, 222G, 222B is aligned with a respective second colour filter 723R, 723G, 723B of the plurality of second colour filters 723R, 723G, 723B. The second colour filter layer 725 is arranged to receive light output from the pixel layer 214 and to output light towards the first colour filter layer 721. The second colour filter layer 725 is arranged between the first colour filter layer 721 and the pixel layer 214. Each second colour filter 723R. 723G, 723B is aligned with a respective first colour filter 722R, 722G, 722B which has the same colour.

Colour filter 723R provides aperture 724r for red light from pixel 222R and light blocking regions 726g. 726b for green and blue light from adjacent green and blue pixels 222G, 222B; colour filter 723G provides aperture 724g for green light from pixel 222G and light blocking regions 726r. 726b for red and blue light from adjacent red and blue pixels 222R. 222B; and colour filter 723B provides aperture 724b for blue light from pixel 222B and light blocking regions 726r. 726g for red and green light from adjacent red and blue pixels 222R. 222B. Advantageously cost and complexity of the parallax barrier layer 714 may be reduced in comparison to the embodiment of FIG. 17C. Stray light in privacy mode directed towards snooper 47 in directions 447 is reduced in comparison to the embodiment of FIG. 18A. Advantageously security factor, S is increased.

Further alternatives of FIG. 18B include use in combination with any other parts of the optical stacks with at least some of the advantages therein are as described with reference to FIG. 18A and the embodiments of FIG. 1 and alternatives hereinabove.

FIG. 18C is a schematic diagram illustrating in top view a view angle control element 102 comprising a first colour filter layer 721. Features of the embodiments of FIG. 18C not discussed in further detail may be assumed to correspond to the features with equivalent reference numerals as discussed above, including any potential variations in the features.

A view angle control optical element 102 for use with a pixel layer 214 of a display device 100, the pixel layer 214 comprising a plurality of pixels 222R. 222G, 222B arranged in a pixel array 222a-n, wherein the view angle control optical element comprises: a first colour filter layer 721 comprising a plurality of first colour filters 722R, 722G, 722B arranged in a first colour filter array 722a-n, wherein, in use, each of the plurality of first colour filters 722R, 722G, 722B is aligned with a respective pixel of the plurality of pixels 222R, 222G, 222B; a lens layer 704 comprising a plurality of lenses 701 arranged in a lens array 701a-m, wherein, in use, each of the plurality of lenses 701 is aligned with a respective pixel of the plurality of pixels 222R. 222G, 222B, and wherein the plurality of lenses 701 comprises one or more birefringent lenses 701; and a display polariser 210 which is a linear polariser, wherein, in use, the first colour filter layer 721 is arranged between the lens layer 704 and the pixel layer 214, wherein, in use, the lens layer 704 is arranged between the pixel layer 214 and the display polariser 210, wherein, in use, the pixel layer 214 is arranged to output light towards the first colour filter layer 721, the first colour filter layer 721 is arranged to receive light output from the pixel layer 214 and to output light towards the lens layer 704, the lens layer 704 is arranged to receive light output from the first colour filter layer 721 and to output light towards the display polariser 210, and the display polariser 210 is arranged to receive light output from the lens layer 704 and to output linearly polarised light, and wherein, in use, the first colour filter layer 721 is arranged to prevent at least some of the light from each of the plurality of pixels 222R, 222G, 222B from reaching lenses which are not aligned with that pixel, and wherein the each of the plurality of lenses 701 is arranged to reflect at least some of the light received from pixels 222 which are not aligned with that lens.

Various arrangements of pixels 222, colour filter layer 721 and lens layer 701 will now be described.

FIG. 19A is a schematic diagram illustrating in front perspective view an alternative arrangement of optical layers comprising pixel layer 214, a one dimensional colour filter layer 721 and a one dimensional lens array 704; FIG. 19B is a schematic diagram illustrating in front perspective view an alternative arrangement of optical layers comprising pixel layer 214, an alternative one dimensional colour filter layer 721 and a one dimensional lens array 704; FIG. 19C is a schematic diagram illustrating in front perspective view an alternative arrangement of optical layers comprising pixel layer 214, a one dimensional colour filter layer 721 and a two dimensional lens array 704; and FIG. 19D is a schematic diagram illustrating in front perspective view an alternative arrangement of optical layers comprising pixel layer 214 a chequerboard colour filter layer 721 and a two dimensional lens array 704. Features of the embodiments of FIGS. 19A-D not discussed in further detail may be assumed to correspond to the features with equivalent reference numerals as discussed above, including any potential variations in the features.

The alternative embodiment of FIGS. 19A-D may be provided with the display devices 100 or view angle control elements 102 of FIG. 17A, FIG. 17C and FIGS. 18A-C hereinabove. The arrangements of first colour filter layer 721 of FIGS. 19A-D may further be used for the second colour filter layer 725 of FIGS. 17B-C and FIG. 18B. In embodiments wherein both first and second colour filter arrays are provided, the arrangement of colour filter layers 721, 725 may be the same. The pitch between the respective colour filters 722, 723 may be the same or may be different as will be described hereinbelow with respect to optical window 26 formation.

The alternative embodiment of FIGS. 19A-B provide a one dimensional profile, for example similar in polar variation to those illustrated in FIGS. 7A-B hereinabove.

By way of comparison with FIG. 19A, the alternative embodiment of FIG. 19B uses yellow filters 722Y combined with columns of red and green pixels 222R, 222G; and a blue colour filter 722B aligned with columns of blue pixels 222B as described hereinabove, for example as illustrated in FIG. 1. In such an arrangement, the first colour filter layer 721 may comprise blue and yellow colour filters 722B, 722Y wherein the yellow colour filters are arranged to transmit red and green light rays and to block blue light rays. Alternative combinations, not shown, may include red and cyan colour filters 722R. 722C wherein the first array of columns comprises red pixels 222R and the second array of columns comprises blue and green pixels 222B, 222G; and green and magenta colour filters 722G, 722M wherein the first array of columns comprises green pixels 222G and the second array of columns comprises blue and red pixels 222B, 222R. Advantageously reduced cost and complexity of fabrication of the layer 721 may be achieved.

By way of comparison with FIG. 19A, the alternative embodiment of FIG. 19B may achieve increased brightness in the elevation direction arising from optical power in both lateral and elevation directions of the lenses 701 of the lens layer 704.

By way of comparison with FIG. 19B, the alternative embodiment of FIG. 19C may achieve increased brightness in the elevation direction arising from optical power in both lateral and elevation directions of the lenses 701 of the lens layer 704. Further stray light in the elevation direction may be reduced arising from the chequerboard arrangement of colour filters 722.

By way of comparison with FIG. 19C, the alternative embodiment of FIG. 19D provides reduced luminance in lateral and elevation directions. A privacy display device 100 suitable for landscape and portrait operation may be provided.

It may be desirable to reduce variation of display device 100 colour with viewing angle.

FIG. 20A is a schematic diagram illustrating in top view an alternative display device 100 wherein the width α_{R}, α_{G}, α_{B} of the apertures 724 of the parallax barrier layer 714 and the width ω_{R}, ω_{G}, ω_{B} of the pixels 222R, 222G, 222B is adjusted to compensate for colour variations in display luminance angular profile; and FIG. 20B is a schematic graph illustrating the profiles 760R. 760G, 760B of output luminance with viewing angle for typical organic LED red pixels 222R, green pixels 222G and blue pixels 222B; and illustrating a modified profile 762 of output luminance with viewing angle for the modified display apparatus. Features of the embodiments of FIGS. 20A-B not discussed in further detail may be assumed to correspond to the features with equivalent reference numerals as discussed above, including any potential variations in the features.

Considering the alternative embodiment of FIG. 20A, differences in the dispersion of the refractive index of materials 705A, 705B can provide different focal regions 430R, 430G, 430B for red, green and blue light respectively. Optical spot 431R. 431G, 431B widths OR, OG, OB at the pixel plane 214 are determined by the distance of focal regions 430R, 430G, 430B from the pixel plane 214 and by the widths α_{R}, α_{G}, α_{B} of the apertures 724R. 724G, 724B that are aligned with the pixels 222R, 222G, 222B respectively.

Considering FIG. 20B, illustrative profiles 760R, 760G, 760B for red, green and blue light of relative luminance against viewing angle in the lateral direction are illustrated. The profiles 760R, 760G, 760B may be different arising from differences in the display luminance angular profile for each colour of the different colour pixels 222R. 222G, 222B. Such colour differences may arise from the optical structure of the respective pixels 222. For OLED pixels 222, such colour differences may arise for example from optical etalons at the pixel plane 214, and for inorganic micro-LED pixels 222 such colour differences may arise for example from differences in forward emission to edge emission efficiency.

Returning to FIG. 20A, the display luminance angular profile 760 may be determined by convolution of the width ω_{R}, ω_{G}, ω_{B} of each of the different colour pixels 222R, 222G, 222B, with the spot 431R, 431G, 431B width σ_{R}, σ_{G}, σ_{B} at the pixel plane 214. Such roll-offs from adjusting the geometry of the pixels 222, and apertures 724 differently for red, green and blue pixels are referred to herein as geometric roll-off corrections.

In an alternative embodiment, the pixel layer 214 comprises different colour pixels 222R, 222G, 222B and the width ω_{R}, ω_{G}, ω_{B} of each of the different colour pixels 222R, 222G, 222B in the at least one direction (such as the lateral direction, x-axis) is arranged to compensate for chromatic aberration of the plurality of lenses 701 of the lens layer 704, such that variation in display luminance angular profile 762 is the same for each colour of the different colour pixels 222.

In a further alternative embodiment the parallax barrier layer 714 comprises different width apertures 724R, 724G, 724B and the width α_{R}, α_{G}, α_{B} of each of the different width apertures 724R, 724G, 724B in the at least one direction is arranged to compensate for angular colour variations of the output of the different colour pixels 222, such that variation in display luminance angular profile 762 is the same for each colour of the different colour pixels 222.

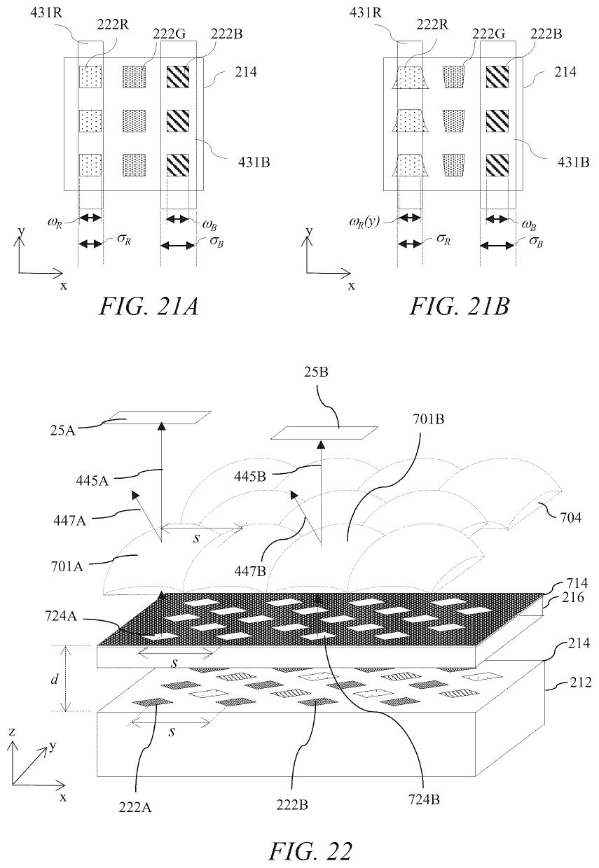

FIG. 21A is a schematic diagram illustrating in front view an alternative display device wherein the size of the apertures of the parallax barrier and the width of the pixels is adjusted to compensate for colour variations in display luminance angular profile 760R. 760B; and FIG. 21B is a schematic diagram illustrating in front view an alternative display device wherein the width of the apertures of the parallax barrier and the shape of the pixels is adjusted to compensate for colour variations in display luminance angular profile 760R. 760B. Features of the embodiments of FIGS. 21A-B not discussed in further detail may be assumed to correspond to the features with equivalent reference numerals as discussed above, including any potential variations in the features.

The embodiment of FIG. 21A illustrates that all the pixels 222R, 222G, 222B have the same shape. In an illustrative example, the profile 760R of FIG. 20B for red light may have a profile that is wider at angles near to the normal direction 199 than for the profile 760B. It would be desirable that the output for red, green and blue light is the same as profile 762. To achieve the compensation of the profile 762 it would be desirable to provide a faster geometric roll-off in luminance for red light from red pixels 222 than for blue light from blue pixels 222B. Such faster geometric roll-off may be provided for example by providing an aperture 724R width α_{R} that is smaller than the aperture 724B width α_{B} so that the spot 431R size width σ_{R} and is smaller than the spot 431B size width σ_{B}. Alternatively the width ω_{R} of the red pixels 222R may be set to be smaller than the width ω_{B} of the blue pixels 222B. Such modifications of widths ω, α are determined from the respective different focal regions 430 that determines the spot width σ at the pixel plane 214 and are determined at least in part by the chromatic aberration of the lenses 701.

The embodiment of FIG. 21A illustrates a pixel layer 214 that comprises different colour pixels 222R, 222G, 222B and the shape of each of the different colour pixels 222R, 222G, 222B is arranged to compensate for angular colour variations of the output of the different colour pixels, such that variation in display luminance angular profile is the same for each colour of the different colour pixels. The pixels 222R, 222G, 222B have a different shape so that the pixels 222R have a width ω_{R}(y) that varies in the direction in which the lenses are extended. In the illustrative embodiment of FIG. 21B, the blue pixels may be rectangular while the red pixels may be trapezoidal with curved edges to provide desirable display luminance roll-off 760R that is the same as the display luminance roll-off 760B. In operation, the convolution of the pixel shape ω(γ) with the spot 431 width σ arising from aperture width α provides a different geometric roll-off of profile 760 for the red, green and blue pixels 222R. 222G, 222B to provide correction of luminance variations in display luminance angular profile 760R. 760B at larger elevation angles. Advantageously display white point variations with viewing angle may be reduced.

It may be desirable to provide maximum luminance in directions 445 that are not parallel to the normal direction 199 to the display device 100.

FIG. 22 is a schematic diagram illustrating in side perspective view optical window formation for an alternative display device 100 wherein the pitch of the pixels 222, the pitch of the apertures 724 of the parallax barrier layer 714 and the pitch of the birefringent lenses 701 are the same separation, s. Features of the embodiment of FIG. 22 not discussed in further detail may be assumed to correspond to the features with equivalent reference numerals as discussed above, including any potential variations in the features.

In operation, the pixel 222A, aperture 724A and lens 701A provide an angular distribution represented by optical region 25A with centre direction 445A; and the pixel 222B, aperture 724B and lens 701B provide an angular distribution represented by optical region 25B with centre direction 445B that is parallel to the direction 445A. An observer 45 at a given location will see a different luminance from the pixels 222A. 222B across the display device 100 because of the different subtended angle of the eye of the observer 45 to the respective pixels 222A, 222B.

FIG. 23A is a schematic diagram illustrating in top view an alternative display device 100 wherein the location of the apertures 724 of the parallax barrier layer 714 and the location of the birefringent lenses 701 is adjusted to provide off-axis direction for maximum luminance; and FIG. 23B is a schematic diagram illustrating in side perspective view optical window formation for an alternative display device 100 wherein the pixels 222, the apertures 724 of the parallax barrier layer 714 and the birefringent lenses 701 have pitches that are adjusted to provide a common optical window from locations across the display device 100. Features of the embodiments of FIGS. 23A-B not discussed in further detail may be assumed to correspond to the features with equivalent reference numerals as discussed above, including any potential variations in the features.

By way of comparison with FIG. 2A, in the alternative embodiment of FIG. 23A the centre of aligned aperture 724 has a non-zero offset ε from the centre of pixel 222 and the respective aligned lens 701 has a non-zero offset δ from the centre of pixel 222. Such arrangement achieves peak luminance in direction 445 that is inclined at angle β to the normal direction 199.

By way of comparison with FIG. 22, in the alternative embodiment of FIG. 23B the pitch s′ of the apertures 724 in the parallax barrier layer 714 and the pitch s″ of the lenses 701 in the lens layer 704 are arranged relative to the pitch s of the pixels 222 in the pixel layer 214 so as to direct light from each pixel of the plurality of pixels 222 into a common viewing window 26 at a window distance v.

Returning to the description of TABLE 1, the pitches of pixels 222R, respective aligned aperture 724 and respective aligned lens 701 are each different to achieve the common window 26 from each part of the display across at least the lateral direction. While it is not reasonable to provide item 222, 724, 701 each with a pitch accurate to within 1 nanometer, in manufacture the average pitch of 1000 lenses may be adjusted to have a pitch within 1 micrometer, for example by inserting or deleting fractional intervals in item pitch across the array of items. The arrangement of TABLE 1 may achieve a window 26 distance v of 400 mm for example.

In operation, an observer 45 at the optical window 26 will observe substantially the same luminance from different pixels 222A, 222B across the display device 100. Advantageously display luminance uniformity may be increased. Further, the non-viewing region for snooper 47 in directions 447A, 447B may have improved uniformity of luminance. Advantageously uniformity of security factor, S may be increased.

FIG. 24A is a schematic graph illustrating the polar variation of luminance output for the embodiment of FIG. 23B in privacy mode for the case of pixels 222A arranged on the right side of the display device 100; and FIG. 24B is a schematic graph illustrating the polar variation of luminance output for the embodiment of FIG. 23B in privacy mode for the case of pixels 222B arranged on the left side of the display device 100. Features of the embodiments of FIGS. 24A-B not discussed in further detail may be assumed to correspond to the features with equivalent reference numerals as discussed above, including any potential variations in the features.

By way of comparison with FIG. 7A, the directions 445A, 445B are different for different parts of the display and are offset from the normal direction 199.

FIG. 25A is a schematic diagram illustrating in top view optical window formation for the alternative display device 100 of FIG. 23B wherein the display device 100 is planar; and FIG. 25B is a schematic diagram illustrating in top view optical window formation for the alternative display device 100 of FIG. 23B wherein the display device 100 is curved. Features of the embodiments of FIGS. 25A-B not discussed in further detail may be assumed to correspond to the features with equivalent reference numerals as discussed above, including any potential variations in the features.

The alternative embodiment of FIG. 25A further illustrates the formation of optical window 26 from the region of the display device 100 comprising lens 701, and further illustrates the formation of a snooper window 27 for light that would be directed from regions of gaps 211A. 211B that comprises the low luminance regions of the output luminance angular distribution to achieve improved uniformity of security factor, S.

FIG. 25A further illustrates that the lenses 701 may be provided over part of the display device 100 and in region 736 the lenses 701 and parallax barrier 701 are omitted. In operation, the viewing angle profile of the display device 100 provided by rays 449 may be different in the region 736, for example to provide a display that is viewable from a wide range of viewing angles. In alternative embodiments not shown, the parallax barrier layer 714 only may be omitted in the region 736. Increased brightness may advantageously be achieved. In alternative embodiments not shown, the lens layer 704 only may be omitted. Display uniformity may advantageously be increased.

The alternative embodiment of FIG. 25B further illustrates a curved display device 100. By way of comparison with FIG. 25A, the pitches s, s′ and s″ of FIG. 23B may be modified to compensate for the curvature of the display device 100 to achieve desirable uniformity of luminance and security factor S at nominal user 45 and snooper 47 locations.

It may be desirable to provide a passenger infotainment display device 100.

FIG. 26 is a schematic diagram illustrating in top view an automotive vehicle 640 comprising a curved display device 100 of the present embodiments. Features of the embodiment of FIG. 26 not discussed in further detail may be assumed to correspond to the features with equivalent reference numerals as discussed above, including any potential variations in the features.

The driver 47 may be located at a nominal angle that is offset from the direction 445, for example by 45°; however in operation, it is desirable that the driver leaning towards the display to within 25°, sufficiently high security factor is maintained. The present embodiments may achieve such.

In a privacy mode that may be termed a no driver distraction mode, passenger 45 in light cone 645 is arranged to see the display device 100 with high image visibility while the driver 47 (that is a type of snooper) in light cone 647 experiences high security factor, S. By comparison with laptop displays, the light cone 645 may desirably be offset from the normal direction 199.

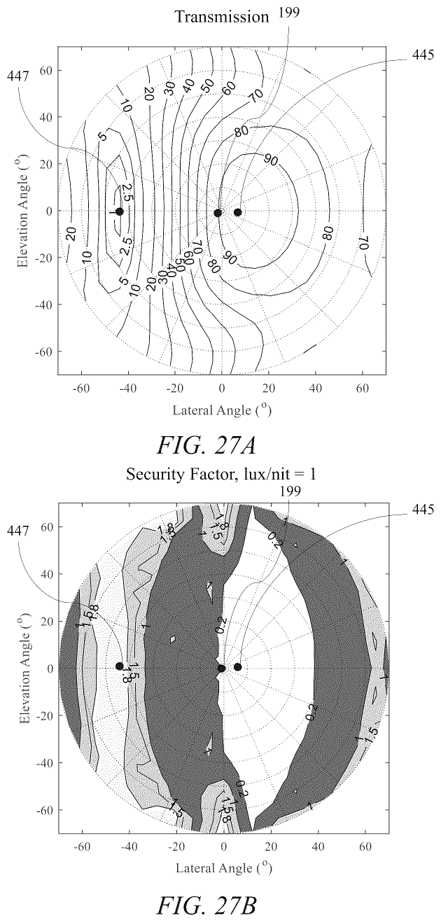

FIG. 27A is a schematic graph illustrating the polar variation of transmission for a polar control retarder 300 comprising the illustrative embodiment of TABLE 4; and FIG. 27B is a schematic graph illustrating the polar variation of security factor S at 1 lux/nit ambient illuminance 604 to maximum display luminance for a display device 100 of FIG. 1 wherein display device 100 comprises the luminance output of FIG. 24B and the polar control retarder 300 comprises the transmission profile of FIG. 27A. Features of the embodiment of FIGS. 27A-B not discussed in further detail may be assumed to correspond to the features with equivalent reference numerals as discussed above, including any potential variations in the features.

By way of comparison with TABLE 2, the alternative embodiment of TABLE 4 is provided with no passive compensation retarder 330. Considering FIG. 2A, the display polariser 210 may be provided with an additional half wave retarder (not shown) to provide a phase difference that rotates the linear polarisation state 902P by 45° so that the electric vector transmission direction 219 is at 135°. The polar control retarder provides an off-axis peak luminance direction 445.

TABLE 4

| | In-plane | In-plane | | Active LC retarder 301 | | | |
|---|---|---|---|---|---|---|---|
| | rotation | rotation | | Alignment | | | |
| Item | angle | angle | Twist | layers | Pretilt | Δn.d | V_{C} |
| 318 | 319 | 135° | | | | | |
| 314 | 417 Ap, θ_{A} | 135° | 90° | Homogeneous | 2° | 500 nm | 1.45 V |
| | 417 Bp, θ_{B} | 45° | | Homogeneous | 2° | | |
| 210 | 219 | 135° | | | | | |

FIG. 27B illustrates that a security factor S profile that is offset from the optical axis direction 199 may be provided. A viewing arrangement suitable for the vehicle 640 of FIG. 26 may be achieved.

It may be desirable to provide further improvement in security factor for non-viewing directions.

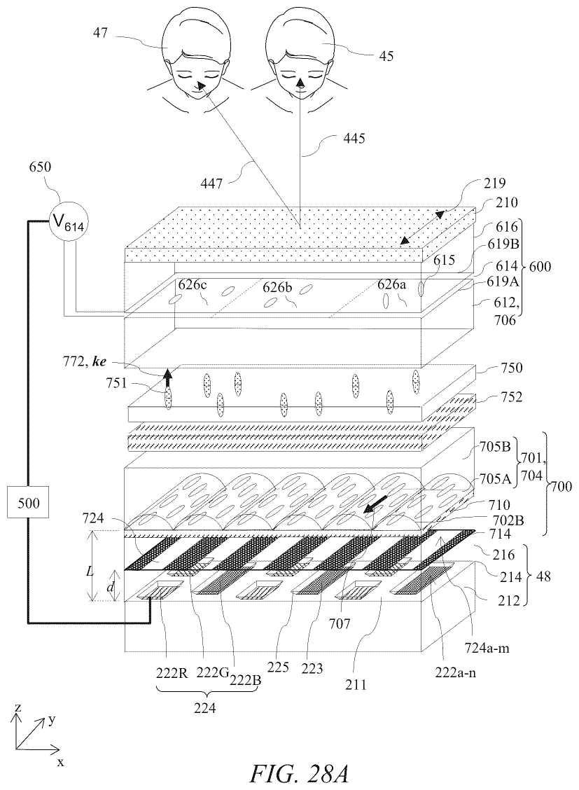

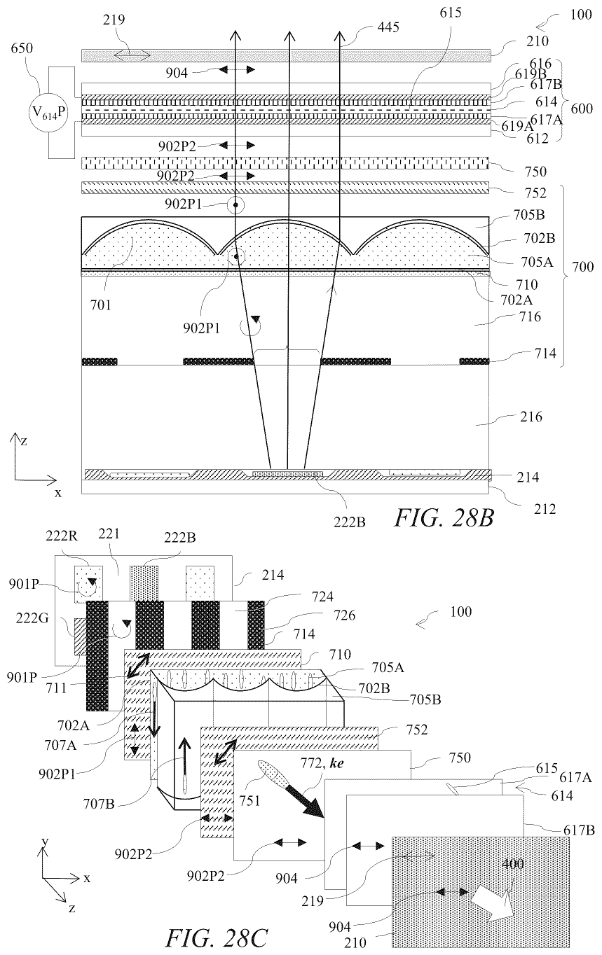

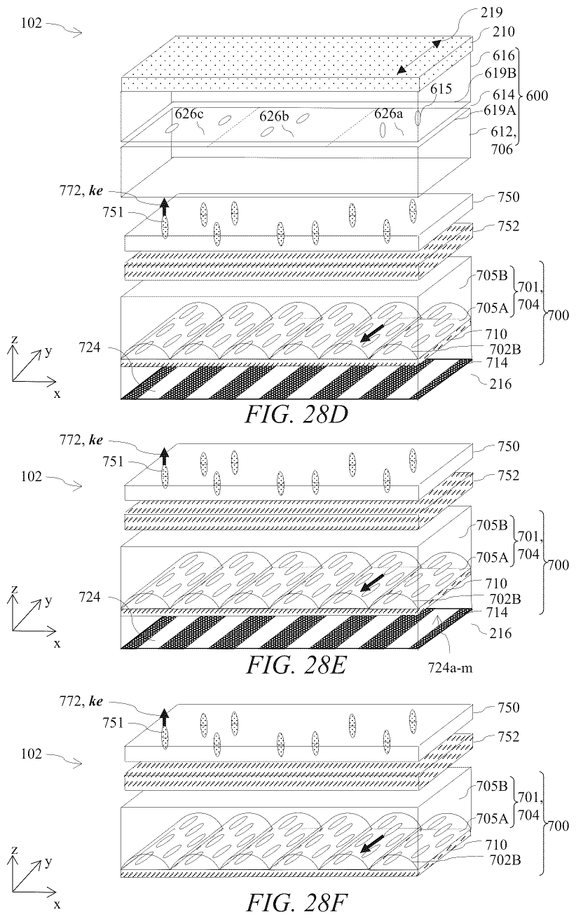

FIG. 28A is a schematic diagram illustrating in side perspective view a switchable privacy display device 100 comprising an OLED emissive SLM 48; and a parallax barrier layer 714, birefringent lens array 701 in lens layer 704, out-of-plane polariser 750; polarisation switch 600, and display polariser 210 arranged on the output side of the SLM 48; FIG. 28B is a schematic diagram illustrating in top view the switchable privacy display device 100 of FIG. 28A arranged in privacy mode; and FIG. 28C is a schematic diagram illustrating in front perspective view, alignment of optical layers in the display device 100 of FIGS. 28A-B. Features of the embodiments of FIGS. 28A-C not discussed in further detail may be assumed to correspond to the features with equivalent reference numerals as discussed above, including any potential variations in the features.

In the alternative embodiment of FIGS. 28A-C, the display device 100 comprises: a pixel layer 214 comprising a plurality of pixels 222 arranged in a pixel array 222a-n; a lens layer 704 comprising a plurality of lenses 701 arranged in a lens array, wherein each of the plurality of pixels 222 is aligned with a respective lens of the plurality of lenses 701, and wherein the plurality of lenses 701 comprises one or more birefringent lenses. The display device 100 further comprises a display polariser 210 which is a linear polariser; and an out-of-plane polariser 750, wherein in the embodiment of FIGS. 28A-C the lens layer 704 is arranged between the pixel layer 214 and the out-of-plane polariser 750.

The out-of-plane polariser 750 is arranged between the lens layer 704 and the display polariser 210. The pixel layer 214 is arranged to output light towards the lens layer 704. The lens layer 704 is arranged to receive light output from the pixel layer 214 and to output light towards the out-of-plane polariser 750. The out-of-plane polariser 750 is arranged to receive light output from the lens layer 704 and to output light towards the display polariser 210, and the display polariser 210 is arranged to receive light output from the out-of-plane polariser 750 and to output linearly polarised light.

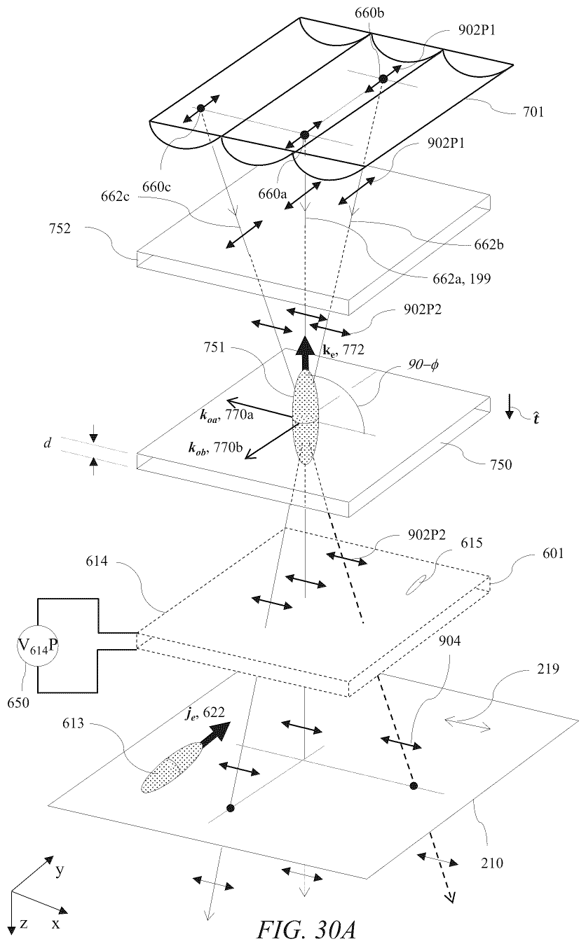

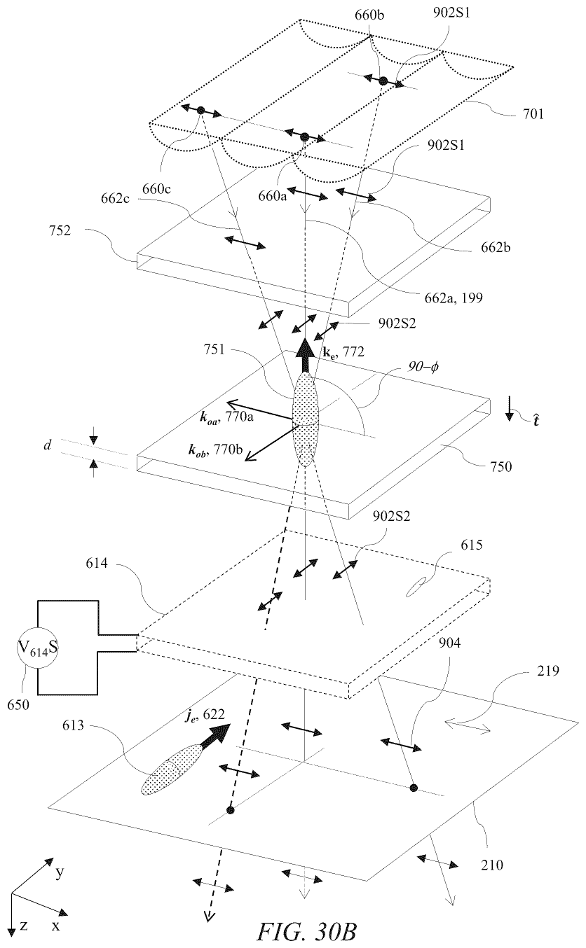

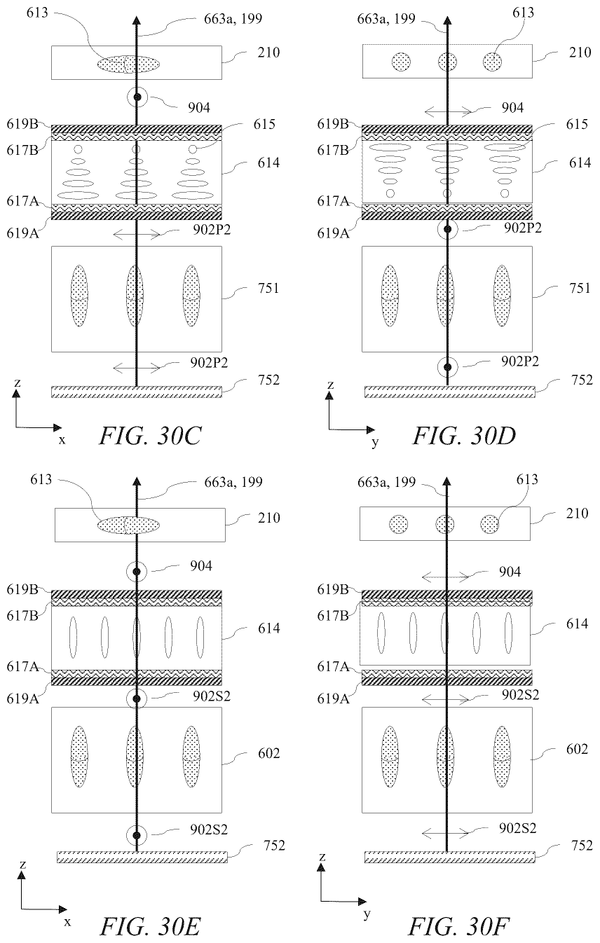

The birefringent lenses 701 may be provided with alignment of liquid crystal material 705A that provides alignment of the extraordinary refractive index parallel to the direction in which the birefringent lenses 701 are extended and the refractive index of the isotropic material 705B may be less than the extraordinary refractive index of the birefringent material 705A. The birefringent lenses 701 may be arranged to operate with a polarisation state 902P1 that has an electric vector direction parallel to the direction in which the birefringent lenses 701 are extended. As described further hereinbelow with respect to FIGS. 30A-F, desirably in privacy mode the light that is transmitted by the display polariser 210 has a polarisation state 902P1 at the birefringent lens 701 and an orthogonal polarisation state 902P2 at the out-of-plane polariser 750. The display device 100 further comprises a half-wave retarder 752 arranged between the lens layer 704 and the out-of-plane polariser 750. FIG. 28B illustrates that in privacy mode, the polarisation state 902P1 that is incident onto the birefringent lenses 701 such that said lenses 701 provide optical power is rotated to polarisation state 902P2 by the half-wave retarder 752.

The display device 100 further comprises a polarisation switch layer 614 arranged between the out-of-plane polariser 750 and the display polariser 210 and the polarisation switch layer 614 comprises a switchable liquid crystal layer comprising liquid crystal material 615 as described further hereinabove.

The polarisation switch layer 614 is switchable between a first mode in which it is arranged to change a polarisation state of the light passing therethrough and a second mode in which it is arranged to affect the polarisation state of the light passing therethrough differently from the first mode. In the first mode, the polarisation switch layer 614 is arranged to change the polarisation state of the light passing therethrough from a first linear polarisation state to a second linear polarisation state that is orthogonal to the first linear polarisation state. In the second mode, the polarisation switch layer 614 is arranged not to change the polarisation state of the light passing therethrough. Thus in privacy mode the output polarisation state 904 from the polarisation switch layer 614 is provided to be the same as the polarisation state 902P2, that is no modification of the polarisation state 902P2 is provided.

In an alternative embodiment, the birefringent lenses 701 may be provided with alignment of liquid crystal material 705A and refractive indices of the materials 705A, 705B to achieve positive optical power for the polarisation state 902P2 that is orthogonal to the polarisation state 902P1. The half-wave retarder 752 may be omitted.

As described further hereinabove the display device 100 further comprises a parallax barrier layer 714 comprising a plurality of apertures 724 arranged in an aperture array, wherein each of the plurality of pixels 222 is aligned with a respective aperture 724 of the plurality of apertures 724. The parallax barrier layer 714 is arranged to prevent at least some of the light from each of the plurality of pixels 222 from reaching lenses which are not aligned with that pixel, and wherein the each of the plurality of lenses 701 is arranged to reflect at least some of the light received from pixels 222 which are not aligned with that lens 701. Such parallax barrier layer 714 is thus arranged to reduce visibility of off-axis light from the display device 100.

Non-exhaustive illustrative embodiments of view angle control elements 102 will now be described.

FIG. 28D is a schematic diagram illustrating in side perspective view a view angle control optical element 102 comprising a parallax barrier layer 714, birefringent lens array 701, half-wave retarder 752, out-of-plane polariser 750; polarisation switch 600, and display polariser 210 for use with a pixel layer 214 of a display device 100; FIG. 28E is a schematic diagram illustrating in side perspective view a view angle control optical element 102 comprising a parallax barrier layer 714, birefringent lens array 701, half-wave retarder 752, and out-of-plane polariser 750 for use with a pixel layer 214 of a display device 100; and FIG. 28F is a schematic diagram illustrating in side perspective view a view angle control optical element 102 comprising a birefringent lens array 701, half-wave retarder 752, and out-of-plane polariser 750 for use with a pixel layer 214 of a display device 100. Features of the embodiments of FIGS. 28D-F not discussed in further detail may be assumed to correspond to the features with equivalent reference numerals as discussed above, including any potential variations in the features.

A view angle control optical element 102 for use with a pixel layer 214 of a display device 100, the pixel layer 214 comprising a plurality of pixels 222 arranged in a pixel array 222a-n, wherein the view angle control optical element 102 comprises: a lens layer 704 comprising a plurality of lenses 701 arranged in a lens array, wherein, in use, each of the plurality of pixels 222 is aligned with a respective lens 701 of the plurality of lenses 701, and wherein the plurality of lenses 701 comprises one or more birefringent lenses; a display polariser 210 which is a linear in-plane polariser; and an out-of-plane polariser 750, wherein, in use, the lens layer 704 is arranged between the pixel layer 214 and the out-of-plane polariser 750, wherein, in use, the out-of-plane polariser 750 is arranged between the lens layer 704 and the display polariser 210 or arranged between the lens layer 704 and the pixel layer 214, wherein, in use, the pixel layer 214 is arranged to output light towards the lens layer 704, the lens layer 704 is arranged to receive light output from the pixel layer 214 and to output light towards the out-of-plane polariser 750, the out-of-plane polariser 750 is arranged to receive light output from the lens layer 704 and to output light towards the display polariser 210, and the display polariser 210 is arranged to receive light output from the out-of-plane polariser 750 and to output linearly polarised light. The view angle control element 102 may be provided for alignment to the pixel layer 214 to provide a switchable display device 100.

The operation of the display device of FIG. 28A in share mode will now be described.

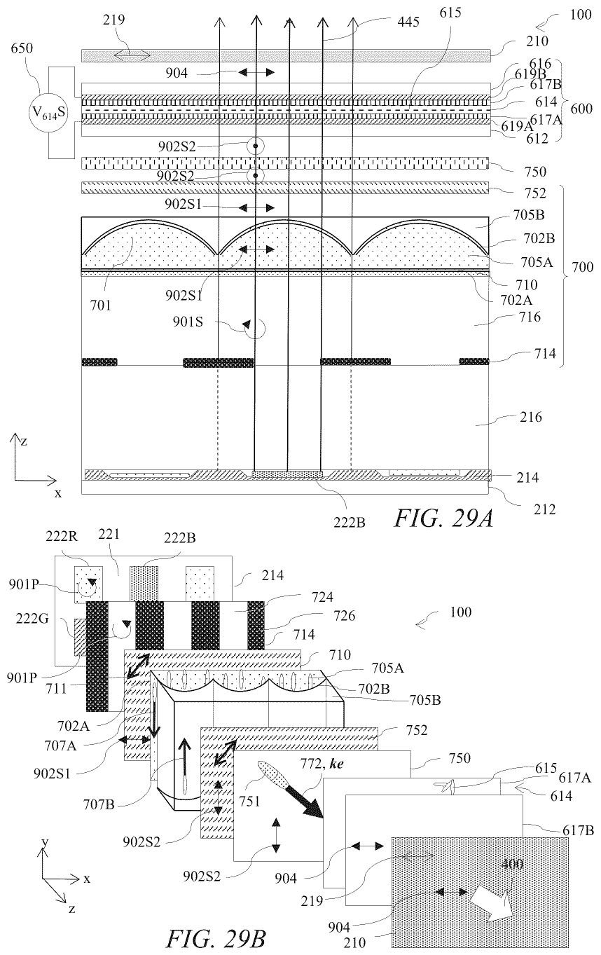

FIG. 29A is a schematic diagram illustrating in top view the switchable privacy display device of FIG. 28A arranged in share mode; and FIG. 29B is a schematic diagram illustrating in front perspective view, alignment of optical layers in the optical stack of FIG. 29A. Features of the embodiments of FIGS. 29A-B not discussed in further detail may be assumed to correspond to the features with equivalent reference numerals as discussed above, including any potential variations in the features.

By way of comparison with FIGS. 28B-C, in the operation mode of FIGS. 29A-B, the polarisation switch layer 601 is arranged to provide output light with polarisation state 904 that is provided by polarisation state 902S2 in the out-of-plane polariser 750 and by polarisation state 902S1 in the birefringent lens 701.

The operation of out-of-plane polariser 750 will now be described.

FIG. 30A is a schematic diagram illustrating in perspective side view operation of an out-of-plane polariser 750, a switchable layer 614 of liquid crystal material 615 and an in-plane polariser 210 for light rays 662a, 662b, 662c inclined in lateral and elevation directions for a privacy mode; and FIG. 30B is a schematic diagram illustrating in perspective side view operation of an out-of-plane polariser 750, a switchable layer 614 of liquid crystal material 615 and an in-plane polariser 210 for light rays 662a, 662b, 662c inclined in lateral and elevation directions for a share mode. Features of the embodiments of FIGS. 30A-B not discussed in further detail may be assumed to correspond to the features with equivalent reference numerals as discussed above, including any potential variations in the features.

The out-of-plane polariser 750 has an absorption axis in a direction having a component kₑ, 772 out of a plane defined by the pixel layer 214 such that the first mode changes the polarisation state 902P of the light passing through the polarisation switch layer 614 and the second mode does not change the polarisation state of the light passing through the polarisation switch layer 614.

FIG. 30A illustrates light ray 662 propagation with polarisation state 902P1 from a birefringent lens array 701 through half-wave retarder 752, a molecule 751 of the out-of-plane polariser 750, polarisation switch layer 601 and display polariser 210. The operation of the birefringent lens array 701 for the polarisation state 902P1 is described further hereinabove.

Light ray 662a from location 660a along the normal 199 is provided with a polarisation rotation by the half-wave retarder 752 to output polarisation state 902P2 onto the molecule 752. The ray 662a is provided along the absorption axis kₑ direction 772 of the molecule 751, and parallel to the transmission axis kₒₐ, 730a, so that low absorption takes place and the light ray 662a is transmitted with high luminous flux through the out-of-plane polariser 750.

The linear polarisation state 902P2 is incident on the input of the polarisation switch 601.

In privacy mode, the polarisation switch 601 is arranged to not change the polarisation state 902P of the light passing therethrough. A first voltage V₆₁₄P is applied to the layer 614 of liquid crystal material 615 so that the linear polarisation state 902P2 is not modified through the layer 614 to provide output polarisation state 904 that is the same as the polarisation state 902P.

In-plane polariser 210 comprises molecules 613 with absorption axis jₑ, 622 such that the polariser 210 has electric vector transmission direction 219 arranged to transmit linear polarisation state 904. Light ray 662a with high luminous flux is transmitted by the in-plane polariser 210 with electric vector transmission direction 219.

Light ray 662b from location 660b is incident on the molecule 751 with polarisation state 902P2 aligned orthogonally to the absorption axis kₑ direction 772 so that substantially no absorption takes place by the molecules 751 of the out-of-plane polariser 750 and the light ray 662b is transmitted by the layer 614 of liquid crystal material 615, polarisation switch 601 and in-plane polariser 210 with high luminous flux.

By comparison with light rays 662a, 662b, for light ray 662c from location 660c the polarisation state 902P2 has a component along the ray 662c that is aligned with the absorption axis kₑ direction 772 of the molecule 751. Such alignment provides some absorption at the molecule 751 so that the output ray 662c from the out-of-plane polariser 750 has reduced luminous flux. The amount of absorption is determined by the thickness, d, refractive indices nₑ, nₒ and absorption coefficients αₑ(ϕ,θ) αₒ(ϕ,θ) of the out-of-plane polariser 750 for polar angle (ϕ, θ), at the angle of incidence of the ray 662c for the polarisation state 902P2.

Thus, the light rays 662a, 662b have a transmission that is greater than the transmission of the light ray 662c. Further the light rays 662a-c are modified by the birefringent lens 701.

By way of comparison with FIG. 30A, in share mode as illustrated in FIG. 30B, the polarisation switch 601 is arranged to change the polarisation state of the light passing therethrough.

FIG. 30B illustrates light ray 662a propagation with polarisation state 640 through the birefringent lens array 701a-n.

As in privacy mode, light ray 662a from location 660a along the normal 199 propagates along the absorption axis kₑ direction 772 of the molecule 751, and parallel to the transmission axis kₒₐ, 730a, so that substantially no absorption takes place and the light ray 662a is transmitted with high luminous flux through the out-of-plane polariser 750.

In share mode, the polarisation switch 601 is arranged to modify the polarisation state 902S2 to polarisation state 904 of the incident light that passes therethrough. A second voltage V₆₁₄S is applied to the layer 614 of liquid crystal material 615 so that the linear polarisation state 902S2 is modified through the layer 614. Light ray 662a is transmitted by the in-plane polariser 210 with high transmission and with the optical properties of the lens array 701a-n in share mode.

By comparison with FIG. 30A, light ray 662b from location 660b is incident on the molecule 751 with polarisation state 902S2 with a component aligned to the absorption axis kₑ direction 730b so that some absorption takes place by the molecules 751 of the out-of-plane polariser 750. The light ray 662b is transmitted by the layer 614 of liquid crystal material 615, polarisation switch 210 and in-plane polariser 210 with high luminous flux.

For the light ray 662c from location 660c the polarisation state 902S2 has no component along the ray 662c that is aligned with the absorption axis kₑ direction 772 of the molecule 751 so that the output ray 663c from the out-of-plane polariser 750 has higher transmission than for the ray 662b.

The operation of an arrangement with an illustrative polarisation switch 601 will now be further described.

FIG. 30C is a schematic diagram illustrating in side view an out-of-plane polariser 750, a twisted nematic liquid crystal polarisation switch 601 and an in-plane polariser 210 in a privacy mode for an on-axis ray 663a; FIG. 30D is a schematic diagram illustrating the arrangement of FIG. 30C in edge view; FIG. 30E is a schematic diagram illustrating in side view an out-of-plane polariser 750, a twisted nematic liquid crystal polarisation switch 601 and an in-plane polariser 210 in a share mode for an on-axis ray 663a; and FIG. 30F is a schematic diagram illustrating the arrangement of FIG. 30E in edge view. Features of the embodiments of FIGS. 30C-F not discussed in further detail may be assumed to correspond to the features with equivalent reference numerals as discussed above, including any potential variations in the features.

By way of comparison with FIG. 30A, FIGS. 30C-D illustrate that the polarisation switch 601 comprises a layer 614 of twisted nematic liquid crystal material 615 provided by alignment layers 617A, 617B and the privacy voltage Vp may be zero volts for example to provide polarisation modification through the layer 614.

By way of comparison with FIG. 30B, FIGS. 30E-F illustrate that the polarisation switch 601 comprises a layer 614 of twisted nematic liquid crystal material 615 provided by alignment layers 617A, 617B and the share voltage Vs may be 5V for example to provide substantially no polarisation modification through the layer 614. In alternative embodiments as described elsewhere herein, the layer 614 of liquid crystal material 615 may be provided by a switchable half-wave retarder.

Illustrative profiles of output will now be further described.

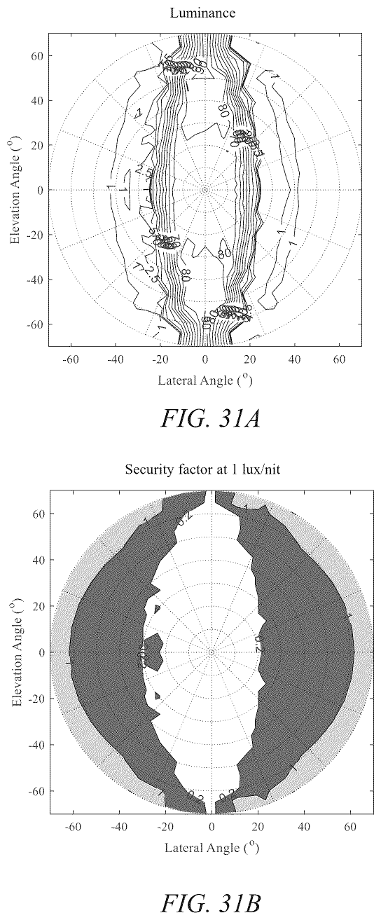

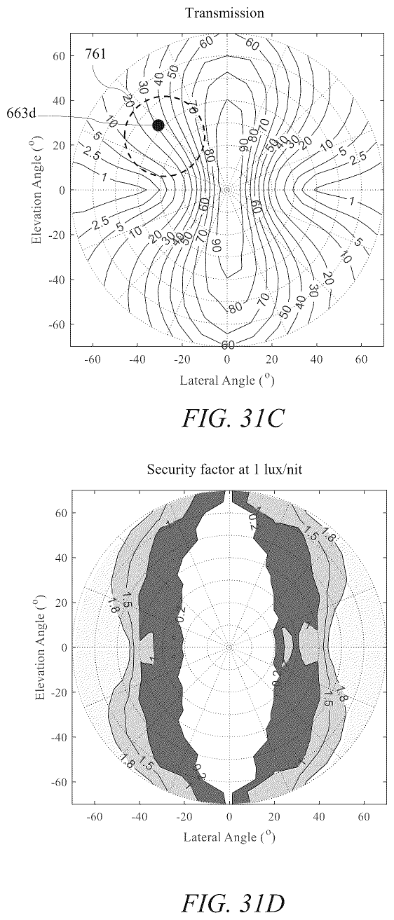

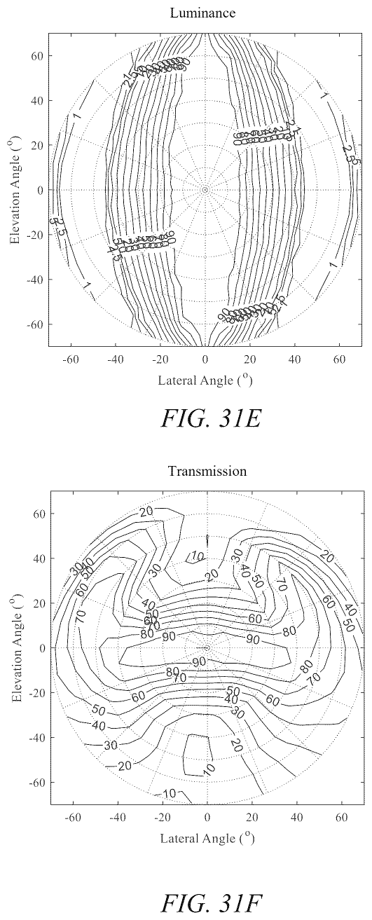

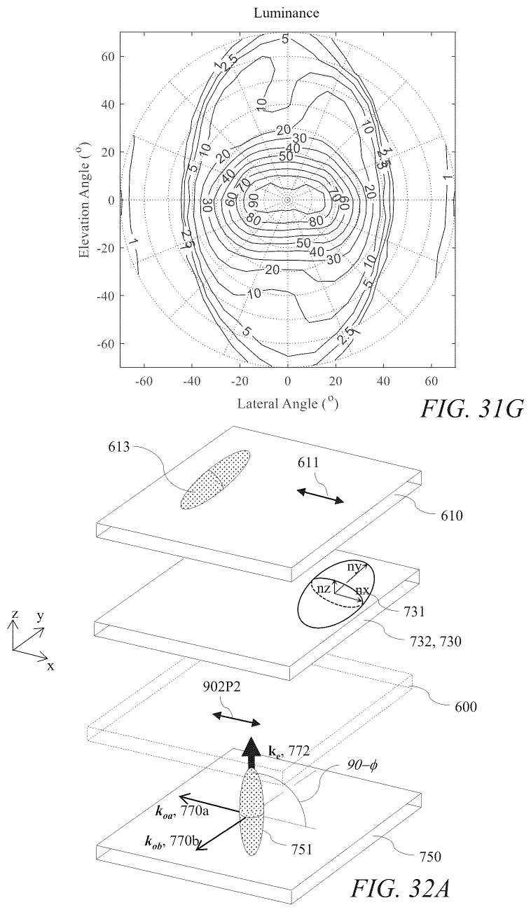

FIG. 31A is a schematic graph illustrating an alternative polar variation of luminance output for a birefringent lens array 701a-n and parallax barrier layer 714 in privacy mode; FIG. 31B is a schematic graph illustrating an alternative polar variation of security factor for the luminance profile of FIG. 31A; FIG. 31C is a schematic graph illustrating a polar variation of transmission for an out-of-plane polariser and in-plane polariser in privacy mode; and FIG. 31D is a schematic graph illustrating an alternative polar variation of security factor for the luminance profile of FIG. 31A and the transmission profile of FIG. 31C. Features of the embodiment of FIGS. 31A-D not discussed in further detail may be assumed to correspond to the features with equivalent reference numerals as discussed above, including any potential variations in the features.

By way of comparison with FIG. 7A, the alternative embodiment of FIG. 31A illustrates the simulated output profile in privacy mode for a parallax barrier 701 comprising apertures that are 25% of the width of the pixel pitch, that is considering TABLE 1 the width of the apertures 724 is 20 μm. FIG. 31B illustrates the output security factor without the out-of-plane polariser of FIG. 28A;

FIG. 31C illustrates an illustrative transmission profile of an out-of-plane polariser 750 for the polarisation state 902P2 and FIG. 31D illustrates an illustrative security factor. S profile for the embodiment of FIG. 28A. Advantageously security factor is improved near to the optical axis. Further by way of comparison with FIG. 1 and FIG. 8, a desirable profile is achieved using a single switch layer 614, that is the additional polariser 318 and polar control retarder 300 are omitted. Advantageously desirable performance may be achieved and thickness, cost and complexity reduced.

FIG. 31C illustrates that in region 761 comprising a viewing direction 663d in a quadrant, undesirable increased transmission is provided. Biaxial retarder arrangement 730 as described hereinbelow may achieve reduced transmission and increased security factor in region 761.

FIG. 31E is a schematic graph illustrating an alternative polar variation of luminance output for a birefringent lens array 701a-n and parallax barrier layer 714 of the same arrangement as FIG. 31A in share mode; FIG. 31F is a schematic graph illustrating a polar variation of transmission for an out-of-plane polariser and in-plane polariser in share mode; and FIG. 31G is a schematic graph illustrating a polar variation of luminance for a privacy display device of the type of FIG. 28A in share mode. Features of the embodiments of FIGS. 31E-G not discussed in further detail may be assumed to correspond to the features with equivalent reference numerals as discussed above, including any potential variations in the features.

Such a display has desirably high image visibility for over a wide polar region.

It may be desirable to further reduce display device 100 luminance in the quadrant regions 761 in privacy mode.

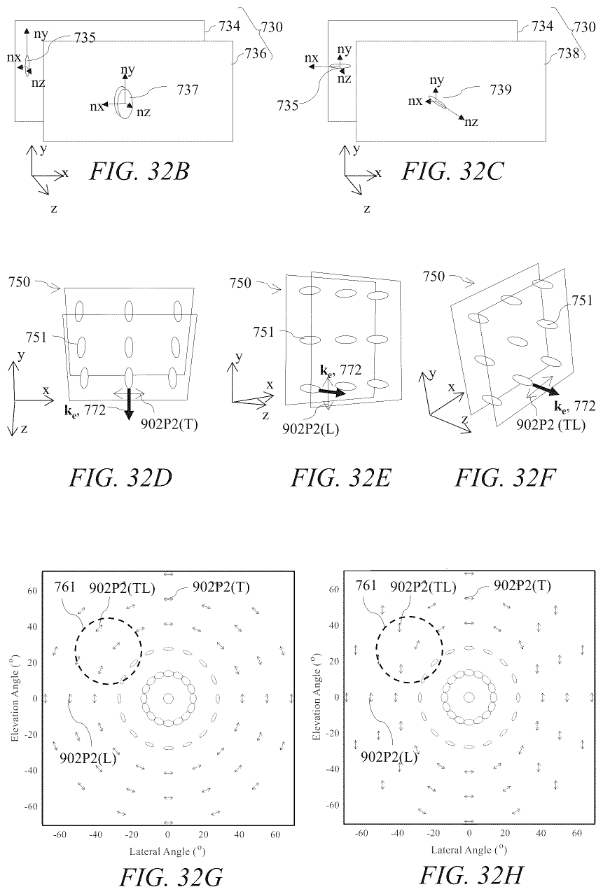

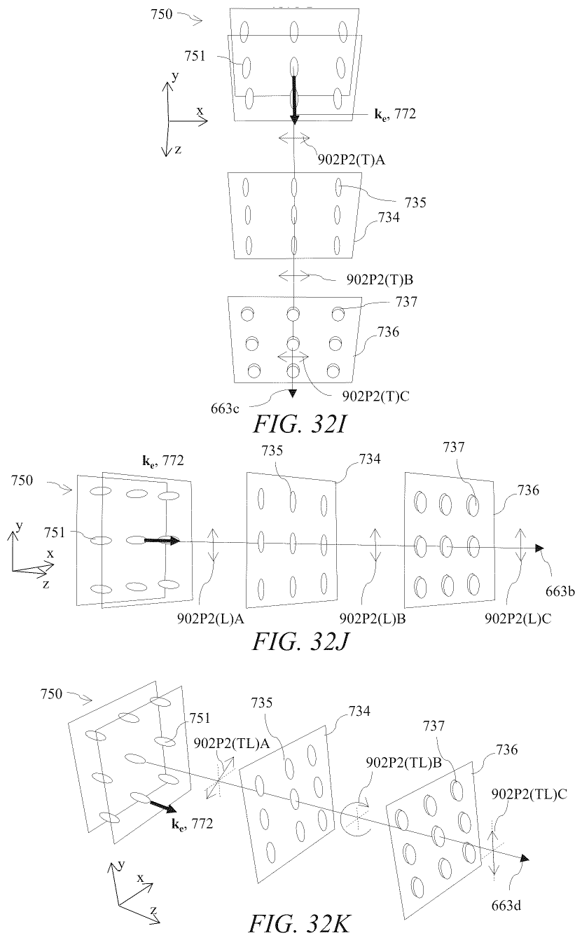

FIG. 32A is a schematic diagram illustrating in perspective side view a polarisation switch 600 arranged between an in-plane polariser that is in-plane polariser 610, a biaxial retarder arrangement 730 comprising biaxial material 731 and an out-of-plane polariser 750. Features of the embodiment of FIG. 32A not discussed in further detail may be assumed to correspond to the features with equivalent reference numerals as discussed above, including any potential variations in the features.

The biaxial retarder arrangement 730 of FIG. 32A comprises biaxial molecules 731 that provide off-axis retardation properties for input polarisation state 902P2.

Biaxial retarder compensation is described further in U.S. patent application Ser. No. 18/792,135 (Atty. Ref. No. 501001 filed Aug. 1, 2024) and U.S. Provisional Patent Appl. No. 63/678,377 (Atty. Ref. No. 507000 filed Aug. 1, 2024), both of which are herein incorporated by reference in their entireties.

Alternative embodiments of biaxial retarder arrangement 730 will now be described.

FIG. 32B is a schematic diagram illustrating in perspective front view an alternative biaxial retarder arrangement 730 comprising an A-plate and a negative C-plate; and FIG. 32C is a schematic diagram illustrating in perspective front view an alternative biaxial retarder arrangement comprising an A-plate and a positive C-plate. Features of the embodiments of FIGS. 32B-C not discussed in further detail may be assumed to correspond to the features with equivalent reference numerals as discussed above, including any potential variations in the features.

By way of comparison with FIG. 32A, in the alternative embodiment of FIG. 32B, the biaxial retarder arrangement 730 comprises a negative C-plate 736 comprising birefringent material 737 arranged to receive the light from a quarter-wave A-plate 734 comprising birefringent material 735 with optical axis direction aligned to the vertical direction or y-axis; that is the extraordinary index ne is the same as the index ny. Negative C-plates may be more conveniently manufactured at low cost than positive C-plates.

By way of comparison with FIG. 32B, in the alternative embodiment of FIG. 32C, the biaxial retarder arrangement 730 comprises a positive C-plate 738 comprising birefringent material 739 arranged to receive the light from a quarter-wave A-plate 734 comprising birefringent material 735 with optical axis direction aligned to the horizontal direction or x-axis; that is the extraordinary index ne is the same as the index ny. Positive C-plate 738 may be provided by a coating manufacturing method, achieving reduced thickness.

The complexity of manufacture of the A-plate 735 and C-plates 736, 738 may be reduced compared to the B-plate 732 of FIG. 32A, advantageously achieving reduced cost.

The operation of the biaxial retarder arrangement 730 will now be described further.

FIG. 32D is a schematic diagram illustrating in perspective top view an out-of-plane polariser; FIG. 32E is a schematic diagram illustrating in perspective left side view an out-of-plane polariser; and FIG. 32F is a schematic diagram illustrating in perspective upper left quadrant view an out-of-plane polariser. Features of the embodiments of FIGS. 32D-F not discussed in further detail may be assumed to correspond to the features with equivalent reference numerals as discussed above, including any potential variations in the features.

In operation, the out-of-plane polariser 750 with absorption axis kₑ 772 provides absorption of the incident unpolarised transmitted polarisation state without output polarisation state 902P2 that varies with viewing direction 663, such as polarisation states 902P2(T) for the top look-down direction 663c, 902P2(L) for the left side viewing direction 663b and 902P2(TL) for the left side top quadrant viewing direction 663d.

FIG. 32G is a schematic graph illustrating a polar variation of output polarisation state 902P2 from an out-of-plane polariser 750 without a biaxial retarder arrangement 730; and FIG. 32H is a schematic graph illustrating a polar variation of output polarisation state 902P2 from an out-of-plane polariser 750 arranged with a desirable biaxial retarder arrangement 730, for example as illustrated in FIG. 32A. Features of the embodiments of FIGS. 32G-H not discussed in further detail may be assumed to correspond to the features with equivalent reference numerals as discussed above, including any potential variations in the features.

FIG. 32G illustrates that in the region 761, the polarisation state 902P2(TL) is rotated with respect to the polarisation state 902P2(L), providing the undesirable increased transmission of FIG. 7B.

It would be desirable to reduce the transmission in the region 761 by modifying the polarisation state 902P2(TL) and substantially not modifying the polarisation states 902P2(L) and 902P2(T) such as is illustrated in FIG. 32H.

FIG. 32I is a schematic diagram illustrating in perspective top view propagation of a polarisation state 902 through an out-of-plane polariser 750 and a biaxial retarder arrangement 730; FIG. 32J is a schematic diagram illustrating in perspective left side view propagation of a polarisation state 902 through an out-of-plane polariser 750 and a biaxial retarder arrangement 730; and FIG. 32K is a schematic diagram illustrating in perspective upper left quadrant view propagation of a polarisation state 902 through an out-of-plane polariser 750 and a biaxial retarder arrangement 730. Features of the embodiments of FIGS. 321-K not discussed in further detail may be assumed to correspond to the features with equivalent reference numerals as discussed above, including any potential variations in the features.

FIGS. 32A-C illustrate that the biaxial retarder 732 may be formed as, or may be considered as, a C-plate arranged to receive the light from an A-plate. Principal axes nx, ny, nz components of the A-plate and C-plate are aligned with the orthogonal x, y and z system axes and preserve polarization in the lateral viewing direction (for zero elevation angle) and elevation viewing directions (for zero lateral angle) so that no modification of polarisation states 902P2(T) and 902P2(L) is achieved, as illustrated in FIGS. 321-K for the directions 663c, 663b respectively where the polarisation states 902P2(T) A, 902P2(T) B and 902P2(T) C are the same and the polarisation states 902P2(L) A, 902P2(L) B and 902P2(L) C are the same.

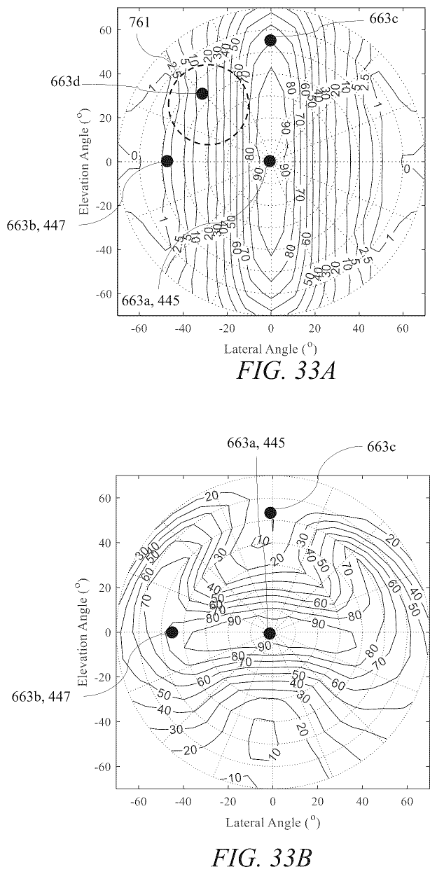

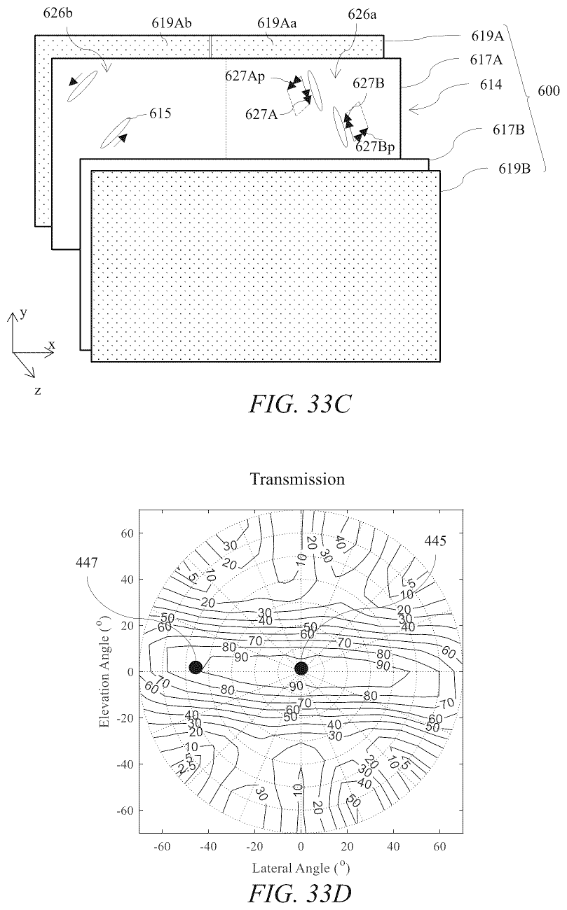

By comparison, in the viewing quadrant direction 663d as illustrated in FIG. 32I, the biaxial retarder 730 may be provided to provide rotation of polarisation state 902P2A at a desirable angle, such as illustrated by direction 663d in FIG. 33A hereinbelow. The A-plate 734 may comprise a quarter waveplate in the direction 663d and the C-plate 736 may further comprise a quarter waveplate in the same direction 663d and with the opposite retardance. Such embodiments of biaxial retarder arrangement may achieve the desirable polarisation state 639 profiles of FIG. 32H.

FIG. 33A is a schematic graph illustrating a polar variation of transmission for the arrangement of FIG. 32A comprising the arrangement of TABLE 5A and TABLE 6 for operation in privacy mode and FIG. 33B is a schematic graph illustrating a polar variation of transmission for the arrangement of FIG. 32A, TABLE 5A and TABLE 6 in share mode. Features of the embodiments of FIGS. 33A-B not discussed in further detail may be assumed to correspond to the features with equivalent reference numerals as discussed above, including any potential variations in the features.

By way of comparison with FIG. 31C, the alternative embodiment of FIG. 33A illustrates that transmission is reduced in the quadrant regions such as regions 761 of FIG. 33A by means of the biaxial retarder arrangement 730. Advantageously the size of the region for which security factor, S>1 may be increased.

TABLE 5A illustrates a biaxial retarder arrangement 730 comprising a B-plate arranged between an out-of-plane polariser 602 and an in-plane polariser 610.

TABLE 5A

| Item | Property | Value (Range) |
|---|---|---|
| Out-of-plane | Material 751 ordinary refractive index, \vec{nₒ} | 1.506 + 0.00165i |
| polariser 750 | Material 751 extraordinary refractive index, \vec{nₑ} | 1.53 + 0.116i |
| | Thickness, d | 5 μm |
| | Absorption axis 622 tilt ϕ to surface normal 199 | 0° |
| Polarisation switch 601 | Polarisation rotation | 0° |
| privacy mode | | |
| Biaxial retarder | Refractive index profile | ny > nx > nz |
| arrangement 730 | (nx − ny)d | −150 nm |
| with refractive | | (−130 nm to −170 nm) |
| indices nx, ny, | (nx − nz)d | +300 nm |
| nz and thickness d | | (+270 nm to +330 nm) |
| | Rth | +370 nm |
| | | (+340 nm to +400 nm) |
| | nx alignment | 0° in plane |
| | ny alignment | 90° in plane |
| | nz alignment | 90° out of plane |
| In-plane polariser 610 | Absorption axis 620 in-plane angle | 0° |

In other words, the biaxial retarder arrangement 730 may comprise a B-plate 732. The B-plate 732 may comprise material 731 with principal components of refractive index nx, ny, nz and a thickness d, and wherein for light at a wavelength of 550 nm: the value of (nx−ny) d is in a range between-130 nm and −170 nm, the value of (nx−nz) d is in a range between +270 nm and +330 nm, and the value of a parameter Rth is in a range between +340 nm and +400 nm, wherein

$$Rth = ( ( nx + ny ) / 2 - nz ) d .$$

A low thickness component may be provided that may be formed with low cost, for example by double stretching.

Alternative biaxial retarder arrangements 730 will now be further described. In an alternative arrangement of B-plate, a negative Rth may be provided, and the B-plate is rotated by 90 degrees so that the values of nx and ny are reversed compared to the embodiment of TABLE 4. The embodiment of TABLE 5A is more conveniently provided by double stretching, in comparison to said alternative arrangement.

TABLE 5B provides illustrative arrangements for the embodiment of FIG. 32B to achieve the equivalent transmission profile of FIG. 33A.

TABLE 5B

| Item | | Property | Value (Range) |
|---|---|---|---|
| Biaxial | A-plate 734 | (ne − no)d | +100 nm |
| retarder | | | (+85 nm to +115 nm) |
| arrangement | | ne alignment | 90° in plane |
| 730 | Negative | (ne − no)d | −220 nm |
| | C-plate 737 | | (−190 nm to −250 nm) |
| | | ne alignment | 90° out of plane |

The biaxial retarder arrangement 730 may comprise a C-plate 736 arranged to receive the light output from an A-plate 734. For light at a wavelength of 550 nm, the A-plate 734 has a retardance in a range between +85 nm and +115 nm, and the C-plate 736 is a negative C-plate with a retardance in a range between −190 nm and −250 nm. The complexity of manufacture of the retarders 734, 736 may be reduced, achieving reduced cost.

TABLE 5C provides illustrative arrangements for the embodiment of FIG. 32C to achieve the equivalent transmission profile of FIG. 33A.

TABLE 5C

| Item | | Property | Value (Range) |
|---|---|---|---|
| Biaxial | A-plate 734 | (ne − no)d | +100 nm |
| retarder | | | (+85 nm to +115 nm) |
| arrangement | | ne alignment | 0° in plane |
| 730 | Positive | (ne − no)d | +250 nm |
| | C-plate 738 | | (+220 nm to +280 nm) |
| | | ne alignment | 90° out of plane |

For light at a wavelength of 550 nm the A-plate 734 has a retardance in a range between +85 nm and +115 nm, and the positive C-plate 738 has a retardance in a range between +220 nm and +280 nm. The thickness of the positive C-plate 738 may be reduced compared to the thickness of the negative C-plate 736, for example by providing cured reactive mesogen layers on the A-plate 734.

It will be appreciated that the combination of values provided in TABLES 5A-C represent particularly beneficial or advantageous embodiments because in privacy mode the luminance in the viewing quadrants such as region 761 of the display device 100 may be reduced as shown in FIG. 33A in comparison to alternative combinations of values and advantageously image security improved.

In operation, the angular variation of output polarisation state of the out-of-plane polariser 750 of FIG. 32G may be modified by means of the biaxial retarder arrangement 730 with said combination of values to achieve the angular variation of output polarisation state of FIG. 32H, which provides said reduction of luminance in region 761.

An illustrative embodiment for the liquid crystal polarisation switch layer 614 driven by driver 650 is given in TABLE 6 for a third minimum cell design to advantageously achieve low chromatic variation of polarisation state switching.

TABLE 6

| | LC polarisation switch layer 614 | | | | | | |
|---|---|---|---|---|---|---|---|
| | Alignment layers | Alignment | Pretilt/ | Δn.d/ | | | |
| Mode | 617A, 617B | direction | deg | nm | Twist | Δε | Voltage/V |
| Share | Homogeneous | 90° | 2 | 168 | 90° | +13.2 | V₆₁₄S: 5.0 |
| Privacy | Homogeneous | 180° | 2 | | | | V₆₁₄P: 0 |

Alternatively second or first minimum cell designs with lower Δn·d values can be chosen to achieve reduced switching time between privacy and share modes. Alternatively, the liquid crystal polarisation switch layer 614 can be made thicker still with the cell operating well in to the Mauguin limit.

An alternative polarisation switch 600 will now be described.

FIG. 33C is a schematic diagram illustrating in perspective front view a polarisation switch 600 comprising a vertically aligned polarisation switch layer 614 with privacy and share mode regions 626a, 626b; and FIG. 33D is a schematic graph illustrating a polar variation of transmission for the polarisation switch of FIG. 33C and TABLE 7 in the share region, and the out-of-plane polariser and the biaxial retarder of TABLE 5A. Features of the embodiments of FIGS. 33C-D not discussed in further detail may be assumed to correspond to the features with equivalent reference numerals as discussed above, including any potential variations in the features.

The polarisation switch 600 may provide a switchable half wave plate to provide polarisation state 902 rotation to output polarisation state 904. The regions 626a, 626b may be provided by patterning of the electrode 619a or alternatively by patterning of electrode 619b.

TABLE 7

| | LC polarisation switch layer 614 | | | | | | |
|---|---|---|---|---|---|---|---|
| | Alignment layers | Alignment | Pretilt/ | Δn.d/ | | | |
| Mode | 617A, 617B | direction | deg | nm | Twist | Δε | Voltage/V |
| Share | Homeotropic | 45° | 88 | 312 | 0° | +10.3 | V₆₁₄S: 7.0 |
| Privacy | Homeotropic | 225° | 88 | | | | V₆₁₄P: 0 |

Patterning of share and privacy mode regions is provided by a gap between electrodes 619Aa and 619Ab. The profile of transmission in privacy mode is substantially the same as for FIG. 33A. By way of comparison with FIG. 33B, FIG. 33D illustrates that improved transmission may be achieved in the lateral direction. Additional retarders (not shown) such as half wave A-plates and half wave C-plates may be provided to achieve improved chromaticity of rotation, advantageously achieving reduced colour change between share and privacy mode such as through Pancharatnam retarder arrangements.

It may be desirable to reduce the complexity of the display device 100.

Various alternative structures of display device 100 will now be described.

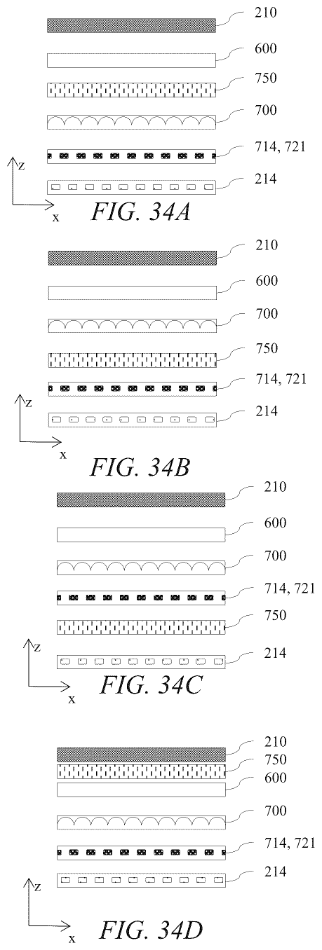

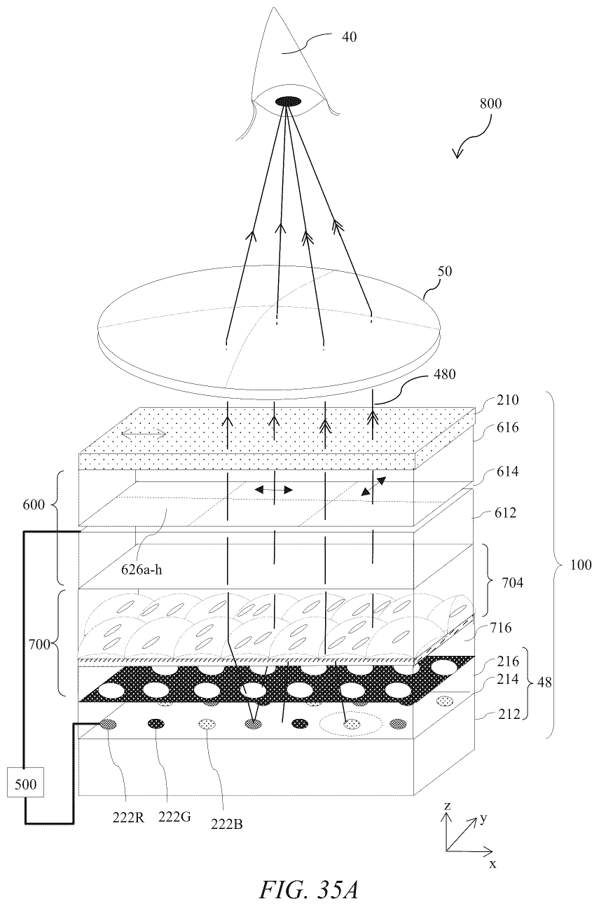

FIGS. 34A-D are schematic diagrams illustrating in top view various alternative structures of display device 100 optical stacks. Features of the embodiments of FIGS. 34A-D not discussed in further detail may be assumed to correspond to the features with equivalent reference numerals as discussed above, including any potential variations in the features.

FIGS. 34A-D are illustrative optical stacks omitting various retarders. Advantageously increased security factor may be achieved in non-viewing directions in privacy mode.

FIG. 34A illustrates the embodiment of FIG. 28A-C. By way of comparison with FIG. 33A, in the alternative embodiments of FIG. 34B and FIG. 34C, the out-of-plane polariser 750 is arranged between the lens layer 704 and the pixel layer 214. The pixel layer 214 is arranged to output light towards the out-of-plane polariser 750. The out-of-plane polariser 750 is arranged to receive light output from the pixel layer 214 and to output light towards the lens layer 704. The polarisation switch 600 is arranged to receive light output from the out-of-plane polariser 750 and to output light towards the display polariser 210, and the display polariser 210 is arranged to receive light output from the lens layer 704 and to output linearly polarised light. Advantageously the thickness of the display device 100 may be reduced.

The display device 100 may further comprise a colour filter layer 721 comprising a plurality of first colour filters arranged in a first colour filter array 722a-n, wherein each of the plurality of pixels 222 is aligned with a respective first colour filter 722 of the plurality of first colour filters 722, wherein the first colour filter layer 721 is arranged between the lens layer 704 and the pixel layer 214. The first colour filter layer 721 is arranged to prevent at least some of the light from each of the plurality of pixels 222 from reaching lenses 701 which are not aligned with that pixel 222, and wherein the each of the plurality of lenses 701 is arranged to reflect at least some of the light received from pixels 222 which are not aligned with that lens 701.

The alternative embodiment of FIG. 34D illustrates that the out-of-plane polariser 750 is arranged between the polarisation switch 600 and the display polariser 210. The profile of luminance reduction provided by the out-of-plane polariser 750 and display polariser 210 is fixed independent of the state of operation of the polarisation switch 600. Such an arrangement may be provided in addition to the structures of FIGS. 34A-C. Advantageously further reduction of off-axis luminance may be achieved and security factor increased.

Advantageously reduced luminance may be provided in non-viewing directions 447. The various embodiments comprising out-of-plane polarisers described hereinabove are not limiting and may be provided with the optical stacks described elsewhere herein to advantageously achieve increased security factor. S in privacy mode.

A near-eye display apparatus will now be described.

FIG. 35A is a schematic diagram illustrating in side perspective view a near-eye display apparatus 800 comprising the display device 100 of the type of FIG. 23A, a pixellated polarisation switch layer 614 and an eyepiece lens; FIG. 35B is a schematic diagram illustrating in side view the operation of the near-eye display apparatus 800 of FIG. 35A; FIG. 35C is a schematic diagram illustrating in side view the operation of the near-eye display apparatus 800 of FIG. 35A arranged to provide increased dynamic range; and FIG. 35D is a schematic diagram illustrating in side view the operation of a near-eye display device 800 arranged to provide increased image contrast. Features of the embodiments of FIGS. 35A-D not discussed in further detail may be assumed to correspond to the features with equivalent reference numerals as discussed above, including any potential variations in the features.

FIG. 35A illustrates a near-eye display apparatus 800 comprising the display device 100 of any of the embodiments herein. The display device 100 comprises pixels 222R. 22G, 222B with a circular shape, although other pixel shapes may be provided. Output light 480 is directed onto an eyepiece 50 that is a refractive lens or alternatively may comprise optical components that are reflective, diffractive or may be catadioptric such as a pancake lens. The eyepiece 50 collects the light and directs towards the eye 40 of an observer located near the eyepiece 50, such as within 25 mm. By way of comparison the direct view displays 100 described hereinabove have a typical viewing distance of between 250 mm and 1000 mm for example.

The polarisation switch layer 614 is segmented and is driven in correspondence with the pixel data supplied by controller 500 to the pixel plane 214.

FIG. 35B illustrates the formation of a virtual image 32 by the eyepiece 50 imaging of the display device 100. The pupil 44 of the eye 40 receives light that is provided with directions in correspondence with pixel position across the SLM 48 of the display device 100.

FIG. 35C illustrates further the operation of the near-eye display apparatus 800. The near-eye display apparatus 800 is arranged to provide pixel data to both the pixel layer 214 and the polarisation switch layer 614, thereby providing increased dynamic range. Pixels 222Aa-d represent a first group of pixels 222 arranged in alignment with a region 626A of the polarisation switch layer 614 that is set to provide a narrow range of output angles in a similar manner to that illustrated in FIG. 2A hereinabove. Light is directed into optical window 26A that has a similar size to the entrance pupil of the eyepiece 50. Advantageously light from pixels 222Aa-d is directed towards the eye with high brightness and high efficiency.

Pixels 222Ba-d represent a second group of pixels 222 arranged in alignment with a region 626B of the polarisation switch layer 614 that is set to provide a wider range of output angles in a similar manner to that illustrated in FIG. 3A hereinabove. Light is directed into optical window 26B that is larger than the size of the entrance pupil of the eyepiece 50. Light from pixels 222Aa-d is directed towards the eye with lower efficiency. The regions 626a-h are modified in correspondence with the image data required for the underlying pixels 222a-n and thus provide increased dynamic range.

In an illustrative embodiment, the pixels 222a-n cover 10% of the area of the pixel layer 214. The light from the pixels 222Ba-d that is directed through the eyepiece 50 is 10% of the light that is directed through the eyepiece 50 from the pixels 222Aa-d. The image from pixels 222A appears to have a luminance that is ten times greater than from pixels 222B. In operation, the region 626A is used to provide image highlights, such as bright scene objects while the region 626B is used to provide dark images, achieving increased bit depth resolution. Advantageously image brightness is increased and image realism may be enhanced.

In the alternative embodiment of FIG. 35D, the polarisation switch layer 614 is omitted, such as in the display device 100 of FIG. 13D. Optical window 26 is arranged to efficiently direct light into the entrance aperture of the lens 50 with increased brightness compared to the average brightness provided across the area of the pixels 222 and gaps 211 of the SLM 48. Light output such as rays 447 that are incident onto a head-mounting arrangement 812 are reflected as stray light 451. Such stray light 451 may return to the display device 100 and be reflected back towards the eyepiece 50. Advantageously the stray light 451 has lower luminance than arrangements of SLM 48 that do not comprise the parallax component 700. Image contrast directed to the pupil 44 of the eye is advantageously improved.

FIG. 36 is a schematic diagram illustrating in rear view a head-mounted display device 100. Features of the embodiment of FIG. 36 not discussed in further detail may be assumed to correspond to the features with equivalent reference numerals as discussed above, including any potential variations in the features.

FIG. 36 illustrates a head-worn display apparatus 810 comprising: left eye near-eye display apparatus 800L comprising display device 100L and eyepiece 50L, right eye near-eye display apparatus 800R comprising display device 100R and eyepiece 50R; and a head-mounting arrangement 812 for mounting the head-worn display apparatus 810 on a head of a wearer 845 such that the near-eye display apparatus 800 extends across the eyes 40L, 40R of the wearer 845. Advantageously a virtual reality display may be provided. In other embodiments, the display device may be provided for a single eye, that is a monocular viewer. Advantageously cost is reduced.

As may be used herein, the terms “substantially” and “approximately” provide an industry-accepted tolerance for its corresponding term and/or relativity between items. Such an industry-accepted tolerance ranges from zero percent to ten percent and corresponds to, but is not limited to, component values, angles, et cetera. Such relativity between items ranges between approximately zero percent to ten percent.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the embodiment(s) set out in any claims that may issue from this disclosure. Specifically and by way of example, although the headings refer to a “Technical Field,” the claims should not be limited by the language chosen under this heading to describe the so-called field. Further, a description of a technology in the “Background” is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

1. A display device comprising:
a pixel layer comprising a plurality of pixels arranged in a pixel array;
a parallax barrier layer comprising a plurality of apertures arranged in an aperture array, wherein each of the plurality of pixels is aligned with a respective aperture of the plurality of apertures;
a lens layer comprising a plurality of lenses arranged in a lens array, wherein each of the plurality of pixels is aligned with a respective lens of the plurality of lenses, and wherein the plurality of lenses comprises one or more birefringent lenses; and
a display polariser which is a linear polariser,
wherein the parallax barrier layer is arranged between the lens layer and the pixel layer,
wherein the lens layer is arranged between the pixel layer and the display polariser,
wherein the pixel layer is arranged to output light towards the parallax barrier layer, the parallax barrier layer is arranged to receive light output from the pixel layer and to output light towards the lens layer, the lens layer is arranged to receive light output from the parallax barrier layer and to output light towards the display polariser, and the display polariser is arranged to receive light output from the lens layer and to output linearly polarised light, and
wherein the parallax barrier layer is arranged to prevent at least some of the light from each of the plurality of pixels from reaching lenses which are not aligned with that pixel, and wherein the each of the plurality of lenses is arranged to reflect at least some of the light received from pixels which are not aligned with that lens.

2. A display device according to claim 1, wherein at least 50%, preferably at least 65% and more preferably at least 75% of the light output by each of the plurality of lenses of the lens layer is from the pixel with which that lens is aligned.

3. A display device according to claim 1, wherein the lens layer is arranged to reflect at least some of the light that it receives by total internal reflection at a lens surface.

4. A display device according to claim 1, further comprising at least one planar surface, wherein the at least one planar surface is arranged to receive light output from the lens layer and to reflect at least some of the light that it receives by total internal reflection.

5. A display device according to claim 1, wherein the parallax barrier layer comprises light blocking regions arranged between the plurality of apertures.

6. A display device according to claim 1, wherein the aperture array and the lens array are one dimensional arrays which extend in a common one dimensional direction.

7. A display device according to claim 1, wherein the aperture array and the lens array are two dimensional arrays which extend in common two dimensional directions.

8. A display device according to claim 1, wherein the pitch of the apertures in the parallax barrier layer and the pitch of the lenses in the lens layer are arranged relative to the pitch of the pixels in the pixel layer so as to direct light from each pixel of the plurality of pixels into a common viewing window.

9. A display device according to claim 1, further comprising a reflection control polarisation conversion retarder, the reflection control polarisation conversion retarder being arranged in at least one mode to convert a polarisation state of light passing therethrough between a linear polarisation state and a circular polarisation state.

10. A display device according to claim 9, wherein the reflection control polarisation conversion retarder is a quarter-wave retarder.

11. A display device according to claim 9, wherein the reflection control polarisation conversion retarder is arranged between the lens layer and the pixel layer.

12. A display device according to claim 1, further comprising a polarisation switch layer arranged between the lens layer and the display polariser, the polarisation switch layer being arranged to convert a polarisation state of light passing therethrough between a first polarisation state and a second polarisation state orthogonal to the first polarisation state.

13. A display device according to claim 12, wherein the polarisation switch layer comprises a switchable liquid crystal layer.

14. A display device according to claim 13, further comprising transmissive electrodes and liquid crystal surface alignment layers formed on each side of the switchable liquid crystal layer.

15. A display device according to claim 14, further comprising a control system arranged to control a voltage applied across the transmissive electrodes.

16. A display device according to claim 12, wherein at least one of the transmissive electrodes is provided with multiple addressable regions.

17. A display device according to claim 1, further comprising a first transparent layer arranged between the pixel layer and the parallax barrier layer.

18. A display device according to claim 17, wherein the first transparent layer comprises a thin film encapsulation layer arranged to provide a barrier to water and oxygen.

19. A display device according to claim 17, further comprising a second transparent layer arranged between the parallax barrier layer and the lens layer.

20. A display device according to claim 19, wherein the second transparent layer comprises an encapsulation layer arranged to provide a barrier to water and oxygen.

21. A display device according to claim 19, wherein the thickness of the first and second transparent layers is the same.

22. A display device according to claim 1, wherein in at least one direction across the pixel layer, a width of each of the plurality of apertures is equal to or less than a pitch of the pixel array in the at least one direction.

23. A display device according to claim 22, wherein the width of each of the plurality of apertures in the at least one direction is at least half of the pitch of the pixel array in the at least one direction.

24. A display device according to claim 22, wherein the pixel layer comprises different colour pixels and the width of each of the different colour pixels in the at least one direction is arranged to compensate for chromatic aberration of the plurality of lenses of the lens layer, such that variation in display luminance angular profile is the same for each colour of the different colour pixels.

25. A display device according to claim 22, wherein the parallax barrier layer comprises different width apertures and the width of each of the different width apertures in the at least one direction is arranged to compensate for angular colour variations of the output of the different colour pixels, such that variation in display luminance angular profile is the same for each colour of the different colour pixels.

26. A display device according to claim 22, wherein the pixel layer comprises different colour pixels and the shape of each of the different colour pixels is arranged to compensate for angular colour variations of the output of the different colour pixels, such that variation in display luminance angular profile is the same for each colour of the different colour pixels.

27. A display device according to claim 1, wherein each of the plurality of lenses comprises an input aperture and the display device further comprises one or more first colour filters aligned with one or more of the input apertures of the plurality of lenses.

28. A display device according to claim 1, further comprising one or more second colour filters aligned with one or more of the plurality of apertures of the parallax barrier layer.

29. A display device according to claim 28, wherein the one or more second colour filters comprise an array of red, green and blue colour filters.

30. A display device according to claim 1, wherein the plurality of pixels comprise light emitting diodes.

31. A display device according to claim 30, wherein at least one of the light emitting diodes comprises an organic light emitting material.

32. A display device according to claim 30, wherein at least one of the light emitting diodes is an inorganic micro-LED.

33. A display device according to claim 1, further comprising:
an additional linear polariser arranged on an output side of the lens layer, the additional polariser being a linear polariser; and
at least one polar control retarder arranged between the lens layer and the additional polariser.

34. A display device according to claim 33, wherein the at least one polar control retarder comprises at least one passive retarder.

35. A display device according claim 33, wherein the at least one polar control retarder comprises a switchable liquid crystal retarder comprising a layer of liquid crystal material and transmissive electrodes arranged to apply a voltage for switching the layer of liquid crystal material.

36. A display device according to claim 35, wherein the at least one polar control retarder is arranged:
in a first switchable state of the switchable liquid crystal retarder, simultaneously to introduce no net relative phase shift to orthogonal polarisation components of light received by the at least one polar control retarder along an axis along an inclination direction to the plane of the at least one polar control retarder and to introduce a net relative phase shift to orthogonal polarisation components of light received by the at least one polar control retarder along an axis inclined to the inclination direction to the plane of the at least one polar control retarder; and
in a second switchable state of the switchable liquid crystal retarder, simultaneously to introduce no net relative phase shift to orthogonal polarisation components of light received by the at least one polar control retarder along an axis along the inclination direction to the plane of the at least one polar control retarder and to introduce no net relative phase shift to orthogonal polarisation components of light received by the at least one polar control retarder along an axis inclined to the inclination direction to the plane of the at least one polar control retarder.

37. A display device according to claim 36, wherein the inclination direction is a direction normal to the plane of the at least one polar control retarder.

38. A display device according to claim 33, further comprising a reflective polariser arranged between the display polariser and the at least one polar control retarder, the reflective polariser being a linear polariser arranged to pass the same linearly polarised polarisation component as the display polariser.

39. A display device according to claim 38, wherein the display polariser is a reflective polariser.

40. A near-eye display apparatus comprising the display device of claim 1.

41. A near-eye display apparatus according to claim 40, further comprising:
a polarisation switch layer arranged between the lens layer and the display polariser, the polarisation switch layer being arranged to convert a polarisation state of light passing therethrough between a first polarisation state and a second polarisation state orthogonal to the first polarisation state,
wherein the polarisation switch layer comprises a switchable liquid crystal layer, and
wherein the near-eye display apparatus is arranged to provide pixel data to both the pixel layer and the polarisation switch layer, thereby providing increased dynamic range.

42. A head-worn display apparatus comprising:
the near-eye display apparatus according to claim 40; and
a head-mounting arrangement for mounting the head-worn display apparatus on a head of a wearer such that the near-eye display apparatus extends across at least one eye of the wearer.

43-44. (canceled)

45. A display device comprising:
a pixel layer comprising a plurality of pixels arranged in a pixel array;
a first colour filter layer comprising a plurality of first colour filters arranged in a first colour filter array, wherein each of the plurality of pixels is aligned with a respective first colour filter of the plurality of first colour filters;
a lens layer comprising a plurality of lenses arranged in a lens array, wherein each of the plurality of pixels is aligned with a respective lens of the plurality of lenses, and wherein the plurality of lenses comprises one or more birefringent lenses; and
a display polariser which is a linear polariser,
wherein the first colour filter layer is arranged between the lens layer and the pixel layer,
wherein the lens layer is arranged between the pixel layer and the display polariser,
wherein the pixel layer is arranged to output light towards the first colour filter layer, the first colour filter layer is arranged to receive light output from the pixel layer and to output light towards the lens layer, the lens layer is arranged to receive light output from the first colour filter layer and to output light towards the display polariser, and the display polariser is arranged to receive light output from the lens layer and to output linearly polarised light, and
wherein the first colour filter layer is arranged to prevent at least some of the light from each of the plurality of pixels from reaching lenses which are not aligned with that pixel, and wherein the each of the plurality of lenses is arranged to reflect at least some of the light received from pixels which are not aligned with that lens.

46. A display device according to claim 45, wherein at least 50%, preferably at least 65% and more preferably at least 75% of the light output by each of the plurality of lenses of the lens layer is from the pixel with which that lens is aligned.

47. A display device according to claim 45, wherein:
each of the plurality of pixels is aligned with a respective first colour filter which has the same colour,
each of the plurality of pixels is adjacent to another pixel of the plurality of pixels which has a different colour, and
each of the plurality of first colour filters is adjacent to another first colour filter of the plurality of first colour filters which has a different colour.

48. A display device according to any claim 45, further comprising a second colour filter layer comprising a plurality of second colour filters arranged in a second colour filter array, wherein each of the plurality of pixels is aligned with a respective second colour filter of the plurality of second colour filters,

49. A display device according to claim 48, wherein the second colour filter layer is arranged to receive light output from the pixel layer and to output light towards the first colour filter layer.

50. A display device according to claim 48, wherein the second colour filter layer is arranged between the first colour filter layer and the pixel layer.

51. A display device according to claim 48, wherein each second colour filter is aligned with a respective first colour filter which has the same colour.

52. A display device according to claim 45, wherein the first colour filter layer is located adjacent to the lens layer, and each first colour filter of the first colour filter layer is aligned with a respective lens of the lens layer.

53. (canceled)
